(19) United States
(12) Patent Application Publication
(10) Pub. No.: US 2024/0408828 A1
(43) Pub. Date: Dec. 12, 2024

(54) PRESSURE CONTROL IN MANUFACTURING SYSTEMS

(71) Applicant: Velo3D, Inc., Fremont, CA (US)

(72) Inventors: Sergey Korepanov, Los Altos, CA (US); Joseph Andrew Tralongo, El Cajon, CA (US); Alexander Vladimirovich Varlakhanov, San Carlos, CA (US); Benyamin Buller, Cupertino, CA (US)

(73) Assignee: Velo3D, Inc., Fremont, CA (US)

(21) Appl. No.: 18/740,258

(22) Filed: Jun. 11, 2024

Related U.S. Application Data
(60) Provisional application No. 63/472,549, filed on Jun. 12, 2023.

(51) Int. Cl. B29C 64/393; B29C 64/371; B33Y 10/00; B33Y 30/00; B33Y 50/02

(52) U.S. Cl. CPC B29C 64/393; B29C 64/371; B33Y 10/00; B33Y 30/00; B33Y 50/02

(57) ABSTRACT

The present disclosure provides manufacturing systems and associated devices, apparatuses, methods, and non-transitory computer readable media, in relation to pressure control in at least a portion of the manufacturing system, e.g., a three-dimensional printing system. The pressure control may consider various aspect of the printed 3D object(s) and/or the material bed utilized for printing the 3D object(s). The pressure control may utilize one or more reservoirs, e.g., at least a portion of a gas conveyance system of the 3D printer. The pressure control may reduce disturbances in an exposed surface of the material bed during the printing.

### CROSS-REFERENCE TO RELATED PATENT APPLICATION(S)

This application is a non-provisional patent application that claims priority to and the benefit of U.S. Provisional Application No. 63/472,549, filed Jun. 12, 2023, entitled “PRESSURE CONTROL IN MANUFACTURING SYSTEMS” the disclosure of which is incorporated by reference herein in its entirety.

### BACKGROUND

Various manufacturing systems may be utilized to manufacture products such as three-dimensional objects. A manufacturing system may (a) utilize starting materials, (b) generate products and/or (c) generate byproducts, that are susceptible to reactive agent(s) present in the ambient atmosphere external to the manufacturing system. Such reactive agents may comprise oxygen or water. The manufacturing system may comprise a three-dimensional printing system.

Three-dimensional (3D) printing (e.g., additive manufacturing) is a process for making a three-dimensional object of any shape from a design. The design may be in the form of a data source such as an electronic data source or may be in the form of a hard copy. The hard copy may be a two-dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, an allotrope of elemental carbon, or polymeric material. In some 3D printing processes (e.g., additive manufacturing), a first layer of hardened material is formed (e.g., by welding powder), and thereafter successive layers of hardened material are added one by one, wherein each new layer of hardened material is added on a pre-formed layer of hardened material, until the entire designed three-dimensional structure (3D object) is layer-wise materialized.

3D models may be created with a computer aided design package, via 3D scanner, or manually. The manual modeling process of preparing geometric data for 3D computer graphics may be similar to plastic arts, such as sculpting or animating. 3D scanning is a process of analyzing and collecting digital data on the shape and appearance of a real object (e.g., real-life object). Based at least in part on this data, 3D models of the scanned object can be produced.

A number of 3D printing processes are currently available. They may differ in the manner layers are deposited to create the materialized 3D structure (e.g., hardened 3D structure). They may vary in the material or materials that are used to materialize the designed 3D object. Some methods melt, sinter, or soften material to produce the layers that form the 3D object. Examples for 3D printing methods include selective laser melting (SLM), selective laser sintering (SLS), direct metal laser sintering (DMLS) or fused deposition modeling (FDM). Other methods cure liquid materials using different technologies such as stereo lithography (SLA). In the method of laminated object manufacturing (LOM), thin layers (made inter alia of paper, polymer, or metal) are cut to shape and joined together.

The manufacturing system, e.g., a three-dimensional printing system, may utilize and/or generate material type(s) that are susceptible to reaction with reactive agent(s) in the ambient atmosphere, e.g., water and/or oxygen. Such a reaction may cause defects in the manufactured product and/or harm to a user. The manufacturing system may comprise an enclosure in which the material type(s) are disposed, e.g., before, during, and/or after the manufacturing operation, e.g., three-dimensional printing. At times, it may be beneficial to isolate the internal environment of the enclosure from the ambient environment external to the enclosure. At times, it may be beneficial to control one or more characteristics of the internal environment to remain a requested value. The one or more characteristics may comprise a temperature, a pressure, a gas makeup, a gas flow direction, a gas flow velocity, or amount of reactive agent(s). At least one of the one or more characteristics of the internal environment of the enclosure may be different from that of the ambient environment. For example, the pressure is different. For example, the pressure of the internal environment is higher than the pressure of the ambient environment. At times, the gas makeup in the enclosure may comprise a robust gas. At times, the gas makeup (e.g., of the robust gas) in the enclosure may be different than that of the ambient environment, e.g., may comprise an inert gas such as a Nobel gas. The cost of the Nobel gas may be, or may become, a substantial expense. The robust gas may be a protective gas. The robust gas may be less reactive with one or more material types present in the enclosure (e.g., during manufacturing such as 3D printing) as compared to the ambient atmosphere external to the enclosure.

Various processes may occur in the enclosure of the manufacturing system. Pressure differentials may arise during one or more of the manufacturing processes. Such pressure differentials may disturb and/or disrupt the manufacturing process. At least for these reasons, it may be beneficial to curtail (e.g., minimize) such pressure differentials. It may be beneficial to curtail such pressure differentials quickly and/or at minimal cost. In some instances, quick rectification of the pressure differential minimizes disturbance and/or disruption to the process(es). Curtailing the pressure differentials may comprise expulsion of a portion of the internal gas from the enclosure. Usage of the expelled gas can reduce cost, which usage may comprise curtailing a subsequent pressure differential. The pressure differentials may be minimized at least in part by utilizing pressure alteration procedure comprising (i) expelling over-pressured internal gas (e.g., comprising robust gas) from the enclosure out to a target location, or (ii) under-pressure may be minimized by introducing robust gas (e.g., from a gas source) into the enclosure to maintain the enclosure under the requested level of pressure. The source of the robust gas and the target location may vary, e.g., depending on the size of the manufacturing systems. Larger manufacturing systems may have different requirements than smaller ones, e.g., due to the non-linearity of system scale up.

### SUMMARY OF THE INVENTION

In some aspects, the present disclosure resolves the aforementioned hardships.

In some aspects, curbing pressure differentials in the enclosure comprises (a) expulsion of gas from the enclosure or (b) insertion of gas into the enclosure. Curbing pressure differential may utilize control scheme(s). To curtail the pressure differentials, a control scheme may be utilized, the control scheme comprising (a) introducing gas into the enclosure from the gas source, or (b) expelling the gas from the enclosure. The expulsion of the gas can be to a target location. The expulsion of the gas can be to an ambient atmosphere or to a reservoir. The target location may comprise the ambient environment or the reservoir. The gas source can be the reservoir. The gas source can be the ambient environment, e.g., when air is utilized during the printing and the manufacturing process is not susceptible to reactive agent(s) in the ambient atmosphere. In some embodiments, the gas is different from air. The manufacturing system may comprise, or may be operatively coupled with, the reservoir. In an example, the reservoir is included in the manufacturing system, e.g., as at least a portion of a gas conveyance system of the manufacturing system. The expelled gas from the enclosure can be recycled. The volume of gas introduced into and/or expelled out of the enclosure can be reduced at least in part by utilizing the released over-pressured gas, e.g., as a subsequent batch of gas introduced into the enclosure to compensate for under-pressure. The gas may comprise a robust gas.

In another aspect, a control system may control curbing the pressure differentials. The control system may utilize a control scheme. The control scheme may control the exchange (e.g., insertion and/or expulsion) of gas, e.g., with respect to the enclosure. Gas may be introduced into the enclosure from a gas source. The gas source may comprise (i) an ambient environment, (ii) pressure reservoir, (iii) a compressor (e.g., pump), (iv) a portion of gas conveyance system of the manufacturing system, or (v) any combination thereof. Gas may be expelled from the enclosure to a target location. The target location may comprise (i) ambient environment, (ii) pressure reservoir, (iii) a portion of gas conveyance system of the manufacturing system, or (iv) any combination thereof. The portion of the gas conveyance system of the manufacturing system may comprise gas channels (e.g., pipes). The target location and gas source may be determined at least in part by considering one or more characteristics of a manufacturing system and/or one or more characteristics of a manufactured product. The manufacturing system may comprise a 3D printing system. The manufactured product may be a 3D object. The one or more characteristics of the manufacturing system may comprise volume, capacity, or manufacturing speed. The volume enclosed by at least a portion of the manufacturing system, e.g., a processing chamber. the capacity may be of the reservoir,

In another aspect, the volume of gas introduced into the enclosure and/or expelled out of the enclosure, can be adjusted at least in part by using control systems, e.g., controlling one or more valves configured to facilitate flow of the robust gas in the gas conveyance system of the manufacturing system. The control system can use a feedback control scheme, e.g., using sensors associated with pressure in the enclosure and/or controlling gas flow through the valves of the gas conveyance system. The timespan of gas exchange can be reduced at least in part by using a feed forward control scheme. The feed forward control scheme can consider one or more properties of the 3D printing and/or one or more properties of the 3D object. In an example, the feed forward control scheme considers the structure of the 3D object such as in real time during its printing, e.g., when it is being made. The gas exchange may be for the purpose of pressure equilibration, e.g., to diminish pressure differentials.

The above delineated features (e.g., aspects and/or embodiments) may be combined in various ways as applicable, e.g., depending on the product manufactures (e.g., 3D printing) and/or tolerances requested for the product.

In another aspect, an apparatus for printing one or more three-dimensional (3D) objects, the apparatus comprises: one or more controllers configured to: (a) operatively couple with one or more components associated with a three-dimensional (3D) printer that is configured to print the one or more 3D objects; (b) generate an estimation of the pressure fluctuation in an enclosure of the 3D printer, the pressure fluctuation being during the printing of the one or more 3D objects in the enclosure, the estimation being generated at least in part by considering (i) at least one first characteristic of the one or more 3D objects printed and/or (ii) at least one second characteristic of a material bed in which the one or more 3D objects are printed, wherein at least a portion of the material bed is utilized to print the one or more 3D objects during the printing; and (c) direct the one or more components to assist in regulating the pressure based at least in part on the estimation. In some embodiments, the one or more controllers are configured to operatively coupled with the one or more components comprising a valve. In some embodiments, the 3D printer is configured to print the one or more 3D objects in a printing cycle. In some embodiments, the one or more controllers are configured to direct the one or more components to assist in regulating the pressure during the 3D printing. In some embodiments, the one or more controllers comprise at least one connector configured to connect to a power source. In some embodiments, the one or more controllers are configured to operatively couple with a power source at least in part by (i) having a power socket and/or (ii) being configured for wireless power transfer using inductive charging. In some embodiments, the one or more controllers are included in, or comprises, a hierarchical control system. In some embodiments, the hierarchical control system comprises at least three hierarchical control levels. In some embodiments, the one or more controllers are included in a control system configured to control the 3D printer that prints the one or more 3D objects. In some embodiments, the at least one valve is a component of a 3D printer, and the one or more controllers are configured to (i) operatively couple with another component of the 3D printer and (ii) direct operation of the other component. In some embodiments, the one or more controllers are configured to direct operation of the other component for the printing of the one or more 3D objects. In some embodiments, the one or more controllers are operatively coupled with at least about 900 sensors, or 1000 sensors, operatively coupled with the 3D printer. In some embodiments, at least during the printing, the one or more controllers are configured to control a pressure in a 3D printer to be above ambient pressure external to the 3D printer. In some embodiments, the one or more controllers are configured to control the atmosphere of the enclosure to be depleted of at least one reactive agent relative to its concentration in an ambient atmosphere external to the enclosure, the reactive agent being configured to react at least during the printing with (i) a starting material of the printing of the one or more 3D objects and/or (ii) a byproduct of the printing. In some embodiments, the byproduct of the printing comprises soot, spatter, or splatter. In some embodiments, the at least one valve is operatively coupled with or is part of the 3D printer. In some embodiments, the printing comprises welding. In some embodiments, the printing of the one or more 3D objects comprises fusing. In some embodiments, the fusing comprises melting or sintering. In some embodiments, the one or more controllers are configured to operatively couple with a gas conveyance system, the gas conveyance system being (a) operatively coupled with the enclosure and (b) in fluidic communication with the enclosure. In some embodiments, the one or more controllers are configured to operatively coupled with the one or more components comprising a valve, and the at least one valve is operatively coupled with or being part of the gas conveyance system. In some embodiments, the one or more controllers are configured to direct the gas conveyance system to introduce robust gas into the enclosure. In some embodiments, the robust comprises a lower concentration of a reactive agent compared with its concentration in an ambient atmosphere external to the enclosure, the reactive agent being configured to react at least during the printing with (a) a starting material of the printing of the one or more 3D objects and/or (ii) a byproduct of the printing. In some embodiments, the reactive agent comprises oxygen, water, or hydrogen sulfide. In some embodiments, at least during the printing, the one or more controllers are configured to control a pressure in the gas conveyance system to be above ambient pressure external to the gas conveyance system. In some embodiments, the one or more controllers are configured to operatively couple with a gas enrichment system, the gas enrichment system being configured to enrich gas flowing into the enclosure with at least one reactive agent. In some embodiments, the gas enrichment system is operatively coupled with or part of a gas conveyance system, the gas conveyance system being (a) operatively coupled with the enclosure and (b) in fluidic communication with the enclosure. In some embodiments, at least during the printing, the reactive agent is configured to react with (i) a starting material of the printing and/or (ii) a byproduct of the printing. In some embodiments, the reactive agent comprises oxygen, water, or hydrogen sulfide. In some embodiments, at least during the printing comprises a time after the printing. In some embodiments, the one or more controllers are configured to facilitate the printing at least in part by being configured to control deposition of a starting material on a target surface. In some embodiments, the one or more controllers are configured to facilitate the printing at least in part by being configured to direct a material dispenser. In some embodiments, the one or more controllers are configured to facilitate the printing at least in part by being configured to direct a layer dispensing mechanism to deposit a planar layer of the starting material on the target surface. In some embodiments, the one or more controllers are configured to operatively couple with a layer dispensing mechanism, the layer dispensing mechanism being located in the enclosure, the layer dispensing mechanism being configured to deposit a layer of a starting material on a target surface, the layer of the starting material constituting at least a portion of the material bed. In some embodiments, the target surface comprises (i) a surface of the material bed or (ii) a surface of a build platform, the material bed being located on the surface of the build platform, the build platform being part of or located in the enclosure. In some embodiments, the layer dispensing mechanism comprises a material dispenser and a remover, the material dispenser being configured to dispense the starting material, the remover being configured to remove from the enclosure at least a portion of the starting material that does not constitute the material bed. In some embodiments, the remover is configured to planarize the layer comprising the starting material as a portion of the material bed. In some embodiments, the remover is operatively coupled with an attractive force source to attract the at least the portion of the starting material that does not constitutes the material bed from the enclosure. In some embodiments, the attractive force comprises a magnetic, electric, electrostatic, or vacuum source. In some embodiments, the attractive force comprises a vacuum source. In some embodiments, the layer dispensing mechanism further comprises a leveler, the leveler being configured to planarize the layer of the starting material as part of the material bed. In some embodiments, the one or more controllers are configured to direct the one or more components to assist in regulating the pressure when the remover removes a removed material from the material bed, the removed material being of the material bed before being removed by the remover. In some embodiments, the one or more controllers are configured to direct the one or more components to assist in regulating the pressure when (i) the remover starts to be loaded with the removed material and/or (ii) the remover starts to be cleared of the removed material. In some embodiments, the pressure fluctuation in the enclosure is negative when the remover starts to be cleared of the removed material. In some embodiments, the pressure fluctuation in the enclosure is positive when the remover starts to be loaded with the removed material. In some embodiments, the removed material cleared from the remover is recycled in a recycling system. In some embodiments, the recycling system is part of the 3D system, or is operatively coupled with the 3D printer. In some embodiments, the one or more 3D objects are printed in a printing cycle, and the one or more controllers are configured to control recycling of the removed material in the recycling system for use in the printing cycle, or in another printing cycle. In some embodiments, the one or more controllers are configured to regulate during recycling a pressure differential in the recycling system to facilitate propagation of recycled material in the recycling system. In some embodiments, the pressure differential is at an internal pressure different than ambient pressure external to the recycling system. In some embodiments, the pressure differential is at an internal pressure above ambient pressure external to the recycling system. In some embodiments, the one or more controllers are configured to regulate during recycling an atmosphere in the recycling system that is different than the ambient environment external to the recycling system, the atmosphere comprising a robust gas. In some embodiments, the robust comprises a lower concentration of a reactive agent compared with its concentration in an ambient atmosphere external to the enclosure, the reactive agent being configured to react at least during the printing with (a) a starting material of the printing of the one or more 3D objects and/or (ii) a byproduct of the printing. In some embodiments, the reactive agent comprises oxygen, water, or hydrogen sulfide. In some embodiments, the robust gas in the enclosure and the robust gas in the recycling system are (e.g., substantially) the same type of robust gas. In some embodiments, the enclosure and the recycling system are operatively coupled to the gas conveyance system. In some embodiments, the layer dispensing mechanism is configured to facilitate deposition of the starting material on the target surface at least in part by layer-wise deposition. In some embodiments, the starting material comprises powder material. In some embodiments, the starting material comprises elemental metal, metal alloy, ceramic, or an allotrope carbon. In some embodiments, the starting material comprising a polymer or a resin. In some embodiments, the one or more controllers are configured to operatively couple with a recycling system, the recycling system being configured to (i) recycle at least a fraction of the portion of the starting material removed by the remover and/or (ii) provide at least a portion of the starting material utilized by the material dispenser in subsequent deposition. In some embodiments, the recycling system is configured to operatively couple with the enclosure. In some embodiments, the recycling system is configured to operatively couple with a gas conveyance system, the gas conveyance system being (i) operatively coupled with the enclosure and (ii) in fluidic communication with the enclosure. In some embodiments, the recycling system comprises the pressure differential that is at least between the enclosure and one or more components of the recycling system. In some embodiments, the one or more controllers are configured to control a pressure in the recycling system to be above ambient pressure external to the recycling system. In some embodiments, the recycling system comprises at least one separator. In some embodiments, the recycling system is configured to accommodate a pressure differential across the at least one separator. In some embodiments, the at least the portion of the starting material removed by the remover is at least about 70%, 50% or 30% of the dispensed starting material. In some embodiments, the fraction of the portion of the starting material recycled by the recycling system is at least about 70% or 90% of the portion removed by the remover. In some embodiments, the at least one first characteristic of the one or more 3D objects comprises a structure of the one or more 3D objects printed during the printing. In some embodiments, the structure of the one or more 3D objects printed comprises (i) a structure of the one or more 3D objects as it is being printed considering it being embedded in the material bed, or (ii) a structure of the one or more 3D objects as it is being printed and embedded in the material bed. In some embodiments, the structure of the one or more 3D object comprises an open cavity comprising an internal cavity space and a cavity opening fluidly coupled with the internal cavity space, and the at least one first characteristic of the one or more 3D objects comprises the internal cavity space and the cavity opening. In some embodiments, the structure of the one or more 3D object comprises an open channel comprising an internal channel space and a channel opening fluidly coupled with the internal channel space, and the at least one first characteristic of the one or more 3D objects comprises the internal channel space and the channel opening. In some embodiments, the at least one second characteristic of the material bed comprises (i) chemical composition of the material bed, (ii) morphology of the material in the material bed, or (iii) temperature of at least one portion the material bed during the printing of the one or more 3D objects. In some embodiments, the at least one portion comprises a top portion of the material bed that includes an exposed surface of the material bed. In some embodiments, the one or more controllers are configured to generate the estimation of the pressure fluctuation in the enclosure at least in part by using a computational scheme. In some embodiments, the computational scheme utilizes (i) the at least one first characteristic of the one or more 3D objects printed and/or (ii) the at least one second characteristic of the material bed. In some embodiments, the one or more controllers are configured to generate the estimation of the pressure fluctuation in the enclosure at least in part by using historical data associated with the pressure in the enclosure. In some embodiments, the one or more controllers are configured to generate the estimation of the pressure fluctuation in the enclosure by at least in part using a learning scheme. In some embodiments, a learning set of the learning scheme utilizes (a) historical data associated with the pressure in the enclosure, (b) synthesized data associated with the pressure in the enclosure, or (c) a combination of (a) and (b). In some embodiments, the material bed comprises a starting material for the printing and/or byproduct of the printing. In some embodiments, the one or more controllers are configured to utilize the estimation of the pressure fluctuation to maintain the pressure fluctuation according to a request, the request comprising (i) the pressure fluctuation being within a requested range or (ii) the pressure fluctuation persisting at most during a requested time span. In some embodiments, the request is tailored to (i) a printing cycle, (ii) the at least one first characteristic of the one or more 3D objects printed, and/or (ii) the at least one second characteristic of the material bed, wherein the one or more 3D objects are printed in the printing cycle. In some embodiments, the requested range of the pressure fluctuation is at most about +/−0.3 kPa. In some embodiments, the requested time span is at most about one (1) second. In some embodiments, the one or more controllers are operatively coupled with at least one sensor operatively coupled with the enclosure, the at least one sensor being configured to sense at least one third characteristic of the atmosphere of the enclosure. In some embodiments, the at least one third characteristic comprises a pressure, a temperature, or concentration of at least one reactive agent. In some embodiments, the at least one sensor is located in or is operatively coupled with (i) the enclosure and/or (ii) a channel (e.g., pipe) connected to the enclosure. In some embodiments, the at least on sensor comprises at least 900 or 1000 sensors. In some embodiments, the one or more controllers are configured to receive data from the at least one sensor and regulate the pressure fluctuation based at least in part on the data received. In some embodiments, the one or more controllers are configured direct the at least one valve to assist in regulation of the pressure fluctuation at least in part by forecasting a volume of gas of the atmosphere to be exchanged, the volume of the gas being with respect to volume of the atmosphere of the enclosure. In some embodiments, forecasting of the volume to be exchanged is based at least in part on the estimation of the pressure fluctuation in the enclosure. In some embodiments, the one or more controllers are configured to adjust the volume of the gas to be exchanged based at least in part on a pressure in the enclosure, the one or more controllers being configured to operatively couple with at least one sensor, the at least one sensor being configured to sense the pressure in the enclosure. In some embodiments, the one or more controllers are configured to control at least one valve to adjust the volume of the gas to be exchanged based at least in part on the pressure in the enclosure. In some embodiments, the at least one valve comprises discrete valve or proportional valve. In some embodiments, the at least one valve comprises (a) one or more inlet valves and (b) one or more outlet valves, the one or more controllers being configured to direct (i) the one or more inlet valves to assist in ingress of gas from a gas source into the enclosure or (ii) the one or more outlet valves to assist in egress of at least a portion of the atmosphere of the enclosure to a target reservoir. In some embodiments, the target reservoir is configured to operate also as the gas source. In some embodiments, the gas comprises a robust gas, and the atmosphere of the enclosure comprises the robust gas that is different by at least one characteristic from the atmosphere external to the enclosure. In some embodiments, the at least one characteristic comprises a pressure, a temperature, or concentration of at least one reactive agent. In some embodiments, a first pressure difference between the gas source and the enclosure is larger than a second pressure difference between the enclosure and the target reservoir. In some embodiments, a first total opening area of the one or more outlet valves is larger than a second total opening area of the one or more inlet valves. In some embodiments, the number of the one or more outlet valves is greater than the number of one or more inlet valves. In some embodiments, the one or more controllers are configured to (i) operatively couple with at least one external device, and (ii) direct regulation of the pressure fluctuation of the atmosphere of the enclosure based at least in part on data received from the at least one external device. In some embodiments, the one or more controllers are configured to (i) operatively couple with at least one valve, and (ii) direct the at least one valve to assist at least in part in the regulation of the pressure fluctuation. In some embodiments, the one or more controllers are configured to direct the at least one valve to assist at least in part in exchange of at least a portion of gas of the atmosphere of the enclosure. In some embodiments, the exchange of the at least a portion of the gas of the atmosphere of the enclosure comprises the ingress or the egress. In some embodiments, the at least one or more controllers are configured to operatively couple with a reservoir configured to exchange at least a portion of gas of the atmosphere of the enclosure, the reservoir being configured to (i) enclose the gas in the reservoir when the exchange comprises egress of the gas from the enclosure, and (ii) release the gas disposed in the reservoir when the exchange comprises ingress of the gas into the enclosure. In some embodiments, the reservoir is a first reservoir, and the one or more controllers are configured to direct release of at least a portion of the gas from the enclosure to the ambient environment when pressure in the first reservoir exceeds a maximum threshold pressure. In some embodiments, the reservoir is at least a portion of a gas conveyance system of the 3D printer.

In another aspect, non-transitory computer readable program instructions for printing one or more three-dimensional (3D) objects, the program instructions, when ready by one or more processors operatively coupled with or include any of the above the apparatuses, cause the one or more processors to execute, or direct execution of, one or more operations associated with the printing of the 3D objects. For example, in another aspect, non-transitory computer readable program instructions for printing one or more three-dimensional (3D) objects, the program instructions, when read by one or more processors, cause the one or more processors to execute, or direct execution of, one or more operations comprises: regulating pressure fluctuation of an atmosphere of an enclosure at least in part by generating an estimation of the pressure fluctuation, the pressure fluctuation being in the enclosure during the printing, the estimation being generated at least in part by considering (i) at least one first characteristic of the one or more 3D objects printed and/or (ii) at least one second characteristic of a material bed in which the one or more 3D objects are printed, the one or more 3D objects being printed in the enclosure, wherein at least a portion of the material bed is utilized to print the one or more 3D objects. In some embodiments, the one or more processors are configured to (i) operatively couple with one or more components associated with a three-dimensional (3D) printer that is configured to print the one or more 3D objects, and (ii) direct the one or more components to assist in regulating the pressure based at least in part on the estimation. In some embodiments, the one or more components are configured to exchange at least a portion of gas of the atmosphere of the enclosure. In some embodiments, the one or more components comprise at least one valve, compressor, gas source, or target reservoir. In some embodiments, the one or more processors execute, or direct execution of, one or more operations comprising the printing of the one or more 3D objects. In some embodiments, the program instructions are inscribed on a medium or on media.

In another aspect, a method for printing one or more three-dimensional (3D) objects, the method comprises providing any of the above apparatuses; and using the apparatus in association with the printing. For example, in another aspect, a method for printing one or more three-dimensional (3D) objects, the method comprises: regulating pressure fluctuation of an atmosphere of an enclosure at least in part by generating an estimation of the pressure fluctuation in the enclosure, the pressure fluctuation being during the printing, the estimation being generated at least in part by considering (i) at least one first characteristic of the one or more 3D objects printed and/or (ii) at least one second characteristic of a material bed in which the one or more 3D objects are printed, the one or more 3D objects being printed in the enclosure, wherein at least a portion of the material bed is utilized to print the one or more 3D objects. In some embodiments, the one or more components comprise a valve. In some embodiments, printing the one or more 3D objects is in a printing cycle. In some embodiments, the method further comprises using the one or more components to assist in regulating the pressure during the 3D printing. In some embodiments, the at least one valve is a component of a 3D printer. In some embodiments, the method further comprises using the other component for the printing of the one or more 3D objects. In some embodiments, the method further comprises using at least about 900 sensors, or 1000 sensors, during the printing. In some embodiments, at least during the printing, controlling a pressure in a 3D printer to be above ambient pressure external to the 3D printer. In some embodiments, the method further comprises controlling the atmosphere of the enclosure to be depleted of at least one reactive agent relative to its concentration in an ambient atmosphere external to the enclosure, the reactive agent being configured to react at least during the printing with (i) a starting material of the printing of the one or more 3D objects and/or (ii) a byproduct of the printing. In some embodiments, the byproduct of the printing comprises soot, spatter, or splatter. In some embodiments, the at least one valve is operatively coupled with or is part of a 3D printer performing the 3D printing. In some embodiments, the printing comprises welding. In some embodiments, the printing of the one or more 3D objects comprises fusing. In some embodiments, the fusing comprises melting or sintering. In some embodiments, the enclosure comprises or is operatively couple with a gas conveyance system that is in fluidic communication with the enclosure. In some embodiments, the one or more components comprising a valve, and the at least one valve is operatively coupled with or being part of the gas conveyance system. In some embodiments, the method comprises introducing robust gas from the gas conveyance system into the enclosure. In some embodiments, the robust comprises a lower concentration of a reactive agent compared with its concentration in an ambient atmosphere external to the enclosure, the reactive agent being configured to react at least during the printing with (a) a starting material of the printing of the one or more 3D objects and/or (ii) a byproduct of the printing. In some embodiments, the reactive agent comprises oxygen, water, or hydrogen sulfide. In some embodiments, at least during the printing, controlling a pressure in the gas conveyance system to be above ambient pressure external to the gas conveyance system. In some embodiments, the method further comprises using a gas enrichment system operatively coupled with or being part of the 3D printer, the method further comprises using the gas enrichment system to enrich gas flowing into the enclosure with at least one reactive agent. In some embodiments, the gas enrichment system is operatively coupled with or part of a gas conveyance system, the gas conveyance system being (a) operatively coupled with the enclosure and (b) in fluidic communication with the enclosure. In some embodiments, at least during the printing, the reactive agent is configured to react with (i) a starting material of the printing and/or (ii) a byproduct of the printing. In some embodiments, the reactive agent comprises oxygen, water, or hydrogen sulfide. In some embodiments, at least during the printing comprises a time after the printing. In some embodiments, the printing comprises controlling deposition of a starting material on a target surface. In some embodiments, the method further comprises using a material dispenser during the printing to dispense the starting material. In some embodiments, the method further comprises depositing a planar layer of the starting material on the target surface as part of the printing. In some embodiments, the method further comprises using the layer dispensing mechanism located in the enclosure, the layer dispensing mechanism being used for depositing a layer of a starting material on a target surface, the layer of the starting material constituting at least a portion of the material bed. In some embodiments, the target surface comprises (i) a surface of the material bed or (ii) a surface of a build platform, the material bed being located on the surface of the build platform, the build platform being part of or located in the enclosure. In some embodiments, the layer dispensing mechanism comprises a material dispenser and a remover, the method further comprises during the printing (a) using the material dispenser to dispense the starting material, and (b) using the remover to remove from the enclosure at least a portion of the starting material that does not constitute the material bed. In some embodiments, the method further comprises using the remover to planarize the layer comprising the starting material as a portion of the material bed. In some embodiments, the method further comprises attracting the at least the portion of the starting material that does not constitutes the material bed from the enclosure at least in part by using an attractive force operatively coupled with the remover. In some embodiments, the attractive force comprises a magnetic, electric, electrostatic, or vacuum source. In some embodiments, the attractive force comprises a vacuum source. In some embodiments, the layer dispensing mechanism further comprises a leveler, and during the printing, using the leveler to planarize the layer of the starting material as part of the material bed. In some embodiments, the method further comprises using the one or more components to assist in regulating the pressure when removing a removed material from the material bed by the remover, the removed material being of the material bed before being removed by the remover. In some embodiments, the method further comprises using the one or more components to assist in regulating the pressure when (i) the remover starts to be loaded with the removed material and/or (ii) the remover starts to be cleared of the removed material. In some embodiments, the pressure fluctuation in the enclosure is negative when the remover starts to be cleared of the removed material. In some embodiments, the pressure fluctuation in the enclosure is positive when the remover starts to be loaded with the removed material. In some embodiments, the method further comprises recycling the removed material cleared from the remover, the recycling being by a recycling system. In some embodiments, the recycling system is part of a 3D printer, or is operatively coupled with the 3D printing printer comprising the enclosure. In some embodiments, the one or more 3D objects are printed in a printing cycle, and the method further comprises recycling the removed material in the recycling system for use in the printing cycle, or in another printing cycle. In some embodiments, during recycling the method further comprises regulating a pressure differential in the recycling system to facilitate propagation of recycled material in the recycling system. In some embodiments, the pressure differential is at an internal pressure different than ambient pressure external to the recycling system. In some embodiments, the pressure differential is at an internal pressure above ambient pressure external to the recycling system. In some embodiments, during recycling the method further comprises regulating an atmosphere in the recycling system that is different than the ambient environment external to the recycling system, the atmosphere comprising a robust gas. In some embodiments, the robust comprises a lower concentration of a reactive agent compared with its concentration in an ambient atmosphere external to the enclosure, the reactive agent being configured to react at least during the printing with (a) a starting material of the printing of the one or more 3D objects and/or (ii) a byproduct of the printing. In some embodiments, the reactive agent comprises oxygen, water, or hydrogen sulfide. In some embodiments, the robust gas in the enclosure and the robust gas in the recycling system are (e.g., substantially) the same type of robust gas. In some embodiments, the enclosure and the recycling system are operatively coupled to the gas conveyance system. In some embodiments, the method further comprises using the layer dispensing mechanism to deposit the starting material on the target surface at least in part by layer-wise deposition. In some embodiments, the starting material comprises powder material. In some embodiments, the starting material comprises elemental metal, metal alloy, ceramic, or an allotrope carbon. In some embodiments, the starting material comprising a polymer or a resin. In some embodiments, the method further comprises using a recycling system to (i) recycle at least a fraction of the portion of the starting material removed by the remover and/or (ii) provide at least a portion of the starting material utilized by the material dispenser in subsequent deposition. In some embodiments, the recycling system is operatively couple with the enclosure. In some embodiments, the recycling system operatively coupled with a gas conveyance system, the gas conveyance system being (i) operatively coupled with the enclosure and (ii) in fluidic communication with the enclosure. In some embodiments, the recycling system comprises the pressure differential that is at least between the enclosure and one or more components of the recycling system. In some embodiments, the method further comprises controlling a pressure in the recycling system to be above ambient pressure external to the recycling system. In some embodiments, the recycling system comprises at least one separator. In some embodiments, the method further comprises accommodating in the recycling system a pressure differential across the at least one separator. In some embodiments, the at least the portion of the starting material removed by the remover is at least about 70%, 50% or 30% of the dispensed starting material. In some embodiments, the fraction of the portion of the starting material recycled by the recycling system is at least about 70% or 90% of the portion removed by the remover. In some embodiments, the at least one first characteristic of the one or more 3D objects comprises a structure of the one or more 3D objects printed during the printing. In some embodiments, the structure of the one or more 3D objects printed comprises (i) a structure of the one or more 3D objects as it is being printed considering it being embedded in the material bed, or (ii) a structure of the one or more 3D objects as it is being printed and embedded in the material bed. In some embodiments, the structure of the one or more 3D object comprises an open cavity comprising an internal cavity space and a cavity opening fluidly coupled with the internal cavity space, and the at least one first characteristic of the one or more 3D objects comprises the internal cavity space and the cavity opening. In some embodiments, the structure of the one or more 3D object comprises an open channel comprising an internal channel space and a channel opening fluidly coupled with the internal channel space, and the at least one first characteristic of the one or more 3D objects comprises the internal channel space and the channel opening. In some embodiments, the at least one second characteristic of the material bed comprises (i) chemical composition of the material bed, (ii) morphology of the material in the material bed, or (iii) temperature of at least one portion the material bed during the printing of the one or more 3D objects. In some embodiments, the at least one portion comprises a top portion of the material bed that includes an exposed surface of the material bed. In some embodiments, the method further comprises generating the estimation of the pressure fluctuation in the enclosure at least in part by using a computational scheme. In some embodiments, the computational scheme utilizes (i) the at least one first characteristic of the one or more 3D objects printed and/or (ii) the at least one second characteristic of the material bed. In some embodiments, the method further comprises generating the estimation of the pressure fluctuation in the enclosure at least in part by using historical data associated with the pressure int the enclosure. In some embodiments, the method further comprises generating the estimation of the pressure fluctuation in the enclosure by at least in part using a learning scheme. In some embodiments, a learning set of the learning scheme utilizes (a) historical data associated with the pressure in the enclosure, (b) synthesized data associated with the pressure in the enclosure, or (c) a combination of (a) and (b). In some embodiments, the material bed comprises a starting material for the printing and/or byproduct of the printing. In some embodiments, the method further comprises utilizing the estimation of the pressure fluctuation to maintain the pressure fluctuation according to a request, the request comprising (i) the pressure fluctuation being within a requested range or (ii) the pressure fluctuation persisting at most during a requested time span. In some embodiments, the method further comprises tailoring the request to (i) a printing cycle, (ii) the at least one first characteristic of the one or more 3D objects printed, and/or (ii) the at least one second characteristic of the material bed, wherein the one or more 3D objects are printed in the printing cycle. In some embodiments, the requested range of the pressure fluctuation is at most about +/−0.3 kPa. In some embodiments, the requested time span is at most about one (1) second. In some embodiments, the method further comprises sensing at least one third characteristic of the atmosphere of the enclosure at least in part by using at least one sensor operatively coupled with the enclosure. In some embodiments, the at least one third characteristic comprises a pressure, a temperature, or concentration of at least one reactive agent. In some embodiments, the at least one sensor is located in or is operatively coupled with (i) the enclosure and/or (ii) a channel (e.g., pipe) connected to the enclosure. In some embodiments, the at least on sensor comprises at least 900 or 1000 sensors. In some embodiments, the method further comprises receiving data from the at least one sensor and regulate the pressure fluctuation based at least in part on the data received. In some embodiments, the method further comprises using the at least one valve to assist in regulation of the pressure fluctuation at least in part by forecasting a volume of gas of the atmosphere to be exchanged, the volume of the gas being with respect to volume of the atmosphere of the enclosure. In some embodiments, forecasting of the volume to be exchanged is based at least in part on the estimation of the pressure fluctuation in the enclosure. In some embodiments, the method further comprises adjusting the volume of the gas to be exchanged based at least in part on a pressure in the enclosure by using at least one sensor being configured to sense the pressure in the enclosure. In some embodiments, the method further comprises adjusting the volume of the gas to be exchanged based at least in part on the pressure in the enclosure; and optionally adjusting the volume is at least in part by using the at least one valve. In some embodiments, the at least one valve comprises discrete valve or proportional valve. In some embodiments, the at least one valve comprises (a) one or more inlet valves and (b) one or more outlet valves, the method further comprises using (i) the one or more inlet valves to assist in ingress of gas from a gas source into the enclosure or (ii) the one or more outlet valves to assist in egress of at least a portion of the atmosphere of the enclosure to a target reservoir. In some embodiments, the method further comprises using the target reservoir also as the gas source. In some embodiments, the gas comprises a robust gas, and the atmosphere of the enclosure comprises the robust gas that is different by at least one characteristic from the atmosphere external to the enclosure. In some embodiments, the at least one characteristic comprises a pressure, a temperature, or concentration of at least one reactive agent. In some embodiments, a first pressure difference between the gas source and the enclosure is larger than a second pressure difference between the enclosure and the target reservoir. In some embodiments, a first total opening area of the one or more outlet valves is larger than a second total opening area of the one or more inlet valves. In some embodiments, the number of the one or more outlet valves is greater than the number of one or more inlet valves. In some embodiments, the method further comprises regulating the pressure fluctuation of the atmosphere of the enclosure based at least in part on data received from the at least one external device. In some embodiments, the method further comprises using the at least one valve to assist at least in part in the regulation of the pressure fluctuation. In some embodiments, the method further comprises using the at least one valve to assist at least in part in exchange of at least a portion of gas of the atmosphere of the enclosure. In some embodiments, the exchange of the at least a portion of the gas of the atmosphere of the enclosure comprises the ingress or the egress. In some embodiments, the method further comprises using a reservoir to exchange at least a portion of gas of the atmosphere of the enclosure, the reservoir being configured to (i) enclose the gas in the reservoir when the exchange comprises egress of the gas from the enclosure, and (ii) release the gas disposed in the reservoir when the exchange comprises ingress of the gas into the enclosure. In some embodiments, the reservoir is a first reservoir, and the method comprises releasing at least a portion of the gas to the ambient environment when pressure in the first reservoir exceeds a maximum threshold pressure. In some embodiments, the reservoir is at least a portion of a gas conveyance system of the 3D printer.

In another aspect, an apparatus for printing one or more three-dimensional (3D) objects, the apparatus comprising one or more controllers configured to execute or direct execution of operations of any of the above the methods for printing the one or more 3D objects. In some embodiments, the one or more controllers comprise at least one connector configured to connect to a power source. In some embodiments, the one or more controllers are configured to operatively couple with a power source at least in part by (i) having a power socket and/or (ii) being configured for wireless power transfer using inductive charging.

In another aspect, non-transitory computer readable program instructions for printing one or more three-dimensional (3D) objects, the program instructions, when read by one or more processors, cause the one or more processors to execute or direct executing operations of any of the above methods for printing the one or more 3D objects. In some embodiments, the program instructions are inscribed on a medium or on media.

In another aspect, a device for printing one or more three-dimensional (3D) objects, the device comprises: a reservoir configured to exchange at least a portion of gas of an atmosphere of an enclosure, the enclosure being of a three-dimensional (3D) printer, the reservoir being configured to operatively couple with, or being part of, the 3D printer utilized for the printing of the one or more 3D objects in the enclosure, the reservoir being configured to (i) enclose the gas in the reservoir when the exchange comprises egress of the gas from the enclosure, and (ii) release the gas disposed in the reservoir when the exchange comprises ingress of the gas into the enclosure. In some embodiments, the device comprises one or more component configured to (a) operatively couple with, or be part of, the 3D printer and (b) facilitate exchange of the at least the portion of the gas of the atmosphere of the enclosure. In some embodiments, the one or more components are configured to, during the printing, facilitate exchange of the at least the portion of the gas of the atmosphere of the enclosure. In some embodiments, during the printing comprises during transformation of at least a portion of a starting material to form the one or more 3D objects, the transformation being by a transforming agent; and optionally the transforming agent comprises an energy beam. In some embodiments, during the printing excludes during transformation of at least a portion of a starting material to form the one or more 3D objects, the transformation being by a transforming agent; and optionally the transforming agent comprises an energy beam. In some embodiments, during the printing comprises during operation of at least one other component operating as part of the printing of the one or more 3D objects; optionally the at least one other components comprises (a) a material remover, (b) a recycling system, or (c) a gas nozzle configured to reduce accumulation of debris on an optical window operatively coupled with the enclosure, the debris being generated during the printing; and optionally the gas nozzle is configured to follow the gas towards a floor of the enclosure. In some embodiments, the at least one other component is configured to operate in the enclosure during the printing. In some embodiments, the at least one other component is configured to induce an alteration to the pressure in the enclosure in the enclosure during the printing. In some embodiments, the one or more component comprises at least one valve. In some embodiments, the at least one valve is configured to operatively couple with the reservoir. In some embodiments, the at least one valve comprises an inlet valve and an outlet valve, the inlet valve being configured to facilitate the ingress of the gas into the enclosure, and the outlet valve being configured to facilitate the egress of the gas from the enclosure. In some embodiments, the 3D printer that is configured to print the one or more 3D objects in a printing cycle. In some embodiments, the reservoir is configured to accommodate at least during the printing a pressure above ambient pressure external to the 3D printer. In some embodiments, the reservoir comprises at least one pressure reservoir, the at least one pressure reservoir being operatively coupled with the enclosure. In some embodiments, reservoir comprises robust gas comprising a lower concentration of at least one reactive agent compared with its concentration in an ambient atmosphere external to the 3D printer, the reactive agent being configured to react with (i) a starting material of the printing of the one or more 3D objects and/or (ii) a byproduct of the printing of the one or more 3D objects. In some embodiments, the reactive agent is configured to react at least during the printing. In some embodiments, the reactive agent comprises oxygen, water, or hydrogen. In some embodiments, the byproduct of the printing comprises soot, spatter, or splatter. In some embodiments, the printing of the one or more 3D objects comprises welding. In some embodiments, the printing of the one or more 3D objects comprises fusing. In some embodiments, the fusing comprises melting or sintering. In some embodiments, the reservoir is part of the 3D printer. In some embodiments, the device further comprises a gas conveyance system, the gas conveyance system being (a) part of the 3D printer, (b) operatively couple with the enclosure and (c) in fluidic communication with the enclosure. In some embodiments, the gas conveyance system comprises robust gas, and the robust gas comprises a lower concentration of at least one reactive agent compared with its concentration in an ambient atmosphere external to the 3D printer, the reactive agent being configured to react with (i) a starting material of the printing of the one or more 3D objects and/or (ii) a byproduct of the printing of the one or more 3D objects. In some embodiments, the gas conveyance system is configured to accommodate at least during the printing a pressure above ambient pressure external to the 3D printer. In some embodiments, during the printing comprises (a) during transformation of a starting material to print the one or more 3D objects, or (b) during operation of a components as part of the 3D printing. In some embodiments, the reservoir is configured to (i) comprise at least a portion of the gas conveyance system, or (ii) operatively couple with the gas conveyance system. In some embodiments, the device comprises at least one valve, the at least one valve being configured to operatively couple with, or be part of, the gas conveyance system. In some embodiments, the at least one valve comprises at least one restrictive valve configured to facilitate confining at least a portion of a volume of the gas conveyance system. In some embodiments, the at least one valve comprises a discrete valve. In some embodiments, the at least one valve comprises a variable valve. In some embodiments, the variable valve comprises a proportional valve and/or a discrete valve that is configured for time variation. In some embodiments, the proportional valve comprises a solenoid valve. In some embodiments, the gas conveyance system comprises the reservoir. In some embodiments, the reservoir comprises at least a portion of the gas conveyance system. In some embodiments, the at least one valve comprises a first valve and a second valve, the at least the portion of the gas conveyance system comprises a portion of the gas conveyance system between the first valve and the second valve. In some embodiments, the portion of the gas conveyance system from the first valve to the second valve comprises a passage configured for flow of the gas; optionally the passage comprises at least one channel; and optionally the passage comprises at least one pipe. In some embodiments, the passage comprises a wall, the wall comprising an elemental metal, a metal alloy, a ceramic, an allotrope of elemental metal, a polymer, or a resin. In some embodiments, the wall is configured as a composite material. In some embodiments, the wall is configured as a first material type reinforced by a second material type. In some embodiments, the wall of the passage is configured to discharge static charge during flow of the gas and any gas borne material though the passage. In some embodiments, the wall of the passage comprises an internal coating configured to be more resistive to abrasion by any gas borne material as compared to the bulk of the wall. In some embodiments, the gas borne material comprises debris or a starting material of the 3D printing. In some embodiments, the wall of the passage comprises an internal coating comprising chromium. In some embodiments, the first valve is located closer to the enclosure as compared to the second valve, and the second valve is located closer to a compressor compared to the first valve, the compressor being operatively coupled with or being part of the gas conveyance system. In some embodiments, the first valve is located closer to the enclosure and more distant from the compressor, and the second valve is located closer to the compressor and more distant from the enclosure. In some embodiments, the compressor comprises a pump. In some embodiments, the at least one valve comprises a third valve, the third valve being located between the enclosure and the first valve. In some embodiments, the third valve is bypass valve. In some embodiments, the third valve is configured to (a) split the gas disposed in the reservoir into a plurality of gas streams and (b) facilitate releasing at least one of the plurality of the gas streams during the ingress of the gas into the enclosure. In some embodiments, the at least the portion of the gas conveyance system comprises a portion of the gas conveyance system between the at least one valve and at least one compressor, the at least one compressor being configured to operatively couple with or being part of the gas conveyance system. In some embodiments, the device comprises at least one compressor, the at least one compressor being configured to operatively couple with or being part of the gas conveyance system. In some embodiments, the at least one compressor is configured to (i) facilitate flow of the gas during the egress of the gas from the enclosure into at least a portion of the gas conveyance system and/or (ii) control one or more gas related variables (e.g., characteristics). In some embodiments, the one or more gas related variables comprise a pressure, temperature, flow rate, flow acceleration, flow direction, flow homogeneity, or volume of gas flowing in the gas conveyance system. In some embodiments, the device comprises at least one filtering mechanism configured to facilitate removal of gas borne material carried by the gas egressed from the enclosure, the at least one filtering mechanism being configured to operatively couple with or being part of the reservoir. In some embodiments, the gas borne material comprises (i) a starting material of the printing of the one or more 3D objects and/or (ii) a byproduct of the printing. In some embodiments, the byproduct of the printing of the one or more 3D objects comprises soot, spatter, or splatter. In some embodiments, the device further comprises at least one container configured to collect debris from the at least one filtering mechanism, the container being configured to operatively couple with or being part of the at least one filtering mechanism. In some embodiments, the gas enclosed in the reservoir comprises at least a portion of filtered gas by the at least one filtering mechanism. In some embodiments, the device further comprises a gas enrichment system, the gas enrichment system being configured to enrich gas flowing into the enclosure with at least one reactive agent. In some embodiments, the gas enrichment system is operatively coupled with or part of the gas conveyance system. In some embodiments, at least during the printing, the reactive agent is configured to react with (i) a starting material of the printing and/or (ii) a byproduct of the printing. In some embodiments, the byproduct comprises soot, spatter, or splatter. In some embodiments, the reactive agent comprises oxygen, water, or hydrogen sulfide. In some embodiments, at least during the printing comprises a time after the printing. In some embodiments, the device further comprises a material bed disposed in the enclosure, at least a portion of the material bed being utilized to print the one or more 3D objects during the printing, the material bed comprising a starting material of the one or more 3D objects. In some embodiments, the material bed comprises a byproduct of the printing. In some embodiments, the gas comprises a robust gas, and the atmosphere of the enclosure comprises the robust gas that is different by at least one characteristic from the atmosphere external to the enclosure. In some embodiments, the at least one characteristic comprises a pressure, a temperature, or concentration of at least one reactive agent; and optionally the pressure is a positive pressure above ambient pressure. In some embodiments, the printing comprises deposition of a starting material on and/or towards a target surface. In some embodiments, the target surface comprises (i) a surface of a material bed or (ii) a surface of a build platform, the material bed being supported by the build platform, the build platform being part of or located in the enclosure, at least a portion of the material bed being utilized to print the one or more 3D objects during the printing, the material bed comprising the starting material of one or more 3D objects. In some embodiments, the device further comprises a layer dispensing mechanism, the layer dispensing mechanism being disposed in the enclosure at least during a portion of the printing, the layer dispensing mechanism being configured to deposit a layer of the starting material on the target surface, the layer of the starting material constituting the at least the portion of the material bed. In some embodiments, the layer dispensing mechanism is disposed outside of the enclosure at least during another portion of the printing. In some embodiments, the layer dispensing mechanism is disposed in an ancillary chamber coupled with the enclosure at least during another portion of the printing. In some embodiments, the layer dispensing mechanism comprises a material dispenser and a remover, the material dispenser being configured to dispense the starting material, the remover being configured to remove from the enclosure at least a portion of the starting material that does not constitute the material bed. In some embodiments, the remover is configured to planarize the layer comprising the starting material as a portion of the material bed. In some embodiments, the remover is operatively coupled with an attractive force source to attract the at least the portion of the starting material that does not constitutes the material bed from the enclosure. In some embodiments, the attractive force comprises a magnetic, electric, electrostatic, or vacuum source. In some embodiments, the attractive force comprises a vacuum source. In some embodiments, the layer dispensing mechanism further comprises a leveler, the leveler being configured to planarize the layer of the starting material. In some embodiments, the reservoir is configured to exchange the at least the portion of the gas of the atmosphere of the enclosure when the remover is operational during the printing. In some embodiments, the reservoir is configured to exchange the at least the portion of the gas of the atmosphere of the enclosure when (i) the remover starts to be loaded with removed material and/or (ii) the remover starts to be cleared of the removed material, the removed material comprising at least the portion of the starting material that does not constitute the material bed. In some embodiments, the exchange comprises the ingress when the remover starts to be cleared of the removed material. In some embodiments, the exchange comprises the egress when the remover starts to be loaded with the removed material. In some embodiments, the removed material cleared from the remover is recycled in a recycling system. In some embodiments, the layer dispensing mechanism is configured to facilitate deposition of the starting material on the target surface at least in part by layer-wise deposition. In some embodiments, the starting material comprises powder material. In some embodiments, the starting material comprises elemental metal, metal alloy, ceramic, or an allotrope carbon. In some embodiments, the starting material comprising a polymer or a resin. In some embodiments, the device further comprises a recycling system, the recycling system being configured to (i) recycle at least a fraction of a portion of the starting material removed by the remover and/or (ii) provide at least a portion of the starting material utilized by the material dispenser in subsequent deposition. In some embodiments, the recycling system is configured to operatively couple with the enclosure. In some embodiments, the recycling system is configured to operatively couple with a gas conveyance system, the gas conveyance system being (i) operatively coupled with the enclosure (ii) in fluidic communication with the enclosure, and (ii) in fluidic communication with the recycling system. In some embodiments, the reservoir is operatively coupled with the recycling system. In some embodiments, the recycling system comprises a pressure differential that is at least between the enclosure and one or more components of the recycling system. In some embodiments, the pressure differential is above ambient pressure external to the 3D printer at least during the printing. In some embodiments, the recycling system comprises at least one separator. In some embodiments, the recycling system is configured to accommodate a pressure differential across the at least one separator. In some embodiments, the at least the portion of the starting material removed by the remover is at least about 70%, 50% or 30% of the dispensed starting material. In some embodiments, the fraction of the portion of the starting material recycled by the recycling system is at least about 70% or 90% of the portion removed by the remover. In some embodiments, the reservoir comprises a plurality of reservoirs (e.g., a plurality of sub-reservoirs). In some embodiments, at least one of the plurality of the reservoirs (i) encloses the gas in the reservoir when the exchange comprises the egress of the gas from the enclosure, and (ii) releases the gas disposed in the reservoir when the exchange comprises the ingress of the gas into the enclosure. In some embodiments, the plurality of the reservoirs comprises (i) ambient atmosphere, (ii) a pressure reservoir, or (iii) at least a portion of a gas conveyance system, the pressure reservoir and the gas conveyance system being (a) operatively coupled with the enclosure and (b) in fluidic communication with the enclosure. In some embodiments, the gas conveyance system is part of the 3D printer. In some embodiments, the reservoir comprises a first reservoir and a second reservoir, the first reservoir being configured to exchange a first portion of the gas of the atmosphere of the enclosure, the second reservoir being configured to exchange a second portion of the gas of the atmosphere of the enclosure. In some embodiments, the second portion of the gas is different from the first portion of the gas. In some embodiments, the device further comprises a first sensor and a second sensor, the first sensor being configured to sense pressure in the first reservoir, the second sensor being configured to sense pressure in the second reservoir. In some embodiments, the device further comprises a first reservoir valve and a second reservoir valve, the first reservoir valve being operatively coupled with the first reservoir, the second reservoir valve being operatively coupled with the second reservoir. In some embodiments, the second reservoir valve is configured to be closed when the first reservoir exchanges the first portion of the gas of the atmosphere of the enclosure, and the first reservoir valve is configured to be closed when the second reservoir exchanges the second portion of the gas of the atmosphere of the enclosure. In some embodiments, the first reservoir valve is configured to be closed and the second reservoir valve is configured to be opened when the first pressure sensor senses a first threshold pressure in the first reservoir. In some embodiments, the first threshold pressure comprises a minimum pressure or a maximum pressure of the first reservoir. In some embodiments, the second reservoir valve is configured to be closed when the second sensor senses a second threshold pressure in the second reservoir. In some embodiments, the second threshold pressure comprises a minimum pressure or a maximum pressure of the second reservoir. In some embodiments, the reservoir is a first reservoir, and the device is configured to release the gas from the enclosure when the gas in the first reservoir is at a pressure exceeding a maximum threshold pressure, the release being to the ambient environment or to a second other reservoir. In some embodiments, the device comprises: one or more controllers configured to: (a) operatively couple with one or more components associated with a three-dimensional (3D) printer that is configured to print the one or more 3D objects; (b) generate an estimation of the pressure fluctuation in an enclosure of the 3D printer, the pressure fluctuation being during the printing of the one or more 3D objects in the enclosure, the estimation being generated at least in part by considering (i) at least one first characteristic of the one or more 3D objects printed and/or (ii) at least one second characteristic of a material bed in which the one or more 3D objects are printed, wherein at least a portion of the material bed is utilized to print the one or more 3D objects during the printing; and (c) direct the one or more components to assist in regulating the pressure based at least in part on the estimation.

In another aspect, non-transitory computer readable program instructions for printing one or more three-dimensional (3D) objects, the program instructions, when read by one or more processors operatively coupled with any of the above devices to cause the one or more processors to direct executing operations comprising one or more operations associated with at least one configuration of the device. For example, in another aspect, non-transitory computer readable program instructions for printing one or more three-dimensional (3D) objects, the program instructions, when read by one or more processors operatively coupled with at least one valve, cause the one or more processors to execute, or direct execution of, one or more operations comprises: directing the at least one valve to exchange gas of an atmosphere in an exchange at least in part by using a reservoir operatively coupled with the at least one valve, the atmosphere being of an enclosure of a three-dimensional (3D) printer, the reservoir being operatively coupled with or being part of the 3D printer utilized for the printing of the one or more 3D objects in the enclosure, the reservoir (i) enclosing the gas in the reservoir when the exchange comprises egress of the gas from the enclosure, and (ii) releasing the gas disposed in the reservoir when the exchange comprises ingress of the gas into the enclosure, the one or more processors being operatively coupled with the 3D printer. In some embodiments, the non-transitory computer readable program instructions are inscribed on a medium or on media.

In another aspect, an apparatus for printing one or more three-dimensional (3D) objects, the apparatus comprising one or more controllers comprising a power connector, the one or more controllers being configured (i) operatively couple with any of the above devices, and (ii) direct executing operations comprising one or more operations associated with at least one configuration of the device. For example, in another aspect, an apparatus for printing one or more three-dimensional (3D) objects, the apparatus comprises: one or more controllers configured to (a) operatively couple with at least one valve operatively coupled with a reservoir; and (b) direct the at least one valve to assist at least in part in exchange of gas of an atmosphere, the exchange being at least in part by using the reservoir, the atmosphere being of an enclosure of a three-dimensional (3D) printer, the reservoir being operatively coupled with or being part of the 3D printer utilized for the printing of the one or more 3D objects in the enclosure, the reservoir (i) enclosing the gas in the reservoir the exchange comprises egress of the gas from the enclosure, and (ii) releasing the gas disposed in the reservoir when the exchange comprises ingress of the gas into the enclosure. In some embodiments, the one or more controllers comprise at least one connector configured to connect to a power source. In some embodiments, the one or more controllers are configured to operatively couple with a power source at least in part by (i) having a power socket and/or (ii) being configured for wireless power transfer using inductive charging.

In another aspect, a method for printing for printing one or more three-dimensional (3D) objects, the method comprising executing one or more operations associated with at least one configuration of the above devices. for example, in another aspect, a method for printing one or more three-dimensional (3D) objects, the method comprises: exchanging gas of an atmosphere in an exchange at least in part by using a reservoir, the atmosphere being of an enclosure of a three-dimensional (3D) printer, the reservoir being operatively coupled with or being part of the 3D printer utilized for the printing of the one or more 3D objects in the enclosure, the reservoir (i) enclosing the gas in the reservoir when the exchange comprises egress of the gas from the enclosure, and (ii) releasing the gas disposed in the reservoir the exchange comprises ingress of the gas into the enclosure. In some embodiments, the method further comprises using one or more component to facilitate exchange of the at least the portion of the gas of the atmosphere of the enclosure, the one or more components configured to operatively couple with, or be part of, the 3D printer. In some embodiments, the method further comprises using the one or more component during the printing to facilitate exchange of the at least the portion of the gas of the atmosphere of the enclosure. In some embodiments, during the printing comprises during transformation of at least a portion of a starting material to form the one or more 3D objects, the transformation being by a transforming agent; and optionally the transforming agent comprises an energy beam. In some embodiments, during the printing excludes during transformation of at least a portion of a starting material to form the one or more 3D objects, the transformation being by a transforming agent; and optionally the transforming agent comprises an energy beam. In some embodiments, during the printing comprises during operation of at least one other component operating as part of the printing of the one or more 3D objects; optionally the at least one other components comprises (a) a material remover, (b) a recycling system, or (c) a gas nozzle configured to reduce accumulation of debris on an optical window operatively coupled with the enclosure, the debris being generated during the printing; and optionally the gas nozzle is configured to follow the gas towards a floor of the enclosure. In some embodiments, the method further comprises operating the at least one other components in the enclosure during the printing. In some embodiments, the method further comprises using the at least one other components during the printing to induce an alteration to the pressure in the enclosure in the enclosure. In some embodiments, the one or more component comprises at least one valve. In some embodiments, the at least one valve is configured to operatively couple with the reservoir. In some embodiments, the at least one valve comprises an inlet valve and an outlet valve, the inlet valve being configured to facilitate the ingress of the gas into the enclosure, and the outlet valve being configured to facilitate the egress of the gas from the enclosure. In some embodiments, the method further comprises using the 3D printer to print the one or more 3D objects in a printing cycle. In some embodiments, the method further comprises at least during the printing, using the reservoir to accommodate a pressure above ambient pressure external to the 3D printer. In some embodiments, the reservoir comprises at least one pressure reservoir, the at least one pressure reservoir being operatively coupled with the enclosure. In some embodiments, reservoir comprises robust gas comprising a lower concentration of at least one reactive agent compared with its concentration in an ambient atmosphere external to the 3D printer, the reactive agent being configured to react with (i) a starting material of the printing of the one or more 3D objects and/or (ii) a byproduct of the printing of the one or more 3D objects. In some embodiments, the reactive agent is configured to react at least during the printing. In some embodiments, the reactive agent comprises oxygen, water, or hydrogen. In some embodiments, the byproduct of the printing comprises soot, spatter, or splatter. In some embodiments, the printing of the one or more 3D objects comprises welding. In some embodiments, the printing of the one or more 3D objects comprises fusing. In some embodiments, the fusing comprises melting or sintering. In some embodiments, the reservoir is part of the 3D printer. In some embodiments, the method further comprises using a gas conveyance system, the gas conveyance system being (a) part of the 3D printer, (b) operatively couple with the enclosure and (c) in fluidic communication with the enclosure. In some embodiments, the gas conveyance system comprises robust gas, and the robust gas comprises a lower concentration of at least one reactive agent compared with its concentration in an ambient atmosphere external to the 3D printer, the reactive agent being configured to react with (i) a starting material of the printing of the one or more 3D objects and/or (ii) a byproduct of the printing of the one or more 3D objects. In some embodiments, the method further comprises during the printing, accommodating in the gas conveyance system a pressure above ambient pressure external to the 3D printer at least during the printing. In some embodiments, during the printing comprises (a) during transformation of a starting material to print the one or more 3D objects, or (b) during operation of a components as part of the 3D printing. In some embodiments, the reservoir is configured to (i) comprise at least a portion of the gas conveyance system, or (ii) operatively couple with the gas conveyance system. In some embodiments, the method further comprises using at least one valve, the at least one valve being configured to operatively couple with, or be part of, the gas conveyance system. In some embodiments, the at least one valve comprises at least one restrictive valve configured to facilitate confining at least a portion of a volume of the gas conveyance system. In some embodiments, the at least one valve comprises a discrete valve. In some embodiments, the at least one valve comprises a variable valve. In some embodiments, the variable valve comprises a proportional valve and/or a discrete valve that is configured for time variation. In some embodiments, the proportional valve comprises a solenoid valve. In some embodiments, the gas conveyance system comprises the reservoir. In some embodiments, the reservoir comprises at least a portion of the gas conveyance system. In some embodiments, the at least one valve comprises a first valve and a second valve, the at least the portion of the gas conveyance system comprises a portion of the gas conveyance system between the first valve and the second valve. In some embodiments, the portion of the gas conveyance system from the first valve to the second valve comprises a passage configured for flow of the gas; optionally the passage comprises at least one channel; and optionally the passage comprises at least one pipe. In some embodiments, the passage comprises a wall, the wall comprising an elemental metal, a metal alloy, a ceramic, an allotrope of elemental metal, a polymer, or a resin. In some embodiments, the wall is configured as a composite material. In some embodiments, the wall is configured as a first material type reinforced by a second material type. In some embodiments, the wall of the passage is configured to discharge static charge during flow of the gas and any gas borne material though the passage. In some embodiments, the wall of the passage comprises an internal coating configured to be more resistive to abrasion by any gas borne material as compared to the bulk of the wall. In some embodiments, the gas borne material comprises debris or a starting material of the 3D printing. In some embodiments, the wall of the passage comprises an internal coating comprising chromium. In some embodiments, the first valve is located closer to the enclosure as compared to the second valve, and the second valve is located closer to a compressor compared to the first valve, the compressor being operatively coupled with or being part of the gas conveyance system. In some embodiments, the first valve is located closer to the enclosure and more distant from the compressor, and the second valve is located closer to the compressor and more distant from the enclosure. In some embodiments, the compressor comprises a pump. In some embodiments, the at least one valve comprises a third valve, the third valve being located between the enclosure and the first valve. In some embodiments, the third valve is bypass valve. In some embodiments, the third valve is configured to (a) split the gas disposed in the reservoir into a plurality of gas streams and (b) facilitate releasing at least one of the plurality of the gas streams during the ingress of the gas into the enclosure. In some embodiments, the at least the portion of the gas conveyance system comprises a portion of the gas conveyance system between the at least one valve and at least one compressor, the at least one compressor being configured to operatively couple with or being part of the gas conveyance system. In some embodiments, the method further comprises at least during the printing, using at least one compressor, the at least one compressor being configured to operatively couple with or being part of the gas conveyance system. In some embodiments, the method further comprises using the at least one to (i) facilitate flow of the gas during the egress of the gas from the enclosure into at least a portion of the gas conveyance system and/or (ii) control one or more gas related variables (e.g., characteristics). In some embodiments, the one or more gas related variables comprise a pressure, temperature, flow rate, flow acceleration, flow direction, flow homogeneity, or volume of gas flowing in the gas conveyance system. In some embodiments, the method further comprises using at least one filtering mechanism to facilitate removal of gas borne material carried by the gas egressed from the enclosure, the at least one filtering mechanism being configured to operatively couple with or being part of the reservoir. In some embodiments, the gas borne material comprises (i) a starting material of the printing of the one or more 3D objects and/or (ii) a byproduct of the printing. In some embodiments, the byproduct of the printing of the one or more 3D objects comprises soot, spatter, or splatter. In some embodiments, the method further comprises using at least one container to collect debris from the at least one filtering mechanism, the container being configured to operatively couple with or being part of the at least one filtering mechanism. In some embodiments, the gas enclosed in the reservoir comprises at least a portion of filtered gas by the at least one filtering mechanism. In some embodiments, the method further comprises using a gas enrichment system to enrich gas flowing into the enclosure with at least one reactive agent. In some embodiments, the gas enrichment system is operatively coupled with or part of the gas conveyance system. In some embodiments, at least during the printing, the reactive agent is configured to react with (i) a starting material of the printing and/or (ii) a byproduct of the printing. In some embodiments, the byproduct comprises soot, spatter, or splatter. In some embodiments, the reactive agent comprises oxygen, water, or hydrogen sulfide. In some embodiments, at least during the printing comprises a time after the printing. In some embodiments, the method further comprises using at least a portion of a material bed disposed in the enclosure to print the one or more 3D objects during the printing, the material bed comprising a starting material of the one or more 3D objects. In some embodiments, the material bed comprises a byproduct of the printing. In some embodiments, the gas comprises a robust gas, and the atmosphere of the enclosure comprises the robust gas that is different by at least one characteristic from the atmosphere external to the enclosure. In some embodiments, the at least one characteristic comprises a pressure, a temperature, or concentration of at least one reactive agent; and optionally the pressure is a positive pressure above ambient pressure. In some embodiments, the printing comprises deposition of a starting material on, and/or towards, a target surface. In some embodiments, the target surface comprises (i) a surface of a material bed or (ii) a surface of a build platform, the material bed being supported by the build platform, the build platform being part of or located in the enclosure, at least a portion of the material bed being utilized to print the one or more 3D objects during the printing, the material bed comprising the starting material of one or more 3D objects. In some embodiments, the method further comprises using during the printing a layer dispensing mechanism, the layer dispensing mechanism being disposed in the enclosure at least during a portion of the printing, the layer dispensing mechanism being configured to deposit a layer of the starting material on the target surface, the layer of the starting material constituting the at least the portion of the material bed. In some embodiments, the layer dispensing mechanism is disposed outside of the enclosure at least during another portion of the printing. In some embodiments, the layer dispensing mechanism is disposed in an ancillary chamber coupled with the enclosure at least during another portion of the printing. In some embodiments, the layer dispensing mechanism comprises a material dispenser and a remover, and the method comprises (a) using the material dispenser to dispense the starting material, and (b) using the remover to remove from the enclosure at least a portion of the starting material that does not constitute the material bed. In some embodiments, the method further comprises using the remover to planarize the layer comprising the starting material as a portion of the material bed. In some embodiments, the method further comprises using an attractive force source operatively coupled with the remover to attract the at least the portion of the starting material that does not constitutes the material bed from the enclosure, the remover being is operatively coupled with the attractive force source. In some embodiments, the attractive force comprises a magnetic, electric, electrostatic, or vacuum source. In some embodiments, the attractive force comprises a vacuum source. In some embodiments, the layer dispensing mechanism further comprises a leveler, and the method comprises using the leveler to planarize the layer of the starting material. In some embodiments, the method further comprises using the reservoir to exchange the at least the portion of the gas of the atmosphere of the enclosure when the remover is operational during the printing. In some embodiments, the method further comprises using the reservoir to exchange the at least the portion of the gas of the atmosphere of the enclosure when (i) the remover starts to be loaded with removed material and/or (ii) the remover starts to be cleared of the removed material, the removed material comprising at least the portion of the starting material that does not constitute the material bed. In some embodiments, the exchange comprises the ingress when the remover starts to be cleared of the removed material. In some embodiments, the exchange comprises the egress when the remover starts to be loaded with the removed material. In some embodiments, the method further comprises clearing the removed material from the remover is recycled in a recycling system. In some embodiments, the method further comprises using the layer dispensing mechanism to facilitate deposition of the starting material on the target surface at least in part by layer-wise deposition. In some embodiments, the starting material comprises powder material. In some embodiments, the starting material comprises elemental metal, metal alloy, ceramic, or an allotrope carbon. In some embodiments, the starting material comprising a polymer or a resin. In some embodiments, the method further comprises using a recycling system to (i) recycle at least a fraction of a portion of the starting material removed by the remover and/or (ii) provide at least a portion of the starting material utilized by the material dispenser in subsequent deposition. In some embodiments, the recycling system is configured to operatively couple with the enclosure. In some embodiments, the recycling system is configured to operatively couple with a gas conveyance system, the gas conveyance system being (i) operatively coupled with the enclosure (ii) in fluidic communication with the enclosure, and (ii) in fluidic communication with the recycling system. In some embodiments, the reservoir is operatively coupled with the recycling system. In some embodiments, the method further comprises utilizing in the recycling system a pressure differential that is at least between the enclosure and one or more components of the recycling system. In some embodiments, the pressure differential is above ambient pressure external to the 3D printer at least during the printing. In some embodiments, the recycling system comprises at least one separator. In some embodiments, the recycling system is configured to accommodate a pressure differential across the at least one separator. In some embodiments, the at least the portion of the starting material removed by the remover is at least about 70%, 50% or 30% of the dispensed starting material. In some embodiments, the fraction of the portion of the starting material recycled by the recycling system is at least about 70% or 90% of the portion removed by the remover. In some embodiments, the reservoir comprises a plurality of reservoirs (e.g., a plurality of sub-reservoirs). In some embodiments, the method further comprises using at least one of the plurality of the reservoirs (i) to enclose the gas in the reservoir when the exchange comprises the egress of the gas from the enclosure, and (ii) to release the gas disposed in the reservoir when the exchange comprises the ingress of the gas into the enclosure. In some embodiments, the plurality of the reservoirs comprises (i) ambient atmosphere, (ii) a pressure reservoir, or (iii) at least a portion of a gas conveyance system, the pressure reservoir and the gas conveyance system being (a) operatively coupled with the enclosure and (b) in fluidic communication with the enclosure. In some embodiments, the gas conveyance system is part of the 3D printer. In some embodiments, the reservoir comprises a first reservoir and a second reservoir, and the method comprises using the first reservoir to exchange a first portion of the gas of the atmosphere of the enclosure, and using the second reservoir to exchange a second portion of the gas of the atmosphere of the enclosure. In some embodiments, the second portion of the gas is different from the first portion of the gas. In some embodiments, the method further comprises using a first sensor and a second sensor to sense pressure in the first reservoir, and using the second sensor to sense pressure in the second reservoir. In some embodiments, the method further comprises using a first reservoir valve and a second reservoir valve, the first reservoir valve being operatively coupled with the first reservoir, the second reservoir valve being operatively coupled with the second reservoir. In some embodiments, the method further comprises (a) closing the second reservoir when the first reservoir exchanges the first portion of the gas of the atmosphere of the enclosure, and (b) closing the first reservoir valve when the second reservoir exchanges the second portion of the gas of the atmosphere of the enclosure. In some embodiments, the method further comprises when the first pressure sensor senses a first threshold pressure in the first reservoir: (a) closing the first reservoir and (b) opening the second reservoir valve. In some embodiments, the first threshold pressure comprises a minimum pressure or a maximum pressure of the first reservoir. In some embodiments, the method further comprises when the second sensor senses a second threshold pressure in the second reservoir, closing the second reservoir valve. In some embodiments, the second threshold pressure comprises a minimum pressure or a maximum pressure of the second reservoir. In some embodiments, the reservoir is a first reservoir, and the method further comprises releasing the gas from the enclosure when the gas in the first reservoir is at a pressure exceeding a maximum threshold pressure, releasing of the gas being to the ambient environment or to a second other reservoir. In some embodiments, the method further comprises (a) generating an estimation of the pressure fluctuation in an enclosure of the 3D printer, the pressure fluctuation being during the printing of the one or more 3D objects in the enclosure, the estimation being generated at least in part by considering (i) at least one first characteristic of the one or more 3D objects printed and/or (ii) at least one second characteristic of a material bed in which the one or more 3D objects are printed, wherein at least a portion of the material bed is utilized to print the one or more 3D objects during the printing; and (b) using the one or more components to assist in regulating the pressure based at least in part on the estimation.

In another aspect, an apparatus for printing one or more three-dimensional (3D) objects, the apparatus comprising one or more controllers configured to direct execution of operations of any of the above the methods, for printing the one or more 3D objects. In some embodiments, the one or more controllers comprise at least one connector configured to connect to a power source. In some embodiments, the one or more controllers are configured to operatively couple with a power source at least in part by (i) having a power socket and/or (ii) being configured for wireless power transfer using inductive charging.

In another aspect, non-transitory computer readable program instructions for printing one or more three-dimensional (3D) objects, the program instructions, when read by one or more processors, cause the one or more processors to direct executing operations of any of the above methods, for printing the one or more 3D objects. In some embodiments, the non-transitory computer readable program instructions are inscribed on a medium or on media.

In another aspect, a system for effectuating the methods, operations of an apparatus, and/or operations inscribed by non-transitory computer readable program instructions (e.g., inscribed on a media/medium), disclosed herein.

In another aspect, a system for effectuating the methods, operations of an apparatus, operation of a device, and/or operations inscribed by non-transitory computer readable program instructions (e.g., inscribed on a media/medium), disclosed herein.

In another aspect, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions are inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions are inscribed on at least one medium (e.g., on a medium or on media).

In another aspect, an apparatus (e.g., for printing one or more 3D objects) comprises at least one controller that is configured (e.g., programmed) to direct a mechanism used in a 3D printing methodology to implement (e.g., effectuate) any of the method and/or operations disclosed herein, wherein the controller(s) is operatively coupled with the mechanism. In some embodiments, the controller(s) implements any of the methods and/or operations disclosed herein. In some embodiments, the at least one controller comprises, or be operatively coupled with, a hierarchical control system. In some embodiments, the hierarchical control system comprises at least three, four, or five, control levels. In some embodiments, at least two operations are performed, or directed, by the same controller. In some embodiments, at least two operations are each performed, or directed, by a different controller.

In another aspect, an apparatus (e.g., for printing one or more 3D objects) comprises at least one controller that is configured (e.g., programmed) to implement (e.g., effectuate), or direct implementation of, the method, process, and/or operation disclosed herein. In some embodiments, the at least one controller implements any of the methods, processes, and/or operations disclosed herein.

In another aspect, non-transitory computer readable program instructions (e.g., for printing one or more 3D objects), when read by one or more processors, are configured to execute, or direct execution of, the method, process, and/or operation disclosed herein. In some embodiments, the at least one controller implements any of the methods, processes, and/or operations disclosed herein. In some embodiments, at least a portion of the one or more processors is part of a 3D printer, outside of the 3D printer, or in a location remote from the 3D printer (e.g., in the cloud).

In another aspect, a system for printing one or more 3D objects comprises an apparatus (e.g., used in a 3D printing methodology) and at least one controller that is configured (e.g., programmed) to direct operation of the apparatus, wherein the at least one controller is operatively coupled with the apparatus. In some embodiments, the apparatus includes any apparatus or device disclosed herein. In some embodiments, the at least one controller implements, or direct implementation of, any of the methods disclosed herein. In some embodiments, the at least one controller directs any apparatus (or component thereof) disclosed herein.

In some embodiments, at least two operations (e.g., instructions) of the apparatus are directed by the same controller. In some embodiments, at least two operations (e.g., instructions) of the apparatus are directed by different controllers.

In some embodiments, at least two of operations (e.g., instructions) are carried out by the same processor and/or by the same sub-computer software product. In some embodiments, at least two operations (e.g., instructions) are carried out by different processors and/or by different sub-computer software products.

In another aspect, a computer software product, comprising a (e.g., non-transitory) computer-readable medium/media in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled with the mechanism. In some embodiments, the mechanism comprises an apparatus or an apparatus component.

In another aspect, a computer system comprising one or more computer processors and non-transitory computer-readable medium/media coupled thereto. In some embodiments, the non-transitory computer-readable medium/media comprises machine-executable code that, upon execution by the one or more computer processors, implements any of the methods and/or operations (e.g., as disclosed herein), and/or effectuates directions of the controller(s) (e.g., as disclosed herein).

In another aspect, a method for three-dimensional printing, the method comprises executing one or more operations associated with at least one configuration of the device(s) disclosed herein.

In another aspect, an apparatus for three-dimensional printing, the apparatus comprising at least one controller is configured (i) operatively couple to the device, and (ii) direct executing one or more operations associated with at least one configuration of the device(s) disclosed herein.

In another aspect, at least one controller is associated with the methods, devices, and software disclosed herein. In some embodiments, the at least one controller comprises at least one connector configured to connect to a power source. In some embodiments, the at least one controller being configured to operatively couple to a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control a three-dimensional printer that prints the one or more three-dimensional objects. In some embodiments, the at least one controller is configured to control at least one other component of a 3D printing system. In some embodiments, the device disclosed herein is a component of a three-dimensional printing system, and wherein the at least one controller is configured to (i) operatively couple to another component of the three-dimensional printing system and (ii) direct operation of the other component. In some embodiments, the at least one controller is configured to direct operation of the other component at least in part for participation of the other component in three-dimensional printing. In some embodiments, the at least one controller is operatively coupled with at least about 900 sensors, or 1000 sensors operatively couple to the three-dimensional printer. In some embodiments, the at least one controller is configured to control a pressure in the three-dimensional printer to be above ambient pressure external to the three-dimensional printer. In some embodiments, the at least one controller is configured to control an internal atmosphere of the three-dimensional printer to be depleted of a reactive agent relative to its concentration in an ambient atmosphere external to the device, the reactive agent being configured to react with a starting material of the three-dimensional printing at least during the three-dimensional printing.

In another aspect, non-transitory computer readable program instructions for three-dimensional printing, the non-transitory computer readable program instructions, when read by one or more processors operatively coupled to the device, cause the one or more processors to direct executing one or more operations associated with at least one configuration of the device(s) disclosed herein. In some embodiments, the program instructions are of a computer product.

In another aspect, a system for three-dimensional printing, the system comprising: the any of the devices above; and an energy beam configured to irradiate powder material (e.g., a planar layer of powder material) to print at least a portion of at least one three-dimensional object at least in part by using three-dimensional printing. In some embodiments, the system further comprising a scanner configured to translate the energy beam along a target surface, wherein the device is operatively coupled with the scanner disposed in an optical system enclosure. In some embodiments, the system further comprises an energy source configured to generate the energy beam, wherein the device is operatively coupled with the energy source. In some embodiments, the energy source comprises a laser source or an electron beam source. In some embodiments, the system further comprises at least one controller that (i) is operatively coupled with the device and (ii) direct one or more operations associated with the device. In some embodiments, the system is configured to operatively couple to at least one controller configured to (i) operatively couple to the system and (ii) direct one or more operations associated with the system.

The various embodiments in any of the above aspects are combinable (e.g., within an aspect), as appropriate.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings or figures (also “Fig.” and “Figs.” herein), of which:

FIG. 1 schematically illustrates a front view of a portion of a three-dimensional (3D) printing system and its components, and a path;

FIG. 2 schematically illustrates a perspective view of a portion of a 3D printing system and its components;

FIG. 3 schematically illustrates various views of a 3D printing system and its components;

FIG. 4 schematically illustrates various components of a portion of a 3D printing system portions thereof;

FIG. 5 schematically illustrates various components of a 3D printing system;

FIG. 6 schematically illustrates a block diagram of various 3D printing system components;

FIG. 7 schematically illustrates various components of a 3D printing system;

FIG. 8 schematically illustrates various modes of operation of components of a 3D printing system;

FIG. 9 schematically illustrates various components of a 3D printing system;

FIG. 10 schematically illustrates various gas flow modes through a processing chamber;

FIG. 11 schematically illustrates a block diagram of various manufacturing system components;

FIG. 12 schematically illustrates a block diagram of various manufacturing system components;

FIG. 13 schematically illustrates a block diagram of various manufacturing system components;

FIG. 14 schematically illustrates a processing (e.g., computer) system;

FIG. 15 shows a flow chart;

FIG. 16 shows a flow chart;

FIG. 17 shows a flow chart; and

FIG. 18 shows a flow chart.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Terms such as “a”, “an” and “the” are not intended to refer to only a singular entity but include the general class of which a specific example may be used for illustration. The terminology herein is used to describe specific embodiments in the present disclosure, but their usage does not delimit to the specific embodiments of the present disclosure. The term “includes” means includes but not limited to, the term “including” means including but not limited to, and the term “based on” means based at least in part on.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) the endpoint(s) of the range is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in “X and/or Y”—including in the specification and claims—is meant to include the options (i) X, (ii) Y, and (iii) X and Y, as applicable. The conjunction of “and/or” in the phrase “including X, Y, and/or Z” is meant to include any combination and any plurality thereof, as applicable. For example, it is meant to include the following: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as the phrase “comprising X, Y, or Z.”

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

The phrase “is/are structured” or “is/are configured,” when modifying an article, refers to a structure of the article that is able to bring about the referred result.

Fundamental length scale (abbreviated herein as “FLS”) comprises any suitable scale (e.g., dimension) of an object. For example, an FLS of an object may comprise a length, a width, a height, a diameter, a spherical equivalent diameter, a diameter of a bounding circle, a diameter of a bounding sphere, a radius, a spherical equivalent radius, or a radius of a bounding circle, or a radius of a bounding sphere.

A central tendency as understood herein comprises mean, median, or mode. The mean may comprise a geometric mean.

“Real time” as understood herein may be during at least part of the printing of a 3D object. Real time may be during a print operation. Real time may be during a print cycle. Real time may comprise: during formation of (i) a 3D object, (ii) a layer of hardened material as part of the 3D object, (iii) a hatch line, or (iv) a melt pool.

Performing a reversible first operation is understood herein to mean performing the first operation and being capable of performing the opposite of that first operation (e.g., which is a second operation). For example, when a controller directs reversibly opening a shutter, that shutter can also close, and the controller can optionally direct a closure of that shutter. For example, when a layer dispensing mechanism (e.g., recoater) reversibly translates in a first direction, that layer dispensing mechanism (e.g., recoater) can also translate in a second direction opposite to the first direction. For example, when a controller directs reversibly translating a recoater in a first direction, that recoater can translate in the first direction and can also translate in a second direction opposite to the first direction, e.g., when the controller directs the recoater to translate in the second direction.

Where suitable, one or more of the features shown in a figure comprising a 3D printer and/or components thereof can be combined with one or more of the various features of other 3D printers and/or components thereof described herein. A figure shown herein may not show certain features of a 3D printer and/or components thereof described herein. It should be understood that any such features can be incorporated within the 3D printer as requested and where suitable.

Any of the apparatuses and/or their components disclosed herein may be built by a material disclosed herein. The apparatuses and/or their components comprise a transparent or non-transparent (e.g., opaque) material. For example, the apparatuses and/or their components may comprise an organic or an inorganic material. For example, the apparatuses and/or their components may comprise an elemental metal, metal alloy, ceramic, or an allotrope of elemental carbon. For example, the enclosure, platform, recycling system, or any of their components may comprise an elemental metal, metal alloy, ceramic, or an allotrope of elemental carbon.

The present disclosure provides three-dimensional (3D) printing apparatuses, systems, software, and methods for forming a 3D object. For example, a 3D object may be formed by sequential addition of material or joining of starting material (e.g., pre-transformed material or source material) to form a structure in a controlled manner (e.g., under manual or automated control).

Transformed material, as understood herein, is a material that underwent a physical change. The physical change can comprise a phase change. The physical change can comprise fusing (e.g., melting or sintering), connecting, or bonding (e.g., physical, or chemical bond). The physical change can be a phase transformation such as from a solid to a partially liquid, or to a liquid phase.

The 3D printing process may comprise printing one or more layers of hardened material in a building cycle, e.g., in a printing cycle. A building cycle (e.g., printing cycle), as understood herein, comprises printing the (e.g., hardened, or solid) material layers of a print job (e.g., all, or substantially all, the layers of a printing job), which may comprise printing one or more 3D objects above a platform (e.g., in a single material bed). The one or more 3D object(s) may or may not be physically anchored to the platform (e.g., a build platform) above which it/they are printed.

Pre-transformed material (also referred to herein as “starting material”), as understood herein, is a material before it has been transformed (e.g., once transformed) by an energy beam during an upcoming 3D printing process, e.g., it is a starting material for an upcoming 3D printing process. The pre-transformed material may be a material that was, or was not, transformed prior to its use in the upcoming 3D printing process. The pre-transformed material may be a material that was partially transformed prior to its use in the upcoming 3D printing process. The pre-transformed material may be a starting material for the upcoming 3D printing process. The pre-transformed material may be liquid, solid, or semi-solid (e.g., gel). The pre-transformed material may be a particulate material. For example, the particulate material may be a powder material. The powder material may comprise solid particles of material(s). The particulate material may comprise vesicles (e.g., containing liquid or semi-solid material). The particulate material may comprise solid or semi-solid material particles. The pre-transformed material may be in the form of a powder, wires, sheets, or droplets. The pre-transformed material may be pulverous. The pre-transformed material may have been transformed by a 3D printer process prior to the upcoming 3D printing process. For example, in a first 3D printing process (having a first build cycle), powder material was used to form a 3D object. A remainder of the powder material of the first 3D printing process may become a pre-transformed material for an upcoming second 3D printing process (having a second build cycle). Thus, even though the remainder powder of the first 3D printing process may comprise transformed material (e.g., bits of sintered powder), it is still considered a pre-transformed material relative to the second 3D printing process. The remainder can be filtered and otherwise recycled for use as a pre-transformed material in the second 3D printing process. The remainder of the material may comprise material removed by the layer dispensing mechanism, e.g., by the remover.

In some embodiments, in a 3D printing process, the deposited pre-transformed material may be fused (e.g., sintered or melted), bound, or otherwise connected to form at least a portion of the requested 3D object. Fusing, binding, or otherwise connecting the material is collectively referred to herein as “transforming” the material. Fusing the material may refer to melting, smelting, or sintering a pre-transformed material.

In some embodiments, melting may comprise liquefying the material (i.e., transforming to a liquefied state). A liquefied state refers to a state in which at least a portion of a transformed material is in a liquid state. Melting may comprise liquidizing the material (i.e., transforming to a liquidus state). A liquidus state refers to a state in which an entire transformed material is in a liquid state. The apparatuses, methods, software, and/or systems provided herein are not limited to the generation of a single 3D object but may be utilized to generate one or more 3D objects simultaneously (e.g., in parallel) or separately (e.g., sequentially). The plurality of 3D objects may be formed in one or more material beds (e.g., powder bed). In some embodiments, a plurality of 3D objects is formed in one material bed.

At times, the printing of a (e.g., complex) 3D object involves using a combination of methodologies (e.g., having respective process parameters). In some cases, different methodologies may be used to transform different portions of the object. In some examples, 3D printing methodologies comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), arc welding (e.g., powder-based arc welding), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition. Various apparatuses (e.g., controllers), systems (e.g., 3D printers), software, methods related to types of energy beam and formation of 3D objects, as well as various control schemes are described in U.S. patent application Ser. No. 15/435,128; International Patent Application number PCT/US17/18191; European Patent Application number EP17156707.6; and International Patent Application number PCT/US18/20406, each of which is entirely incorporated herein by reference.

In some examples, 3D printing methodologies differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

In an aspect provided herein is a system for generating a 3D object comprising: an enclosure for accommodating at least one planar layer of pre-transformed material (e.g., powder); at least one energy (e.g., energy beam) capable of transforming the pre-transformed material to form a transformed material; and at least one controller (e.g., as part of a control system) that directs the energy beam(s) to impinge on the exposed surface of the layer of pre-transformed material and translate along a path (e.g., as described herein). The transformed material may be capable of hardening to form at least a portion of a 3D object. The system may comprise at least one energy source generating the energy beam(s), at least one optical system, a layer dispensing mechanism such as a recoater, gas source(s), pump(s), nozzle(s), valve(s), sensor(s), display(s), chamber(s), processor(s) comprising or software inscribed on a computer readable media/medium. The control system may be configured to control attributes including temperature, pressure, gas flow, optics, actuator(s), energy source(s), energy beam(s), and/or atmosphere(s). The chamber may comprise a base (e.g., also referred to herein as “build platform,” or “build plate”) and a substrate. The substrate may comprise a piston. The system for generating at least one 3D object (e.g., in a printing cycle) and its components may be any 3D printing system. Examples of 3D printers, their components, and associated methods, software, systems, devices, and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the deposited pre-transformed material within the enclosure is a liquid material, semi-solid material (e.g., gel), or a solid material (e.g., powder). The deposited pre-transformed material within the enclosure can be in the form of a powder, wires, sheets, or droplets. The material (e.g., pre-transformed, transformed, and/or hardened) may comprise elemental metal, metal alloy, ceramics, or an allotrope of elemental carbon. The allotrope of elemental carbon may comprise amorphous carbon, graphite, graphene, amorphous carbon, carbon fiber, carbon nanotube, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may include high performance material (HPM). The ceramic material may include a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding. Transforming can comprise chemical bonding. Chemical bonding can comprise covalent bonding.

The printed 3D object can be made of a single material (e.g., single material type) or a plurality of materials (e.g., a plurality of material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or including (e.g., with) metal alloy. The material may comprise a stainless steel. The material may comprise a titanium alloy, aluminum alloy, and/or nickel alloy.

In some cases, a layer within the 3D object comprises a single type of material. In some examples, a layer of the 3D object may comprise a single elemental metal type, or a single alloy type. In some examples, a layer within the 3D object may comprise several types of material (e.g., an elemental metal and an alloy, an alloy and a ceramic, an alloy and an elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member of elemental carbon (e.g., graphite). In some cases, a layer of the 3D object comprises more than one type of material. In some cases, a layer of the 3D object comprises more than one member of a type of material.

In some examples, the material bed, and/or 3D printing system (or any component thereof such as a build platform) may comprise any material disclosed herein. The material may comprise a material type which constituents (e.g., atoms) readily lose their outer shell electrons, resulting in a free-flowing cloud of electrons within their otherwise solid arrangement. The material bed may comprise a particulate material (e.g., powder). In some examples the material (e.g., powder, and/or 3D printer component) may comprise a material characterized in having high electrical conductivity (e.g., at least about 1*105 Siemens per meter (S/m)), low electrical resistivity (e.g., at most about 1*10-5 ohm times meter (Q*m)), high thermal conductivity (e.g., at least about 10 Watts per meter times Kelvin (W/mK)), or high density (e.g., at least about 1.5 grams per cubic centimeter (g/cm3)). The density can be measured at ambient temperature (e.g., at R.T., or 20° C.) and at ambient atmospheric pressure (e.g., at 1 atmosphere).

In some embodiments, the elemental metal is an alkali metal, an alkaline earth metal, a transition metal, a rare-earth element metal, a precious metal, or another elemental metal. The elemental metal may comprise Titanium, Copper, Platinum, Gold, Aluminum, or Silver.

In some embodiments, the metal alloy comprises iron-based alloy, nickel-based alloy, cobalt-based alloy, chrome-based alloy, cobalt chrome-based alloy, titanium-based alloy, magnesium-based alloy, or copper-based alloy. The alloy may comprise an oxidation or corrosion resistant alloy. The alloy may comprise a super alloy (e.g., Inconel, In718, Ti64, F357, Haynes282, GRCop-42, C22, CA6NM, Hastelloy-X). The alloy may comprise an alloy used for aerospace applications, automotive application, surgical application, or implant applications. The metal may include a metal used for aerospace applications, automotive application, surgical application, or implant applications.

In some embodiments, the metal alloys are refractory alloys. The refractory metals and alloys may be used for heat coils, heat exchangers, furnace components, or welding electrodes. The refractory alloys may comprise a high melting point, low coefficient of expansion, high mechanical strength, low vapor pressure at elevated temperatures, high thermal conductivity, or high electrical conductivity.

In some embodiments, the material (e.g., alloy or elemental) comprises a material used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The material may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, tablet), air conditioning, generators, furniture, musical equipment, art, jewelry, cooking equipment, or sport gear. The material may comprise an alloy used for products for human or veterinary applications comprising implants, or prosthetics. The metal alloy may comprise an alloy used for applications in the fields comprising human or veterinary surgery, implants (e.g., dental), or prosthetics.

In some embodiments, the alloy includes a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy can be a single crystal alloy. Examples of materials, 3D printers, and associated methods, software, systems, devices, materials (e.g., alloys), and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the material comprises powder material (also referred to herein as a “pulverous material”). The powder material may comprise a solid comprising fine particles. The powder may be a granular material. The powder can be composed of individual particles. At least some of the particles can be spherical, oval, prismatic, cubic, or irregularly shaped. At least some of the particles can have a fundamental length scale (e.g., diameter, spherical equivalent diameter, length, width, depth, or diameter of a bounding sphere). The central tendency of the fundamental length scale (abbreviated herein as “FLS”) of the particles can be from about 5 micrometers (μm) to about 100 μm, from about 10 μm to about 70 μm, or from about 50 μm to about 100 μm. The particles can have central tendency of the FLS of at most about 75 μm, 65 μm, 50 μm, 30 μm, 25 μm or less. The particles can have a central tendency of the FLS of at least 10 μm, 25 μm, 30 μm, 50 μm, 70 μm, or more. A central tendency of the distribution of an FLS of the particles (e.g., range of an FLS of the particles between largest particles and smallest particles) can be at least about 5 μm, 10 μm, 20 μm, 30 μm, 40 μm, 53 μm, 60 μm, or 75 μm. The particles can have a central tendency of the FLS of at most about 65 μm. In some cases, the powder particles may have central tendency of the FLS between any of the afore-mentioned FLSs.

In some embodiments, the powder comprises a particle mixture, which particle comprises a shape. The powder can be composed of a homogenously shaped particle mixture such that all the particles have substantially the same shape and FLS magnitude within at most about 1%, 5%, 8%, 10%, 15%, 20%, 25%, 30%, 35%, or 40% distribution of FLS.

At times, a plurality of build modules may be situated in an enclosure comprising the processing chamber. At times, the build module may be connected to, or may comprise an autonomous guided vehicle (AGV). The AGV may have at least one of the following: a movement mechanism (e.g., wheels), positional (e.g., optical) sensor, and controller. The controller may enable self-docking (e.g., to a docking station) and/or self-driving of the AGV. The self-docking and/or self-driving may be to and from the processing chamber. The build module may reversibly engage with (e.g., couple to) the processing chamber. The engagement of the build module with the processing chamber may be controlled (e.g., by a controller). The control may be automatic and/or manual. The engagement of the build module with the processing chamber may be reversible. In some embodiments, the engagement of the build module with the processing chamber may be permanent.

In some embodiments, the pre-transformed material (e.g., starting material for the 3D printing) is deposited in an enclosure, e.g., a build module. The build module container can contain the pre-transformed material (e.g., without spillage). Material may be placed in or inserted to the container. The material may be deposited in, pushed to, sucked into, or lifted to the container. The material may be layered (e.g., spread) in the enclosure such as by using a layer dispensing mechanism. The build module container may be configured to enclosure a substrate (e.g., an elevator piston). The substrate may be situated adjacent to the bottom of the build module container. Bottom may be relative to the gravitational field along gravitational vector pointing towards gravitational center, or relative to the position of the footprint of the energy beam on the layer of pre-transformed material as part of a material bed. The build module container may comprise a platform comprising a substrate or a base (e.g., a build plate). The platform may be situated within the build module container. The base may be situated within the build module container. The base may reside adjacent to the substrate. For example, the base may (e.g., reversibly) connect to the substrate. The pre-transformed material may be layer-wise deposited adjacent to a side of the build module container, e.g., above and/or on the bottom of the build module container. The pre-transformed material may be layered adjacent to the substrate and/or adjacent to the base. Adjacent to may be above. Adjacent to may be directly above, or directly on. The substrate may have one or more seals that enclose the material in a selected area within the build module container. The one or more seals may be flexible or non-flexible. The seal may be a hermetic seal such as a gas tight seal. The one or more seals may comprise a polymer or a resin. The enclosure, processing chamber, and/or building module container may comprise (I) a window (e.g., an optical window and/or a viewing window) or (II) an optical system. The optical window may allow the energy beam to pass through without (e.g., substantial) energetic loss. The viewing window may be any window disclosed herein. The viewing window may be a single or a double pane window. The viewing window may be an insulated glass unit (IGU). The viewing window may be configured to withstand positive pressure within the processing chamber, e.g., during printing. The positive pressure is above ambient pressure external to the build module, e.g., the ambient pressure may be about one atmosphere. During the 3D printing, a ventilator and/or gas flow may prevent debris (e.g., spatter) from accumulating on the surface of the optical window that is disposed within the enclosure (e.g., within the processing chamber). A portion of the enclosure that is occupied by the energy beam (e.g., during the 3D printing) can define a processing cone (e.g., a truncated processing cone). During the 3D printing may comprise during the entire 3D printing. The processing cone can be the space that is occupied by a non-reflected energy beam during the (e.g., entire) 3D printing. The processing cone can be the space that is occupied by an energy beam that is directed towards the material bed during the (e.g., entire) 3D printing. During the 3D printing may comprise during printing of a layer of hardened material.

In some embodiments, the 3D printer comprises a gas flow mechanism. The gas flow mechanism may be in fluidic contact with one or more enclosures of the 3D printer. For example, the gas flow mechanism may be in fluidic contact with (i) a processing chamber, (ii) a build module, (iii) an optical system enclosure, or (iv) any combination thereof. The gas flow mechanism may be in fluidic contact with a processing chamber and/or a build module. The gas flow mechanism may be in fluid communication with the optical system enclosure. At times, a gas flow assembly may be in fluid communication with the optical system enclosure. The gas flow assembly may be configured to flow gas into and out of the optical system enclosure. The gas flow assembly may be separate from the gas flow mechanism. For example, the gas flow mechanism and the gas flow assembly may be isolated (e.g., fluidically separate) from each other. The gas flow mechanism may be configured to flow gas into and out of the processing chamber. The gas flow mechanism may or may not be included in the gas conveyance system, e.g., as disclosed herein. In an example, the gas flow mechanism and the gas conveyance system can be separate from each other. In an example, the gas flow mechanism can be included in the gas conveyance system.

In some embodiments, the 3D printer comprises a layer dispensing mechanism. The pre-transformed material may be deposited in the enclosure by a layer dispensing mechanism (also referred to herein as a “layer dispenser,” “layer forming apparatus,” or “layer dispensing mechanism”). The layer dispensing mechanism may comprise a recoater. In some embodiments, the layer dispensing mechanism includes one or more material dispensers (also referred to herein as “dispensers” or “material dispensing mechanism”), and/or at least one powder removal mechanism (also referred to herein as material “remover” or “material remover”) to form a layer of pre-transformed material (e.g., starting material) as at least a portion of material bed, e.g., within the enclosure. The deposited starting material may be shaped (e.g., leveled) by a shaping operation (e.g., leveling operation). Shaping the material bed may comprise altering a shape of the exposed surface of the material bed. In some embodiments, the layer dispensing mechanism includes a leveler to planarize (e.g., smooth, such as substantially planarize) an exposed surface of a material bed within the enclosure. In some embodiments, the layer dispensing mechanism is devoid of a leveler to planarize (e.g., smooth, such as substantially planarize) an exposed surface of a material bed within the enclosure. The leveling operation may comprise using a material removal mechanism that does not contact the exposed surface of the material bed. The material removed can comprise a pre-transformed material or debris. The layer dispensing mechanism and energy beam(s) can translate and form the 3D object adjacent to (e.g., above) the platform and/or within the material bed (e.g., as described herein), while the platform gradually (e.g., sequentially and/or stepwise) lowers its vertical position to facilitate layer-wise formation of the 3D object. The material dispensing mechanism (e.g., the dispenser) can comprise a reservoir configured to retain a volume of pre-transformed material. The volume of pre-transformed material may be equivalent to about the volume of pre-transformed material sufficient for at least one or more dispensed layers above the platform. For example, the volume of pre-transformed material may be equivalent to about the volume of starting material sufficient for at least an integer number of dispensed layers above the platform. For example, the volume of pre-transformed material retained within the reservoir can be at least about 2 cubic centimeters (cc), 15 cc, 20 cc, 50 cc, 100 cc, 250 cc, 1500 cc, 2000 cc, or 2500 cc. The material dispensing mechanism can comprise a reservoir configured to retain a volume of pre-transformed material can be between any of the afore-mentioned amounts, for example, from about 2 cc to about 2500 cc. The material dispensing mechanism can dispense material at a dispensing rate (e.g., flow rate from the material dispensing mechanism) of at least 0.2 cubic centimeters per second (cm3/sec) or (cc/sec), 0.5 cc/sec, 2 cc/sec, 2.5 cc/sec, 3.5 cc/sec, 5 cc/sec, 10 cc/sec, 30 cc/sec, 50 cc/sec, 75 cc/sec, 90 cc/sec, 100 cc/sec, 110 cc/sec, 125 cc/sec, or 150 cc/sec. The dispensing rate can be between any of the afore-mentioned dispensing rates (e.g., from about 2 cc/sec to about 150 cc/sec). The layer dispensing mechanism may include components comprising a material dispensing mechanism, material leveling mechanism, material removal mechanism, or any combination or permutation thereof. Examples of 3D printing systems, apparatuses, devices, components (e.g., material dispensing mechanisms and material removal mechanisms), controllers, software, and 3D printing processes can be found in Patent Application serial number PCT/US15/36802 filed on Jun. 19, 2015; in U.S. patent application Ser. No. 17/881,797, filed Aug. 5, 2022; or in International Patent Application serial number PCT/US16/66000 filed on Dec. 9, 2016; each of which is incorporated herein in its entirety.

In some embodiments, the layer dispensing mechanism is utilized for the 3D printing. The layer dispensing mechanism can be in a layer forming mode when dispensing the material and/or shaping the material bed. The layer dispensing mechanism can be in a parked mode when the layer dispensing mechanism is in an idle position such as a parked position. In some embodiments, the layer dispensing mechanism may reside within an ancillary chamber. The layer dispenser may be physically secluded from the processing chamber when residing in the ancillary chamber. The ancillary chamber may be connected (e.g., reversibly) to the processing chamber. The ancillary chamber may be connected (e.g., reversibly) to the build module. The ancillary chamber may convey the layer dispensing mechanism adjacent to a platform (e.g., that is disposed within the build module). The layer dispensing mechanism may be retracted into the ancillary chamber (e.g., when the layer dispensing mechanism does not perform dispensing). Examples of 3D printing systems, apparatuses, devices, components (e.g., material dispensing mechanisms and material removal mechanisms), controllers, software, and 3D printing processes can be found in Patent Application serial number PCT/US15/36802 filed on Jun. 19, 2015; in Provisional Patent Application Ser. No. 62/317,070 filed Apr. 1, 2016; in International Patent Application serial number PCT/US16/66000 filed on Dec. 9, 2016; in International Patent Application Ser. No. 62/265,817, filed Dec. 10, 2015; or in Provisional Patent Application Ser. No. 63/357,901, filed on Jul. 1, 2022; each of which is incorporated herein in its entirety.

In some embodiments, the 3D object(s) are printed from a material bed. At least one FLS (e.g., width, depth, and/or height) of the material bed can be at least about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m, or 5 m. The at least one FLS (e.g., width, depth, and/or height) of the material bed can be at most about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m, or 5 m. The at least one FLS of the material bed can be between any of the afore-mentioned values (e.g., from about 50 mm to about 5 m, from about 250 mm to about 500 mm, from about 280 mm to about 1 m, or from about 500 mm to about 5 m). In some embodiments, a FLS of the material bed is in the direction of the gas flow. The build module may be configured to accommodate the material bed, e.g., having the at least one FLS disclosed herein.

In some embodiments, the 3D printer has a capacity to complete at least 1, 2, 3, 4, or 5 printing cycles before requiring human intervention. Human intervention may be required for refilling the pre-transformed (e.g., powder) material, unloading the build modules, unpacking the 3D object, removing the debris byproduct of the 3D printing, or any combination thereof. The 3D printer operator may condition the 3D printer at any time during operation of the 3D printing system (e.g., during the 3D printing process). Conditioning of the 3D printer may comprise refilling the pre-transformed material that is used by the 3D printer, replacing gas source, or replacing filters. The conditioning may be with or without interrupting the 3D printing system. For example, refilling and unloading from the 3D printer can be done at any time during the 3D printing process without interrupting the 3D printing process. Conditioning may comprise refreshing the 3D printer.

In some examples, the 3D printing system requires operation of maximum an operator during a single standard daily work shift. The 3D printing system may require operation by a human operator working at most of about 8 hours (h), 7 h, 6 h, 5 h, 4 h, 3 h, 2 h, 1 h, or 0.5 h a day. The 3D printing system may require operation by a human operator working between any of the afore-mentioned time frames (e.g., from about 8 h to about 0.5 h, from about 8 h to about 4 h, from about 6 h to about 3 h, from about 3 h to about 0.5 h, or from about 2 h to about 0.5 h a day).

In some embodiments, the enclosure and/or processing chamber of the 3D printing system may be opened to the ambient environment sparingly. In some embodiments, the enclosure and/or processing chamber of the 3D printing system may be opened by an operator (e.g., human) sparingly. Sparing opening may be at most once in at most every 1, 2, 3, 4, or 5 weeks. The weeks may comprise weeks of standard operation of the 3D printer. In some embodiments, the 3D printer has a capacity of 1, 2, 3, 4, or 5 full prints in terms of pre-transformed material (e.g., starting material such as powder) reservoir capacity. The 3D printer may have the capacity to print a plurality of 3D objects in parallel, e.g., in one material bed. For example, the 3D printer may be able to print at least 2, 3, 4, 5, 6, 7, 8, 9, or 10 3D objects in parallel.

In some embodiments, the printed 3D object is retrieved soon after terminating the last transformation operation of at least a portion of the material bed. Soon after terminating may be at most about 1 day, 12 hours, 6 hours, 3 hours, 2 hours, 1 hour, 30 minutes, 15 minutes, 5 minutes, 240 seconds (sec), 220 sec, 200 sec, 180 sec, 160 sec, 140 sec, 120 sec, 100 sec, 80 sec, 60 sec, 40 sec, 20 sec, 10 sec, 9 sec, 8 sec, 7 sec, 6 sec, 5 sec, 4 sec, 3 sec, 2 sec, or 1 sec. Soon after terminating may be between any of the afore-mentioned time values (e.g., from about is to about 1 day, from about is to about 1 hour, from about 30 minutes to about 1 day, or from about 20 s to about 240 s).

Ambient refers to a condition to which people are generally accustomed. For example, ambient pressure may be about one (1) atmosphere. Ambient temperature may be a typical temperature to which humans are generally accustomed. For example, from about 15° C. to about 30° C., from about −30° C. to about 60° C., from about −20° C. to about 50° C., from 16° C. to about 26° C., from about 20° C. to about 25° C. “Room temperature” may be measured in a confined or in a non-confined space. For example, “room temperature” can be measured in a room, an office, a factory, a vehicle, a container, or outdoors. The vehicle may be a car, a truck, a bus, an airplane, a space shuttle, a spaceship, a ship, a boat, or any other vehicle. Room temperature may represent the small range of temperatures at which the atmosphere feels neither hot nor cold, approximately 24° C. “Room temperature” may denote 20° C., 25° C., or any value from about 20° C. to about 25° C.

In some embodiments, a time lapse between the end of printing in a first material bed, and the beginning of printing in a second material bed is at most about 60 minutes (min), 40 min, 30 min, 20 min, 15 min, 10 min, or 5 min. The time lapse between the end of printing in a first material bed, and the beginning of printing in a second material bed may be between any of the afore-mentioned times (e.g., from about 60 min to about 5 min, from about 60 min to about 30 min, from about 30 min to about 5 min, from about 20 min to about 5 min, from about 20 min to about 10 min, or from about 15 min to about 5 min). The speed during which the 3D printing process proceeds is disclosed in Patent Application serial number PCT/US15/36802 that is incorporated herein in its entirety.

In some embodiments, at least one (e.g., each) energy source of the 3D printing system is able to transform (e.g., print) at a throughput of at least about 6 cubic centimeters of material per hour (cc/hr), 12 cc/hr, 35 cc/hr, 50 cc/hr, 120 cc/hr, 480 cc/hr, 600 cc/hr, 1000 cc/hr, or 2000 cc/hr. The at least one energy source may print at any rate within a range of the aforementioned values (e.g., from about 6 cc/hr to about 2000 cc/hr, from about 6 cc/hr to about 120 cc/hr, or from about 120 cc/hr to about 2000 cc/hr). At times, the 3D printing increases in efficiency when a plurality of energy beams (e.g., at least two energy beams) is used for the 3D printing. In some embodiments, the plurality of energy beams incident on a target surface may increase (i) the (e.g., total) processing field available for printing (e.g., in a X-Y plane) and/or (ii) the rate of 3D printing completion for a given print cycle (as compared to using a single energy beam). For example, the plurality of energy beams may be useful in providing a relatively larger processing area (e.g., build platform and/or material bed) in which one or more 3D objects (e.g., larger 3D object) may be generated. The processing field may be larger in relation to a 3D printing system that comprises (e.g., only) a single energy beam, which processing area is limited to the areal extent (e.g., the processing field) of the single energy beam (e.g., as guided by an optical system), which is not arbitrarily sized. For example, the time for 3D printing may be shortened when at least two of the plurality of energy beams operate simultaneously at least in part (e.g., in parallel). For example, the time for 3D printing may be shortened by at least about 25%, 50%, 75% or 95% when at least two of the plurality of energy beams operate simultaneously at least in part. The time for 3D printing may be shortened by any value of the afore-mentioned values (e.g., by from about 25% to about 95%, about 25% to about 50%, or about 50% to about 95%) when at least two of the plurality of energy beams operate simultaneously at least in part. A shortened time may be relative to a 3D printing system that does not use a plurality of energy beams (e.g., uses only a single energy beam). Examples of 3D printing systems, apparatuses, devices, components, controllers, software, and 3D printing processes (e.g., speed of printing, throughput of printing processes) can be found in International Patent Application Serial No. PCT/US15/36802, and in International Patent Application Serial No. PCT/US19/226364, filed on May 16, 2019, each of which is incorporated herein by reference in its entirety.

In some embodiments, the at least one 3D object is removed from the material bed after the completion of the 3D printing process. For example, the 3D object(s) may be removed from the material bed when the transformed material that formed the 3D object hardens. For example, the 3D object may be removed from the material bed when the transformed material that formed the 3D object is no longer susceptible to deformation under standard handling operation (e.g., human and/or machine handling).

In some examples, the generated 3D object adheres (e.g., substantially) to a requested model of the 3D object. Substantially may be with relation to the intended purpose of the 3D object. The 3D object (e.g., solidified material) that is generated can be formed with high fidelity, e.g., having a high fidelity (e.g., high accuracy) of one or more characteristics (e.g., dimensions) of the generated 3D object when compared to a model or simulation of the intended 3D object. For example, have an average deviation percentage from intended dimensions that are at most about 5%, 2%, 1%, 0.5%, 0.25%, 0.1%, 0.05%, or less. For example, the 3D object that is generated can have an average deviation value from the intended dimensions (e.g., of a requested 3D object) of at most about 0.5 microns (μm), 1 μm, 3 μm, 10 μm, 30 μm, 100 μm, 300 μm or less from a requested model of the 3D object. The deviation can be any value between the afore-mentioned values. The average deviation can be from about 0.5 μm to about 300 μm, from about 10 μm to about 50 μm, from about 15 μm to about 85 μm, from about 5 μm to about 45 μm, or from about 15 μm to about 35 μm. The 3D object can have a deviation from the intended dimensions in a specific direction, according to the formula D_v+L/K_dv, wherein D_v is a deviation value, L is the length of the 3D object in a specific direction, and K_dv is a constant. D_v can have a value of at most about 300 μm, 200 μm, 100 μm, 50 μm, 40 μm, 30 μm, 20 μm, 10 μm, 5 μm, 1 μm, or 0.5 μm. D_v can have a value of at least about 0.5 μm, 1 μm, 3 μm, 5 μm, 10 μm, 20 μm, 30 μm, 50 μm, 70 μm, 100 μm, 300 μm or less. D_v can have any value between the afore-mentioned values. For example, D_v can have a value that is from about 0.5 μm to about 300 μm, from about 10 μm to about 50 μm, from about 15 μm to about 85 μm, from about 5 μm to about 45 μm, or from about 15 μm to about 35 μm. K_dv can have a value of at most about 3000, 2500, 2000, 1500, 1000, or 500. K_dvcan have a value of at least about 500, 1000, 1500, 2000, 2500, or 3000. K_dv can have any value between the afore-mentioned values. For example, K_dv can have a value that is from about 3000 to about 500, from about 1000 to about 2500, from about 500 to about 2000, from about 1000 to about 3000, or from about 1000 to about 2500.

At times, the 3D object printed by the 3D printing system is a high fidelity 3D object. At times, the generated 3D object (e.g., the hardened cover) is substantially smooth. The generated 3D object may have a deviation from an ideal planar surface (e.g., atomically flat or molecularly flat) of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or less. The generated 3D object may have a deviation from an ideal planar surface of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or more. The generated 3D object may have a deviation from an ideal planar surface between any of the afore-mentioned deviation values. The generated 3D object may comprise a pore. The generated 3D object may comprise pores. The pores may be of an average FLS (diameter or diameter equivalent in case the pores are not spherical) of at most about 1.5 nanometers (nm), 2 nm, 3 nm, 4 nm, 5 nm, 10 nm, 15 nm, 20 nm, 25 nm, 30 nm 35 nm, 100 nm, 300 nm, 500 nm, 1 micrometer (μm), 1.5 μm, 2 μm, 3 μm, 4 μm, 5 μm, 10 μm, 15 μm, or 20 μm. The pores may be of an average FLS of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, or 20 μm. The pores may be of an average FLS between any of the afore-mentioned FLS values (e.g., from about 1 nm to about 20 μm). The 3D object (or at least a layer thereof) may have a porosity of at most about 0.05 percent (%), 0.1% 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have a porosity of at least about 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have porosity between any of the afore-mentioned porosity percentages (e.g., from about 0.05% to about 80%, from about 0.05% to about 40%, from about 10% to about 40%, or from about 40% to about 90%). In some instances, a pore may traverse the generated 3D object. For example, the pore may start at a face of the 3D object and end at the opposing face of the 3D object. The pore may comprise a passageway extending from one face of the 3D object and ending on the opposing face of that 3D object. In some instances, the pore may not traverse the generated 3D object. The pore may form a cavity in the generated 3D object. The pore may form a cavity on a face of the generated 3D object. For example, pore may start on a face of the plane and not extend to the opposing face of that 3D object.

The resolution of the printed 3D object may be at least about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or more. The resolution of the printed 3D object may be at most about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or less. The resolution of the printed 3D object may be any value between the above-mentioned resolution values. At times, the 3D object may have a material density of at least about 99.9%, 99.8%, 99.7%, 99.6%, 99.5%, 99.4%, 99.3%, 99.2% 99.1%, 99%, 98%, 96%, 95%, 94%, 93%, 92%, 91%, 90%, 8%, or 70%. At times, the 3D object may have a material density of at most about 99.5%, 99%, 98%, 96%, 95%, 94%, 93%, 92%, 91%, 90%, 8%, or 70%. At times, the 3D object may have a material density between the afore-mentioned material densities. The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dpi. The resolution of the 3D object may be any value between the afore-mentioned values (e.g., from 100 dpi to 4800 dpi, from 300 dpi to 2400 dpi, or from 600 dpi to 4800 dpi). The height uniformity (e.g., deviation from average surface height) of a planar surface of the 3D object may be at least about 100 μm, 90 μm, 80 μm, 70 μm, 60 μm, 50 μm, 40 μm, 30 μm, 20 μm, 10 μm, or 5 μm. The height uniformity of the planar surface may be at most about 100 μm, 90 μm, 80 μm, 70 μm, 60 μm, 50 μm, 40 μm, 30 μm, 20 μm, 10 μm, or 5 μm. The height uniformity of the planar surface of the 3D object may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity.

At times, the generated 3D object (i.e., the printed 3D object) does not require further processing following its generation (e.g., retrieval) by a method described herein. The printed 3D object may require reduced amount of processing after its generation by a method described herein. For example, the printed 3D object may not require removal of auxiliary support (e.g., since the printed 3D object was generated as a 3D object devoid of auxiliary support) and/or removal of transformed material. The printed 3D object may not require smoothing, flattening, polishing (e.g., sanding), leveling, trimming, annealing, or curing. The printed 3D object may not require further machining. In some examples, the printed 3D object may require one or more treatment operations following its generation (e.g., post generation treatment, or post printing treatment). The further treatment step(s) may comprise surface scraping, machining, polishing, grinding, blasting (e.g., sand blasting, bead blasting, shot blasting, or dry ice blasting), annealing, or chemical treatment. Examples of 3D printing systems, apparatuses, devices, components, controllers, software, and 3D printing processes (e.g., post-processing, post-generation treatment, and post-printing treatment) can be found in U.S. patent application Ser. No. 17/835,023, filed on Jun. 8, 2022, and U.S. Provisional Patent Application Ser. No. 63/289,787, filed Dec. 15, 2021, each of which are entirely incorporated herein by reference.

In some embodiments, the 3D printer comprises a chamber having an interior space. The chamber may be referred to herein as a “processing chamber.” The processing chamber may facilitate ingress of at least one energy beam into the processing chamber. The energy beam(s) may be directed towards a target surface, e.g., an exposed surface of a material bed. The 3D printer may comprise one or more modules, e.g., build modules. At times, at least one build module may be situated in the enclosure and coupled with the processing chamber. At times, at least one build module may reversibly engage with (e.g., couple to) the processing chamber to expand an interior volume of the processing chamber, e.g., to form at least a portion of the chamber.

In some embodiments, the 3D printing system comprises a build module. The build module may be mobile or stationary. The build module may comprise an elevation mechanism, e.g., comprising a build platform assembly. The build module may comprise the build platform (e.g., base) that may be coupled with the build platform assembly. The build platform may be disposed within the build module. The build platform may reside adjacent to the substrate, e.g., above the substrate relative to a gravitational center of the environment (e.g., Earth). The elevation mechanism may be reversibly connected to (and disconnected from) at least a portion of the build platform. The elevation mechanism may comprise a portion that vertically translates the build platform with respect to a gravitational center (e.g., a gravitational center of the Earth). The build platform may be disposed on the substrate. The build platform and the substrate may operatively couple (e.g., physically connect). The material bed may be disposed above build platform. The build platform may support the material bed. The build platform may comprise, or be configured to operatively couple to, an engagement mechanism. The substrate may comprise, or be configured to operatively couple to, an engagement mechanism. The engagement mechanism may facilitate engagement and/or dis-engagement between a base (e.g., of the build platform) and the substrate. The build platform may be configured to support one or more layers of pre-transformed material (e.g., as part of the material bed). The build platform may be configured to support at least a portion of the 3D object (e.g., during forming of the 3D object). The substrate and/or the base (e.g., build platform) may be removable or non-removable (e.g., from the 3D printing system and/or relative to each other). The substrate and/or base may be fastened (I) to the build module and/or (II) to each other. The build platform and/or substrate may be translatable, e.g., before, during, and/or after printing one or more 3D objects in a print cycle. The translation of the build platform may be effectuated (e.g., controlled and/or regulated) by the build platform assembly and/or an actuator (e.g., by at least one controller and/or by a control system). The build platform assembly may be configured to provide a high precision platform for building one or more 3D objects in a printing cycle with high fidelity. The translation of the substrate may be controlled and/or regulated by at least one controller (e.g., by a control system). The build platform and/or substrate may be translatable horizontally, vertically, or at an angle (e.g., planar or compound angle). The translation may be in both directions (e.g., back and forth such as up and down relative to a gravitational vector). The control system may be any control system disclosed herein, e.g., a control system of the 3D printer such as the one controlling an energy beam. The substrate may comprise a piston. At times, the 3D printing system may comprise more than one substrate. At times, the 3D printing system may comprise more than one piston. The disclosure herein relating to the substrate may apply to the substrates.

In some embodiments, the build module, processing chamber, and/or enclosure comprises one or more seals. The seal may be a sliding seal or a stationary (e.g., top) seal. For example, the build module and/or processing chamber may comprise a sliding seal that meets with the exterior of the build module upon engagement of the build module with the processing chamber. During at least a portion of the 3D printing process, the atmospheres of the build module and processing chamber may be separate. For example, the processing chamber may comprise a top seal that faces the build module and is pushed upon engagement of the processing chamber with the build module. For example, the build module may comprise a top seal that faces the processing chamber and is pushed upon engagement of the processing chamber with the build module. The seal may be a face seal, or compression seal. The seal may comprise an O-ring. For example, the build module and the processing chamber may be separated by a load lock. The seal may be impermeable or substantially impermeable to at least one gas. The seal may be permeable to at least one gas. The seal may be impermeable to a solid material (e.g., the pre-transformed material and/or the transformed material). The seal may be flexible. The seal may be elastic. The seal may be bendable. The seal may be compressible. The seal may include a material comprising rubber (e.g., latex), Teflon, plastic, or silicon. The seal may comprise a mesh, membrane, sieve, paper (e.g., filter paper), cloth such as felt (e.g., Aramid felt, or another high temperature felt or fiber), or a brush. The mesh, membrane, paper and/or cloth may comprise randomly or non-randomly arranged fibers. The paper may comprise a HEPA filter.

In some embodiments, the substrate is separated from the base (e.g., build platform) assembly by a seal. The base and/or the substrate may be separated from the internal surface (e.g., side walls) of the build module by one or more seals. The seal may be attached to the moving build platform and/or substrate (e.g., while the walls of the build module are devoid of a seal). The seal may be attached to the (e.g., vertical) walls of the build module (e.g., while the build platform and/or substrate is devoid of a seal). In some embodiments, both the build platform and/or substrate and the walls of the build module comprise a seal. The seal may be placed laterally (e.g., horizontally) between one or more walls (e.g., side walls) of the build module. The seal may be connected to a bottom plane of the build platform and/or substrate. The seal may be connected to a side (e.g., circumference) of the build platform and/or substrate.

The seal may be permeable to at least one gas. The seal may be impermeable or substantially impermeable to at least one gas. The seal may be impermeable to a solid material (e.g., the pre-transformed material and/or the transformed material). The seal may be impermeable to particulate material (e.g., powder). The seal may not allow permeation of particulate material into the build platform assembly and/or piston assembly. The build platform assembly may comprise a piston and a build platform. The piston assembly may comprise a piston. The seal may be flexible. The seal may be elastic. The seal may be bendable. The seal may be compressible. The seal may include a material comprising a polymeric material (e.g., nylon, polyurethane), Teflon, plastic, rubber (e.g., latex), or silicon. The seal may comprise a mesh, membrane, sieve, paper (e.g., filter paper), cloth (e.g., felt, or wool), or brush. The mesh, membrane, paper and/or cloth may comprise randomly and/or non-randomly arranged fibers. The paper may comprise a HEPA filter.

In some embodiments, the 3D printing system comprises a build module, e.g., as disclosed herein. The build module may accommodate a material bed having at least one (e.g., two or more) FLS (e.g., diameter, width, and/or height) of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 2500 mm, 3000 mm, 3500 mm, 4000 mm, or 4500 mm. The FLS of the material bed accommodated by the build module may have a FLS value between any of the aforementioned values (e.g., from about 100 mm to about 4500 mm, from about 100 mm to about 2000 mm, from about 100 mm to about 700 mm, or from about 300 mm to about 4000 mm). In addition to the material bed, the build module may be configured to accommodate a base (e.g., build platform) and at least one substrate (e.g., piston). The build module may accommodate a build platform having an FLS (e.g., diameter or width) of at least about 100 millimeters (mm), 200 mm, 300 mm, 400 mm, 500 mm, 600 mm, 700 mm, 800 mm, 900 mm, 1000 mm, 1500 mm, or 2000 mm, 2500 mm, 3000 mm, 3500 mm, or 4000 mm. The build module may accommodate a build platform having at least one FLS (e.g., diameter, height and/or width), the FLS being of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 4000 mm, or 4500 mm. The FLS of the build platform accommodated by the build module may have a FLS value between any of the aforementioned values (e.g., from about 100 mm to about 4500 mm, from about 100 mm to about 1200 mm, from about 100 mm to about 1500 mm, or from about 300 mm to about 2000 mm). The build platform assembly may be able to translate in a continuous and/or discrete manner. The build platform assembly may be able to translate in discrete increments of at most about 5 micrometers (μm), 20 μm, 30 μm, 40 μm, 50 μm, 60 μm, 70 μm, or 80 μm. The build platform assembly may be able to translate in discrete increments having a value between any of the aforementioned values (e.g., from about 5 μm to about 80 μm, from about 10 μm to about 60 μm, or from about 40 μm to about 80 μm). The build platform assembly may have a precision (e.g., error +/−) of at most about 0.25 μm, 0.5 μm, 1 μm, 1.5 μm, 2 μm, 2.5 μm, 3 μm, 4 μm, or 5 μm. The build platform assembly may have a precision value between any of the aforementioned precision value (e.g., from about 0.25 μm to about 5 μm, from about 0.25 μm to about 2.5 μm, or from about 1.5 μm to about 5 μm). The build platform assembly may have a precision (e.g., error +/−) of at most about 0.5%, 1%, 2%, 3%, 4%, 5%, 6%, 8% or 10% of its incremental movement. The build platform assembly may have a precision value between any of the aforementioned precision value relative to its incremental movement (e.g., from about 0.5% to about 10%, from about 0.5% to about 5%, or from about 1% to about 10%). The weight of the material bed (e.g., including any printed 3D object therein) may be at least about 300 Kilograms (Kg), 500 Kg, 800 Kg, 1000 Kg, 1200 Kg, 1500 Kg, 1800 Kg, 2000 Kg, 2500 Kg, or 3000 Kg. The weight of the material bed (e.g., including any printed 3D object therein) may be between any of the aforementioned values (e.g., from about 300 Kg to about 3000 Kg, from about 300 Kg to about 1500 Kg, or from about 1000 Kg to about 3000 Kg). The build platform assembly may be configured to translate the build module at a speed of at most 3 millimeters per second (mm/sec), 5 mm/sec, 10 mm/sec, 20 mm/sec, 30 mm/sec, or 50 mm/sec. The build platform assembly may be configured to translate the build module at a speed of at least 1 mm/sec, 3 mm/sec, 5 mm/sec, 10 mm/sec, 20 mm/sec, 30 mm/sec, or 40 mm/sec. The build platform assembly may be configured to translate the build module at a speed between any of the aforementioned speeds (e.g., from about 1 mm/sec to about 50 mm/sec, from about 1 mm/sec to about 20 mm/sec, or from about 5 mm/sec to about 50 mm/sec). The build platform assembly may be configured to translate the build module at a speed of at most 1 millimeter per second squared (mm/sec\hat{ }2), 2.5 mm/sec\hat{ }2, 5 mm/sec\hat{ }2, 7.5 mm/sec\hat{ }2, 10 mm/sec\hat{ }2, or 20 mm/sec\hat{ }2. The build platform assembly may be configured to translate the build module at an acceleration of at least 0.5 mm/sec\hat{ }2, 1 mm/sec\hat{ }2, 2 mm/sec\hat{ }2, 3 mm/sec\hat{ }2, 5 mm/sec\hat{ }2, 10 mm/sec\hat{ }2, or 15 mm/sec\hat{ }2. The build platform assembly may be configured to translate the build module at a speed between any of the aforementioned speeds (e.g., from about 0.5 mm/sec\hat{ }2 to about 20 mm/sec\hat{ }2, from about 0.5 mm/sec\hat{ }2 to about 10 mm/sec\hat{ }2, or from about 4 mm/sec\hat{ }2 to about 20 mm/sec\hat{ }2). The build platform assembly may be configured such that a time to complete a translation of a first portion of the build platform assembly relative to a second portion of the build platform assembly (e.g., to perform a block movement) is at most about 120 seconds (sec), 60 sec, 50 sec, 45 sec, 40 sec, 35 sec, 30 sec, 25 sec, 20 sec, 15 sec, or less. The build platform assembly may be configured such that a time to complete a translation of a first portion of the build platform assembly relative to a second portion of the build platform assembly is any value between the aforementioned values, for example, from about 120 sec to 40 sec, from about 60 sec to 25 sec, or from about 35 sec to 15 sec.

In some embodiments, the pre-transformed material (e.g., starting material for the 3D printing) is deposited in an enclosure to form a material bed. The pre-transformed material may be layered on a target surface, e.g., on an exposed surface of a material or on a surface of the build platform. The deposited layer of pre-transformed material may be substantially planar. For example, the deposited layer may have a central tendency of planarity (e.g., a surface roughness R_a) that is from about 15% to about 65% of a second central tendency of thickness of the deposited layer. The second central tendency of thickness of the deposited layer may be (e.g., substantially) equal to a discrete increment of vertical translation of the platform. The second central tendency of thickness of the deposited layer may be (e.g., substantially) equal to any discrete increment of vertical translation of the build platform assembly, e.g., as disclosed herein.

In some embodiments, the 3D printer comprises an energy source that generates an energy beam. The energy beam may project energy to the material bed. The apparatuses, systems, and/or methods described herein can comprise at least one energy beam. In some cases, the 3D printing system can comprise at least two, three, four, five, eight, twelve, sixteen, twenty-four, thirty-two, or more energy beams. The energy beam may include radiation comprising electromagnetic, electron, positron, proton, plasma, or ionic radiation. The electromagnetic beam may comprise microwave, infrared, ultraviolet or visible radiation. The ion beam may include a cation or an anion. The electromagnetic beam may comprise a laser beam. The energy beam may derive from a laser source. In some embodiments, the energy source is an energy beam source. The energy source may be a laser source. The laser may comprise a fiber laser, a solid-state laser or a diode laser (e.g., diode pumped fiber laser).

In some embodiments, the energy source is a laser source. The laser source may comprise a Nd: YAG, Neodymium (e.g., neodymium-glass), or an Ytterbium laser. The laser beam may comprise a corona laser beam, e.g., a laser beam having a footprint similar to a doughnut shape. The laser may comprise a carbon dioxide laser (CO2 laser). The laser may be a fiber laser. The laser may be a solid-state laser. The laser can be a diode laser. The energy source may comprise a diode array. The energy source may comprise a diode array laser. The laser may be a laser used for micro laser sintering. Examples of 3D printing systems, apparatuses, devices, components (e.g., energy beams), controllers, software, and 3D printing processes can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the energy beam (e.g., transforming energy beam) comprises a Gaussian energy beam. The energy beam may have any cross-sectional shape comprising an ellipse (e.g., circle), or a polygon (e.g., as disclosed herein). The energy beam may be continuous or non-continuous (e.g., pulsing). The energy beam may be modulated before and/or during the formation of a transformed material as part of the 3D object. The energy beam may be modulated before and/or during the 3D printing process. In some embodiments, the energy beam (e.g., laser) has a power of at least about 150 Watt (W), 200 W, 250 W, 350 W, 500 W, 750 W, 1000 W, or 1500 W. The energy source may have a power between any of the afore-mentioned energy beam power values (e.g., from about from about 150 W to about 1000 W, or from about 1000 W to about 1500 W). The energy beam may derive from an electron gun.

In some embodiments, the 3D printer includes a plurality of energy beam, e.g., laser beams. The 3D printer may comprise at least 2, 4, 6, 8, 10, 12, 16, 20, 24, 32, 36, 64, or more energy beams. Each of the energy beam may be coupled with its own optical window. At times, at least two energy beams may shine through the same optical window. At times, at least two energy beams may shine through different optical windows.

In some embodiments, the energy beam (e.g., transforming energy beam) comprises a Gaussian energy beam. The energy beam may have any cross-sectional shape comprising an ellipse (e.g., circle), or a polygon (e.g., as disclosed herein). The energy beam may be continuous or non-continuous (e.g., pulsing). The energy beam may be modulated before and/or during the formation of a transformed material as part of the 3D object. The energy beam may be modulated before and/or during the 3D printing process.

In some embodiments, the beam profile of the energy beam is altered, e.g., during printing. Any of the 3D printing methodologies disclosed herein can include altering the beam profile. Alteration of the beam profile can be using a physical component and/or a computational scheme (e.g., algorithm). Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a ring (e.g., corona or doughnut) beam profile. For example, the energy beam may print a first portion of the 3D object using a gaussian beam profile, and then print a second portion of the 3D object using a ring shaped beam profile.

In some embodiments, the beam profile of the energy beam is altered, e.g., during printing. Any of the 3D printing methodologies disclosed herein can include altering the beam profile. Alteration of the beam profile can be using a physical component and/or a computational scheme (e.g., algorithm). Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a doughnut (e.g., corona) beam profile. For example, the energy beam may print a first portion of the 3D object using a gaussian beam profile, and then print a second portion of the 3D object using a doughnut shaped beam profile.

In some embodiments, the energy beam(s) is/are utilized for the 3D printing. The energy beam(s) can translate vertically, horizontally, or in an angle (e.g., planar or compound angle). The energy beam(s) can be modulated. The energy beam(s) emitted by the energy source(s) can be modulated.

In some embodiments, at least one of the energy beams is moveable with respect to a material bed and/or 3D printing system. Movable can be relative to the processing chamber, the build module, the target surface, or any combination thereof. The energy beam can be moveable such that it can translate relative to the material bed (e.g., across the top surface of the material bed), e.g., during the printing. The energy beam can be moved by an optical system (e.g., comprising a scanner). The movement of the energy beam can comprise utilization of a scanner e.g., optical scanner to move the energy beam, or mechanical stage type scanner to move the target surface on which the energy beam impinges. The energy beams can be translated independently of each other. In some cases, at least two energy beams can be translated at different rates, and/or along different paths. For example, the movement of a first energy beam may be faster (e.g., at a greater rate) as compared to the movement of a second energy beam. At times, the energy beam(s) are modulated. The energy (e.g., beam) emitted by the energy source can be modulated. The modulator can comprise an amplitude modulator, a phase modulator, or polarization modulator. The modulation may alter the intensity of the energy beam. The modulation may alter the shape (e.g., footprint) of the energy beam. The modulation may alter the current supplied to the energy source (e.g., direct modulation). The modulation may affect (e.g., alter) the energy beam, e.g., external modulation such as external light modulator. The modulator can comprise an acousto-optic modulator or an electro-optic modulator. The modulator can comprise an absorptive modulator or a refractive modulator. The modulation may alter the absorption coefficient of the material that is used to modulate the energy beam. The modulator may alter the refractive index of the material that is used to modulate the energy beam. The energy beam, and/or the platform can be moved by at least one scanner, e.g., optical scanner can move the energy beam, or mechanical stage type scanner to move the target surface on which the energy beam impinges such as moving a material bed having an exposed. The scanner can be included in an optical system that is configured to direct energy beam from the energy source to a predetermined position on the (target) surface, e.g., an exposed surface of the material bed. At least two scanners may be operably coupled with a single energy source and/or energy beam. In some embodiments, at least two energy beams are moved by the same scanner. At least two (e.g., each) energy sources and/or beams may have a separate scanner. In some embodiments, at least two energy beams are moved with different scanners, e.g., are each moved with a different scanner. The scanner may comprise one or more optical elements, e.g., mirrors. The scanner may comprise a galvanometer scanner (e.g., a two-axis galvanometer scanner), a polygon, a mechanical-stage (e.g., X-Y-stage), a piezoelectric device, gimbal, or any combination thereof. The galvanometer scanner may comprise a mirror. The scanner may comprise a modulator. The scanner may comprise a polygonal mirror. The systems and/or apparatuses disclosed herein may comprise one or more shutters (e.g., safety shutters). The energy source(s) can project energy using a DLP modulator, a one-dimensional scanner, a two-dimensional scanner, or any combination thereof.

In some embodiments, the energy source is used to generate the energy beam. The energy source can be stationary. In some embodiments, the energy beam (e.g., laser beam) impinges onto an exposed surface of a material bed to generate at least a portion of a 3D object. The energy beam may be a focused beam. The energy beam may be a dispersed beam. The energy beam may be an aligned beam. The apparatus and/or systems described herein may comprise a focusing coil, a deflection coil, or an energy beam power supply. The optical system may be configured to direct at least one energy beam from the at least one energy source to a position on a target surface such as an exposed surface of the material bed within the enclosure, e.g., to a predetermined position on the target surface. The 3D printing system may comprise a processor (e.g., a central processing unit). The processor can be programmed to control a trajectory of the at least one energy beam and/or energy source e.g., with the aid of the optical system and/or optical actuator(s). The systems and/or the apparatus described herein can comprise a control system in communication with the energy source(s) and/or energy beam(s). The control system can regulate a supply of energy from the energy source(s) to the material (e.g., to the pre-transformed material), e.g., to form the transformed material. The control system may control the various components of the optical system. The various components of the optical system may include optical components comprising a mirror(s), a lens (e.g., concave or convex), a fiber, a beam guide, a rotating polygon, or a prism. The optical system may be enclosed in an optical system enclosure, e.g., of the system of optical assemblies. Examples of 3D printing systems, apparatuses, devices, and components (e.g., optical housing and optical system), controllers, software, and 3D printing processes can be found Patent Application serial number PCT/US17/64474, filed Dec. 4, 2017, in International Patent Application serial number PCT/US18/12250, filed Jan. 3, 2018, in International Patent Application Serial No. PCT/US19/226364, filed on May 16, 2019, or in U.S. Provisional Patent Application 63/348,901 filed on Jun. 3, 2022, each of which is incorporated herein by reference in its entirety.

In some embodiments, the 3D printer comprises a power supply. The power supply to any of the components described herein can be supplied by a grid, generator, local, or any combination thereof. The power supply can be from renewable or non-renewable sources. The renewable sources may comprise solar, wind, hydroelectric, or biofuel. The power supply can comprise rechargeable batteries.

In some embodiments, the 3D printing system can comprise two, three, four, five, eight, ten, sixteen, eighteen, twenty, twenty-four, thirty-two, thirty-six, or more energy sources that each generates an energy beam (e.g., laser beam). An energy source can be a source configured to deliver energy to an area (e.g., a confined area). The energy can be in the form of an energy beam such as a laser beam or an electron beam. An energy source can deliver energy to the confined area through radiative heat transfer. The energy source may comprise a laser source or an electron beam source.

In some embodiments, the 3D printing system can comprise at least one (e.g., a plurality of) optical windows. The optical window(s) may be arranged on a roof of the processing chamber. The optical window(s) may be arranged on a side wall of the processing chamber. The optical window(s) may be arranged with respect to the processing chamber to allow transmittance of energy beam(s) directed by the array of optical assemblies into the processing chamber. The optical window(s) may be arranged with respect to the processing chamber to allow transmittance of energy beam(s) directed by the array of optical assemblies into the processing chamber and incident on the target surface supported by the build platform. During the 3D printing, a ventilator and/or gas flow may deter (e.g., measurably and/or substantially prevent) debris from accumulating on the surface of optical window(s) that are disposed within the enclosure (e.g., within the processing chamber). The debris may comprise soot, spatter, or splatter. The optical window may be supported by (or supportive of) a nozzle that directs debris away from the optical window, e.g., at towards the material bed. The processing cone may assume a shape of a truncated cone within the processing chamber.

In some embodiments, the 3D printing system comprises one or more sensors. The one or more sensors may be at least about 500, 600, 900, or 1000 sensors. At least two of the sensors may be of the same type. At least two of the sensors may be of different type. The 3D printing system includes at least one enclosure. In some embodiments, the 3D printing system (e.g., its enclosure) comprises one or more sensors (alternatively referred to herein as one or more sensors). The enclosure described herein may comprise at least one sensor. The enclosure may comprise, or be operatively coupled with, the build module, the filtering mechanism, gas recycling system, the processing chamber, or the ancillary chamber. The sensor may be connected and/or controlled by the control system (e.g., computer control system, or controller(s)). The control system may be able to receive signals from the at least one sensor. The control system, e.g., through a control scheme, may act upon at least one signal received from the at least one sensor. The control scheme may comprise a feedback and/or feed forward control scheme, e.g., that has been pre-programmed. The feedback and/or feed forward control may rely on input from at least one sensor that is connected to the controller(s).

In some embodiments, the 3D printing system comprises one or more sensors. The one or more sensors can comprise a pressure sensor, a temperature sensor, a gas flow sensor, or an optical density sensor. The pressure sensor may measure the pressure of the chamber (e.g., pressure of the chamber atmosphere). The pressure sensor can be coupled with the control system. The pressure can be electronically and/or manually controlled. The controller may regulate the pressure (e.g., with the aid of one or more vacuum pumps) according to input from at least one pressure sensor. The sensor may comprise light sensor, image sensor, acoustic sensor, vibration sensor, chemical sensor, electrical sensor, magnetic sensor, fluidity sensor, movement sensor, speed sensor, position sensor, pressure sensor, force sensor, density sensor, metrology sensor, sonic sensor (e.g., ultrasonic sensor), or proximity sensor. The metrology sensor may comprise measurement sensor (e.g., height, length, width, depth, angle, and/or volume). The metrology sensor may comprise a magnetic, acceleration, orientation, or optical sensor. The sensor may comprise a material level sensor such as a powder level sensor. The sensor (e.g., material level sensor) may comprise a guided wave radar. The optical sensor may comprise a camera. The metrology sensor may measure the gap. The metrology sensor may measure at least a portion of the layer of material (e.g., pre-transformed, transformed, and/or hardened). The layer of material may be a pre-transformed material (e.g., powder), transformed material, or hardened material. The metrology sensor may measure at least a portion of the 3D object. The sensor may comprise a temperature sensor, weight sensor, powder level sensor, gas sensor, or humidity sensor. The gas sensor may sense any gas enumerated herein. The temperature sensor may measure the temperature without contacting the material bed (e.g., non-contact measurements). The weight of the enclosure (e.g., container), or any components within the enclosure can be monitored by at least one weight sensor in or adjacent to the material. One or more position sensors (e.g., height sensors) can measure the height of the material bed relative to the substrate. The position sensors can be optical sensors. The position sensors can determine a distance between one or more energy sources and a surface of the material bed. The exposed surface of the material bed can be the upper surface of the material bed relative to a gravitational center of the environment. Examples of 3D printing systems, apparatuses, devices, material beds, and components (e.g., sensors), controllers, software, and 3D printing processes can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the 3D printer comprises one or more valves. The methods, systems and/or the apparatus described herein may comprise at least one valve. The valve may be shut or opened based at least in part on an input from the at least one sensor (e.g., automatically), or manually. The degree of valve opening or shutting may be regulated by the control system, for example, according to at least one input from at least one sensor. The systems and/or the apparatus described herein can include one or more valves, such as throttle valves or butterfly valves. The valve may or may not comprise a sensor sensing the open/shut position of the valve. The valve may be a component of a gas conveyance system, e.g., operable to control a flow of gas of the gas conveyance system. A valve may be a component of the gas conveyance system, e.g., operable to control a flow of gas in the gas conveyance system. The valve(s) may comprise a proportional valve, or a discrete valve. The valve(s) may comprise a variable valve, e.g., a butterfly valve.

In some embodiments, the 3D printer comprises one or more actuators such as motors. The motor may be controlled by the controller(s) (e.g., by the control system) and/or manually. The motor may alter (e.g., the position of) the substrate and/or the base. The motor may alter (e.g., the position of) the build platform assembly. The actuator may facilitate translation (e.g., propagation) of the layer dispenser, e.g., the actuator may facilitate reversible translation of the layer dispenser. The motor may alter an opening of the enclosure (e.g., its opening or closure). The motor may be a step motor or a servomotor. The actuator (e.g., motor) may alter (e.g., a position of) one or more optical components, e.g., mirrors, lenses, prisms, and the like. The servomotors may comprise actuated linear lead screw drive motors. The motors may comprise belt drive motors. The motors may comprise rotary encoders. The encoder may comprise an absolute encoder. The encoder may comprise an incremental encoder. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators.

In some embodiments, the 3D printer (e.g., its components) comprises one or more nozzles. The systems and/or the apparatus described herein may comprise at least one nozzle. For example, the material remover may comprise a nozzle. The nozzle may be regulated according to at least one input from at least one sensor. The nozzle may be controlled automatically or manually. The controller(s) may control the nozzle. The controller(s) may any controller(s) disclosed herein, e.g., as part of the control system of the 3D printer. The nozzle may include jet (e.g., gas jet) nozzle, high velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle. The material dispenser can comprise a nozzle, e.g., through which material is removed from the material bed. The gas flow system may comprise a nozzle, e.g., that facilitates adjustment to the gas flow. The optical window may be supported by a nozzle that directs debris away from the optical window, e.g., at towards the material bed. The nozzle may comprise a venturi nozzle.

In some embodiments, the 3D printer comprises one or more pumps. The systems and/or the apparatus described herein may comprise at least one pump. The pump may be regulated according to at least one input from at least one sensor. The pump may be controlled automatically or manually. The controller may control the pump. The one or more pumps may comprise a positive displacement pump. The positive displacement pump may comprise rotary-type positive displacement pump, reciprocating-type positive displacement pump, or linear-type positive displacement pump.

In some embodiments, the 3D printer comprises at least one filter. The filter may comprise a ventilation filter. The ventilation filter may capture debris and/or other gas-borne material (e.g., fine powder) from the 3D printing system. The filter may comprise a paper filter such as a high-efficiency particulate air (HEPA) filter (a.k.a., high-efficiency particulate arresting filter). The ventilation filter may capture debris comprising soot, splatter, spatter, gas borne pre-transformed material, or gas borne transformed material. The debris may result from the 3D printing process. The filter and/or gas flow may direct the debris in a requested direction (e.g., by using positive and/or negative gas pressure). For example, the filter and/or gas flow may use vacuum, overpressure, and/or gas pulsing. For example, the ventilator may use gas flow.

At times, it may be advantageous to allow for easy installation and/or component maneuvering of the 3D printing system. For example, it may be advantageous if one or more components of the 3D printing system are easily maneuvered, e.g., insertable and/or removed. Easy maneuvering (e.g., removal and/or insertion) may include actions of a user facing the 3D printing system, and maneuvering (e.g., pulling and/or pushing) the one or more components to facilitate their maneuver, e.g., removal and/or insertion, respectively. For example, easy maneuvering (e.g., removal and/or insertion) may include actions of a personnel facing a front, a back, a side, a top, or a bottom of the 3D system, and maneuvering (e.g., pulling and/or pushing) the one or more components to facilitate their maneuver (e.g., removal and/or insertion, respectively). The one or more components may comprise: an optical system (e.g., including an array of optical assemblies, a laser generator), a detection system, an optical system enclosure, a side cover, or a door. The front of the 3D printing system can include a door to the processing chamber. The top of the 3D printing system can face the platform, e.g., through the optical window(s). The one or more components can be reversibly secured to and released from the rest of the 3D printing system using a (e.g., flexible) fastener. The flexible fastener may facilitate reversible maneuvering of a component (e.g., retraction and insertion of the component into a designated location in the 3D printing system. The fastener may comprise any material disclosed herein, e.g., an elemental metal, a metal alloy, or a polymer. The fastener may comprise a lock assembly. The fastener may comprise a snap (e.g., snap fit) assembly, or a latch assembly. The fastener may comprise interlocking portions that engage and/or disengage using human exerted force. The fastener may comprise a cantilever, torsional or annular. The fastener may be devoid of loose parts. The fastener may or may not comprise a spring. In some embodiments, a component may be configured to (e.g., reversibly) snap into and/or out of a cavity in the 3D printing system, e.g., without any fastener, and rather due to the geometric configuration of the cavity edge and component edge that fit together. The fastener may comprise a screw, a peg, or a pin. The component (e.g., energy source) may be disposed on a rack (e.g., an electronic rack). The component may be engaged with a sliding mechanism (e.g., similar to a drawer). For example, the component may comprise at least one wheel (e.g., wheels) configured to couple to at least one rail (e.g., two rails) disposed in 3D printing system cavity. For example, the component may comprise at least one rail (e.g., two rails) configured to couple to the 3D printing system cavity (e.g., wheel(s) configured to engage with the at least one rail. The component and/or 3D printing system cavity may comprise bracket(s) as part of the engagement mechanism between the 3D printing system cavity and the component. The engagement mechanism may comprise a rail, a wheel, or a bracket. The engagement mechanism may facilitate linear and/or tilting sliding of the component with respect to the 3D printing system. Any parts of the components may remain stable (e.g., configured to remain stable) during the maneuvering. For example, one or more parts (e.g., all parts) of the optical system may be stable during extraction of the optical system and/or one or more components of the optical system (e.g., an optical assembly of the array of optical assemblies) from the 3D printing system and/or insertion of the optical system into the 3D printing system. Such (e.g., reversible) maneuvering methodology may allow easy assembly, and/or maintenance of the 3D printing system (e.g., of the component thereof).

At times, maneuvering the optical system with respect to the 3D printing system causes no, or minimum (e.g., non-material), alternation of the optical system(s) disposed in the optical system enclosure. For example, one or more parts (e.g., all parts) of the optical system, optical assembly/ies, or of the optical system enclosure may be stable during extraction of the optical system, optical assembly/ies, (or optical system enclosure comprising the optical system) from the 3D printing system and/or insertion of the optical system or optical assembly/ies into the 3D printing system. Such (e.g., reversible) maneuvering methodology may allow easy assembly, and/or maintenance of the 3D printing system (e.g., of the component thereof).

At times, the energy beam follows a path. The path of the energy beam may be a vector. The path of the energy beam may comprise a raster, a vector, or any combination thereof. The path of the energy beam may comprise an oscillating pattern. The path of the energy beam may comprise a zigzag, wave (e.g., curved, triangular, or square), or curve pattern. The curved wave may comprise a sine or cosine wave. The path of the energy beam may comprise a sub-pattern. The path of the energy beam may comprise an oscillating (e.g., zigzag), wave (e.g., curved, triangular, or square), and/or curved sub-pattern. The curved wave may comprise a sine or cosine wave.

The path of the energy beam may comprise a sub-pattern. The sub-pattern of the energy beam may comprise a wave (e.g., sine or cosine wave) pattern. The sub-pattern may be a small path that forms the large path. The sub-pattern may be a component (e.g., a portion) of the large path. The path that the energy beam follows may be a predetermined path. A model may predetermine the path by utilizing a controller or an individual (e.g., human). The controller may comprise a processor. The processor may comprise a computer, computer program, drawing or drawing data, statue or statue data, or any combination thereof. The hatch lines or paths may be straight or curved. The hatch lines or paths may be winding. At times, the path comprises successive lines. The successive lines may touch each other. The successive lines may overlap each other in at least one point. The successive lines may substantially overlap each other. The successive lines may be spaced by a first distance (e.g., hatch spacing). Examples of 3D printing systems, apparatuses, devices, and any component thereof; controllers, software, and 3D printing processes (e.g., hatch spacings) can be found in International Patent Application Serial No PCT/US16/34857 filed on May 27, 2016, titled “THREE-DIMENSIONAL PRINTING AND THREE-DIMENSIONAL OBJECTS FORMED USING THE SAME” that is entirely incorporated herein by reference.

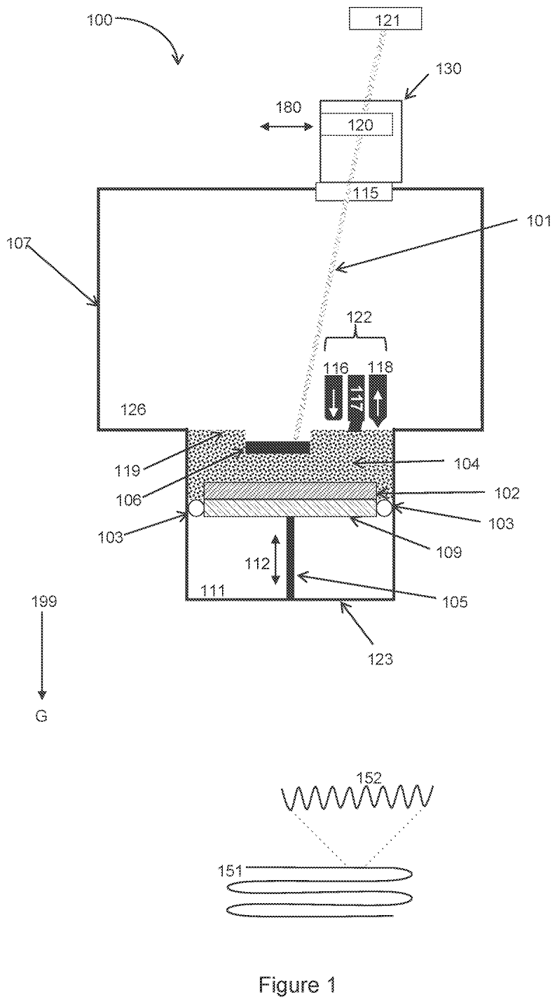

FIG. 1 shows an example of a 3D printing system 100 having a processing chamber 107 coupled with a build module 123. The build module comprises an elevation mechanism 105 (e.g., as part of a build platform assembly) that vertically translate a substrate 109 (e.g., piston) along arrow 112. A build platform 102 is disposed on substrate 109 (e.g., piston). Material bed 104 is disposed above build platform 102 (e.g., also referred herein as “base”, or “build plate”). The 3D printing system 100 comprises an optical system 120 (e.g., a guidance system) for energy beam 101 (e.g., a galvanometer scanner). The optical system 120 is disposed in optical system enclosure 130 coupled with optical window 115. Optical system 120 can optionally be translatable along axis 180, e.g., translatable along an axis perpendicular to gravitational vector 199. Energy source (e.g., laser source) 121 generates energy beam 101 that traverses through the optical system 120 (e.g., comprising a guidance system such as a scanner) and through an optical window 115 into processing chamber 107 enclosing interior space 126 that can include an atmosphere. The optical window 115 is configured to allow the energy beam to pass through with minimal energetic loss, e.g., without (e.g., substantial) energetic loss. Processing chamber 107 can include an optional temperature adjustment device (e.g., cooling plate), not shown. Seal 103 encircles the substrate and/or base, e.g., to deter (e.g., prevent) migration of material of the material bed from reaching elevation mechanism 105. Energy beam 101 impinges upon an exposed surface 119 of material bed 104, to form at least a portion of a 3D object 106. FIG. 1 shows an example of a build module 123. Build module 123 contains the pre-transformed (e.g., starting) material in a material bed 104. As depicted in FIG. 1, the 3D printer comprises a layer dispensing mechanism 122. The layer dispensing mechanism 122 includes a material dispenser 116 and a powder removal mechanism 118 to form a layer of pre-transformed material (e.g., starting material) within the enclosure. Layer dispensing mechanism 122 includes an optional leveler 117. The material may be layered (e.g., spread) in the enclosure such as by using the layer dispensing mechanism 122. Build module 123 is configured to enclose a substrate 109 (e.g., piston) and arranged adjacent to a floor 111 at the bottom of build module 123. Floor 111 is defined relative to the gravitational field along gravitational vector 199 pointing towards gravitational center G, and/or relative to the position of the footprint of the energy beam 101 on the layer of pre-transformed material as part of a material bed 104. Build module 123 comprises build platform 102. The substrate is coupled with one or more seals 103 that enclose the material in a selected area within the build module to form material bed 104. One or more components of 3D printing system 100 are controlled by a control system (not shown in FIG. 1). The energy beam 101 can travel along a path such as path 151. FIG. 1 shows an example of a path of an energy beam path 151 comprising a zigzag sub-pattern. Sub-pattern 152 is an expansion (e.g., blow-up) of a portion of path 151.

In some embodiments, the formation of the 3D object includes transforming (e.g., fusing, binding and/or connecting) the pre-transformed material (e.g., 3D printing starting material such as a powder material) using an energy beam. The energy beam may be projected on to the starting material (e.g., disposed in the material bed), thus causing the pre-transformed material to transform (e.g., fuse). The pre-transformed or transformed material can absorb the energy from the energy source (e.g., energy beam, diffused energy, and/or dispersed energy), and as a result, a localized region of that pre-transformed or transformed material can increase in temperature (e.g., and at least partially transform). The energy beam may cause at least a portion of the pre-transformed material to transform from its present state of matter to a different state of matter. For example, the pre-transformed material may transform at least in part (e.g., completely) from a solid to a liquid state. The energy beam may cause at least a portion of the pre-transformed material to chemically transform. For example, the energy beam may cause chemical bonds to form or break. The chemical transformation may be an isomeric transformation. The transformation may comprise a magnetic transformation or an electronic transformation. The transformation may comprise coagulation of the material, cohesion of the material, or accumulation of the material. Transformation of the material may comprise connecting disconnected starting materials. For example, connecting various powder particles. The connection may comprise phase transfer, or chemical bonding. The connection may comprise fusing the starting material, e.g., sintering or melting the starting material.

In some embodiments, the methods described herein comprise repeating the operations of material deposition and material transformation operations to produce (e.g., print) a 3D object (or a portion thereof) by at least one 3D printing (e.g., additive manufacturing) method. For example, the methods described herein may comprise repeating the operations of depositing a layer of pre-transformed material and transforming at least a portion of the pre-transformed material to connect to the previously formed 3D object portion (e.g., repeating the 3D printing cycle), thus forming at least a portion of a 3D object. The transforming operation may comprise utilizing energy beam(s) to transform the material. In some instances, the energy beam is utilized to transform at least a portion of the material bed.

In some embodiments, the term “auxiliary support,” as used herein, generally refers to at least one feature that is a part of a printed 3D object, but not part of the requested, intended, designed, ordered, and/or final 3D object. Auxiliary support may provide structural support during and/or after the formation of the 3D object. The auxiliary support may be anchored to the enclosure. For example, an auxiliary support may be anchored to the build platform (e.g., build platform such as a build plate), to the side walls of the material bed, to a wall of the enclosure, to an object (e.g., stationary or semi-stationary) within the enclosure, or any combination thereof. The auxiliary support may be the build platform or the bottom of the enclosure. The auxiliary support may enable the removal of energy from the 3D object (e.g., or a portion thereof) that is being formed. The removal of energy (e.g., heat) may be during and/or after the formation of the 3D object. Examples of auxiliary support comprise a fin (e.g., heat fin), anchor, handle, pillar, column, frame, footing, wall, build platform, or another stabilization feature. In some instances, the auxiliary support may be mounted, clamped, or situated on the build platform. The auxiliary support can be anchored to the build platform, to the sides (e.g., walls) of the build platform, to the enclosure, to an object (stationary or semi-stationary) within the enclosure, or any combination thereof. Sometimes, the generated 3D object may comprise one or more auxiliary supports. The auxiliary support may be suspended in the pre-transformed material (e.g., powder material). The auxiliary support may provide weight or stabilizer. The auxiliary support can be suspended in the material bed such as within the layer of pre-transformed material in which the 3D object (or a portion thereof) has been formed. The auxiliary support may touch the build platform. The auxiliary support may be suspended in the material bed and not touch (e.g., contact) the build platform. The auxiliary support may be anchored to the build platform.

In some examples, the generated 3D object(s) can be printed without auxiliary support in a material bed in which it/they are formed. In some examples, low overhanging feature and/or hollow cavities of the generated 3D object can be printed without (e.g., without any) auxiliary support. The low overhanging features may be shallow overhanging features with respect to an exposed surface of the material bed. The low overhanging features may form an angle of at most about 40 degrees (°), 35°, or 25° with the exposed surface of the material bed (or a plane parallel thereto). The printed 3D object can be devoid of auxiliary supports. The printed 3D object may be suspended (e.g., float anchorlessly) in the material bed (e.g., powder bed). The term “anchorlessly,” as used herein, generally refers to without, or in the absence of, an auxiliary anchor. In some examples, an object is suspended in a material bed anchorlessly without attachment to a support. For example, the object floats in the material bed. A portion of the printed 3D object can be devoid of auxiliary supports. The portion of the 3D object may be suspended over a volume of the material bed. For example, a portion of the object defines an enclosed cavity which may be temporarily filled with powder material during a build process. The generated 3D object may be suspended in the layer of pre-transformed material (e.g., powder material). The pre-transformed material can offer support to the printed 3D object (or the object during its generation).

In some examples, the at least 3D object may be generated above a build platform, which at least one 3D object comprises auxiliary supports. In some examples, the auxiliary support(s) adhere (e.g., connect) to the build platform, e.g., the upper surface of the build platform). In some examples, the auxiliary supports of the printed 3D object may touch the build platform (e.g., the bottom of the enclosure, the substrate, or the base. In some embodiments, the auxiliary supports are an integral part of the build platform. At times, auxiliary support(s) of the printed 3D object, do not touch the build platform. In any of the methods described herein, the printed 3D object may be supported only by the pre-transformed material within the material bed. Any auxiliary support(s) of the printed 3D object, if present, may be suspended adjacent to the build platform. Occasionally, the build platform may have a pre-hardened (e.g., pre-solidified) amount of material. Such pre-solidified material may provide support to the printed 3D object. At times, the build platform may provide adherence to the material. At times, the build platform does not provide adherence to the material. The build platform may comprise elemental metal, metal alloy, elemental carbon, or ceramic. The build platform may comprise a composite material (e.g., as disclosed herein). The build platform may comprise glass, stone, zeolite, or a polymeric material. The polymeric material may include a hydrocarbon or fluorocarbon. The build platform (e.g., base) may include Teflon. The build platform may include compartments for printing small objects. Small may be relative to the size of the enclosure. The compartments may form a smaller compartment within the enclosure, which may accommodate a layer of pre-transformed material.

In some examples, when the energy source is in operation, the material bed reaches a certain (e.g., average) temperature. The average temperature of the material bed can be an ambient temperature or “room temperature.” The average temperature of the material bed can have an average temperature during the operation of the energy (e.g., beam(s)). The average temperature of the material bed can be an average temperature during the formation of the transformed material, the formation of the hardened material, or the generation of the 3D object. The average temperature can be below or just below the transforming temperature of the material. Just below can refer to a temperature that is by at most about 1° C., 2° C., 3° C., 4° C., 5° C., 6° C., 7° C., 8° C., 9° C., 10 C, 15° C., or 20° C. below the transforming temperature. The average temperature of the material bed (e.g., pre-transformed material) can be by at most about 25° C. (degrees Celsius), 50° C., 100° C., 150° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., pre-transformed material) can be at least about 20° C., 25° C., 50° C., 100° C., 150° C., 200° C., 250° C., 300° C., 400° C., 500° C., 600° C., 700° C., 800° C., 900° C., 1000° C., 1200° C., 1400° C., 1600° C., or 1800° C. The average temperature of the material bed (e.g., of the pre-transformed material therein) can be any temperature between the afore-mentioned material average temperatures. The temperature of the material bed can be conditioned (e.g., heated or cooled) before, during, or after forming (e.g., printing) the 3D object (e.g., hardened material). The material bed temperature can be controlled (e.g., substantially maintained) at a predetermined value. The temperature of the material bed can be monitored. The material temperature can be controlled manually and/or by a control system (e.g., such as any control system disclosed herein).

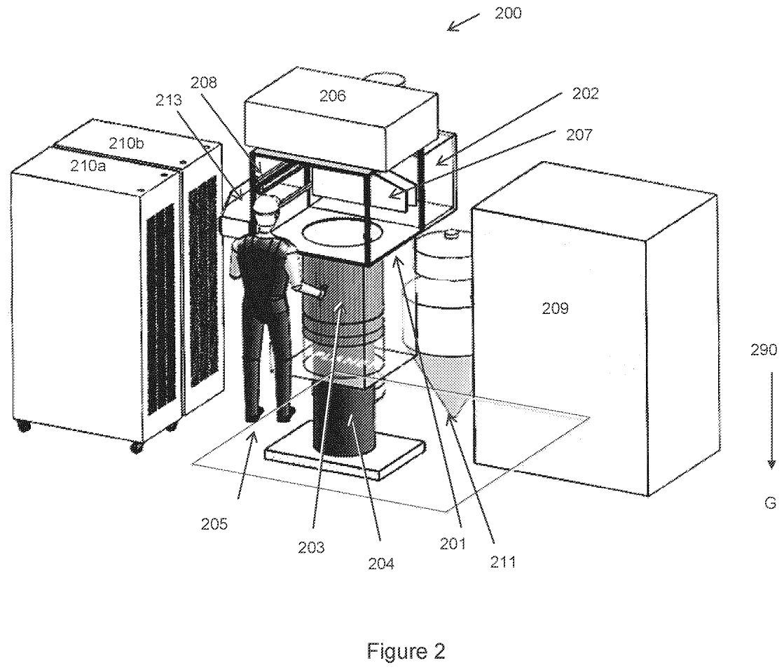

FIG. 2 shows an example of a 3D printing system 200 disposed in relation to gravitational vector 290 directed towards gravitational center G. The 3D printing system comprises processing chamber 201 coupled with an ancillary chamber (e.g., garage) 202 configured to accommodate a layer dispensing mechanism (e.g., recoater), e.g., in its resting (e.g., idle) position. The processing chamber is coupled with a build module 203 that extends 204 under a plane (e.g., floor) at which user 205 stands on (e.g., can extend under-grounds). The processing chamber may comprise a door (not shown) facing user 205. 3D printing system 200 comprises optical system enclosure 206 that can comprise an energy beam alignment system, e.g., comprising at least one optical array comprising at least one guidance system (e.g., scanner). A layer dispensing mechanism (not shown) may be coupled with framing 207 as part of a moving system that facilitates movement of the layer dispensing mechanism along the material bed and garage, e.g., in a reversible back-and-forth movement. The moving system comprises a translation inducer system, e.g., comprising a belt or a chain 208. 3D printing system 200 comprises a filter unit 209, heat exchangers 210a and 210b, pre-transformed material (e.g., powder) reservoir 211, and gas conveyance system (e.g., comprising gas inlets and gas inlet portions) disposed in enclosure 213. The filtering system may filter gas and/or pre-transformed material. The filtering system may be configured to filter debris, e.g., comprising byproduct(s) of the 3D printing.

In some embodiments, 3D printing system comprises a pre-transformed material (e.g., starting material such as powder) conveyor system (e.g., also referred to as “conveyance system” or “powder conveyance system”). The pre-transformed material conveyor system may be coupled with a processing chamber having a layer dispensing mechanism (e.g., recoater). Pre-transformed material (e.g., powder) from a reservoir (e.g., hopper) can be introduced into the layer dispensing mechanism disposed in the processing chamber. Once the layer dispensing mechanism dispenses a layer of pre-transformed material to layer wise form a material bed utilized for the three-dimensional printing, excess pre-transformed material may be attracted away from the material bed. In this process, excess pre-transformed material may be attracted away from the material bed using layer dispensing mechanism and introduced into separator (e.g., cyclone), and optionally to an overflow separator (e.g., cyclone). The pre-transformed material may undergo separation (e.g., cyclonic separation) in separator(s), and may be introduced into sieve(s), followed by gravitational flow into a lower reservoir (e.g., hopper). The separated and sieved pre-transformed material can be then delivered into separator(s), and into a reservoir that can deliver the pre-transformed material back into the layer dispensing mechanism. The separator may be coupled with sieve(s) instead of to the reservoir. The pre-transformed material conveyor system may comprise pumps (e.g., displacement pump and/or compressor pumps), and a temperature regulator (e.g., heater or radiator such as a radiant plane). The pre-transformed material conveyor system may comprise a venturi nozzle, for example, to facilitate suction of the pre-transformed material from the reservoir into separator(s). The pre-transformed material conveyance system can include a condensed gas source (e.g., a blower or a cylinder of condensed gas). The pre-transformed material conveyance system may include a heat exchanger. The pre-transformed material conveyance system may include one or more filters. The pre-transformed material conveyance system may operate at a positive pressure above ambient pressure external to the pre-transformed material conveyance system (e.g., above about one atmosphere). The gas conveyance system may be configured to circulate (e.g., recirculate) gas also in the processing chamber. The gas conveyance system may sweep debris (e.g., soot) away from the process area in which the 3D object is being printed. At times, a pressure differential is required to convey pre-transformed material from one compartment of the 3D printer to another. The pressure differential may be established via pressurizing or vacuuming one or more compartments. For example, pre-transformed material from the layer dispensing system to the recycling system (e.g., including the separator(s), sieve(s), and/or reservoirs) may be conveyed using (a) induced pressure differential among components, (b) pressure isolation of the components, and (c) induced pressure equilibration of components.

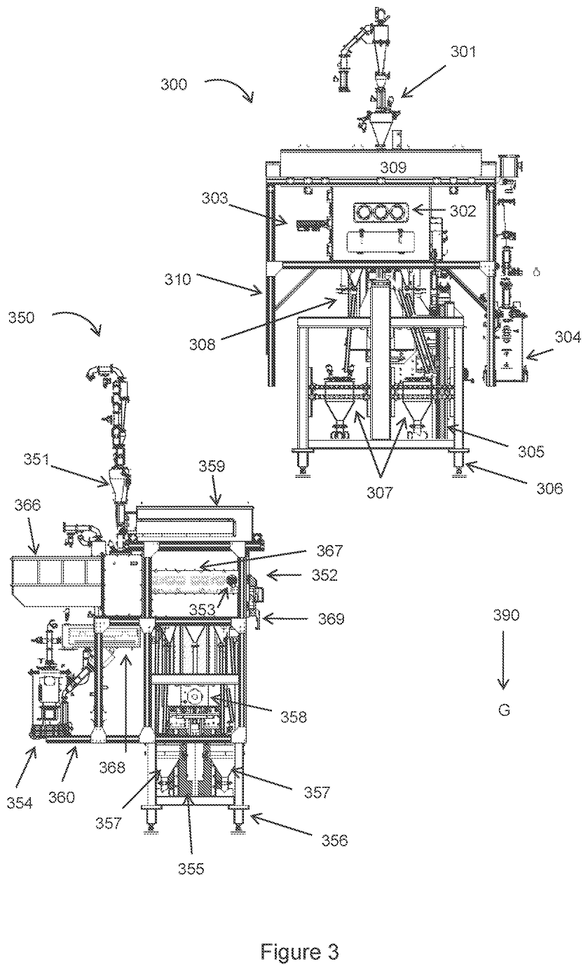

FIG. 3 shows in example 300 a front side example of a portion of a 3D printing system comprising a material reservoir 301 configured to feed pre-transformed material to a layer dispensing mechanism, and an optical system enclosure 309 configured to enclose, e.g., one or more optical system including scanner(s) and/or director(s) of at least one energy beam (e.g., laser beam) configured to transform the pre-transformed material into a transformed material to print one or more 3D object in a printing cycle. Example 300 of FIG. 3 shows processing chamber 302 having a primary door with three circular viewing windows and a secondary door, e.g., having a glove box type arrangement. Example 300 shows a material reservoir 304 configured to accumulate a remainder pre-transformed material. The remainder may be from the layer dispensing mechanism, post 305 as part of a build platform assembly of build module 308, two material reservoirs 307 for accumulating a remainder of the material bed that did not form the 3D object, and actuator 303 configured to translate the layer dispensing mechanism to dispense a layer of pre-transformed material as part of a material bed. Supports 306 are planarly stationed in a first horizontal plane, which supports 306 and associated framing support one section of the 3D printing system portion 300 and framing 310 is disposed on a second horizontal plane higher than the first horizontal plane. FIG. 3 shows in 350 an example side view example of a portion of the 3D printing system shown in example 300, which side view comprises a material reservoir 351 configured to feed pre-transformed material to a layer dispensing mechanism (not shown), an enclosure 359 enclosing an optical system (e.g., including scanners and/or directors of at least one energy beam (e.g., laser beam) configured to transform the pre-transformed material into a transformed material to print one or more 3D object in a printing cycle. Example 350 of FIG. 3 shows an example of a processing chamber 352 having a door comprising handle 369 (as part of a handle assembly). 3D printing system portion 350 shows a material reservoir 354 configured to accumulate recycled remainder from the layer dispensing process to form a material bed and/or a remainder of the material bed that did not form one or more 3D objects during a printing cycle, and a portion of the material conveyance system 368 configured to convey the material to reservoir 354. The remainder material conveyed to reservoir 354 may be separated (e.g., sieved) before reaching reservoir 354. The example shown in 350 shows post 355 as part of a build platform assembly of build module 358, two material reservoirs 357 for accumulating a remainder of the material bed that did not form the 3D object, and actuator 353 configured to translate the layer dispensing mechanism to dispense a layer of pre-transformed material as part of a material bed, e.g., along railing 367 in processing chamber and into garage 366 in a reversible (e.g., back and forth) movement. Supports 356 are planarly stationed in a first horizontal plane, which supports 356 and associated framing support one section of the 3D printing system portion 350 and framing 360 is disposed on a second horizontal plane higher than the first horizontal plane. In the example shown in FIG. 3, the 3D printing system components are aligned with respect to gravitational vector 390 pointing towards gravitational center G.

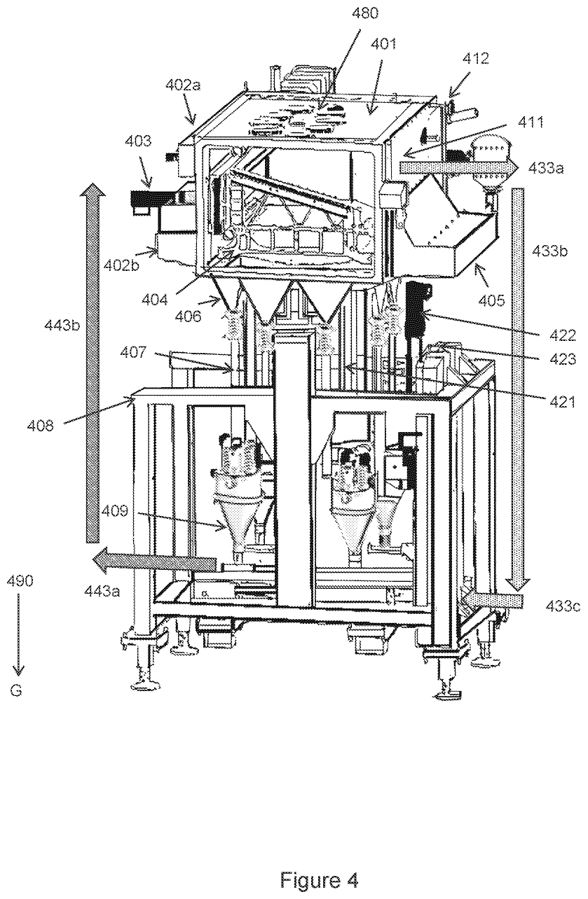

FIG. 4 shows a perspective view example of a portion of a 3D printing system including a processing chamber having a roof 401 in which eight optical windows 480 are disposed to each facilitate penetration of each of eight energy beams respectively into the interior space of processing chamber having side wall 411 comprising a gas exit port covering 405 coupled thereto. The processing chamber has two gas entrance port coverings 402a and 402b coupled with a wall opposing side wall 411. The opposing wall to wall 411 is coupled with actuator 403 configured to facilitate translation of a layer dispensing mechanism mounted on framing 404 above a base disposed adjacent to a floor of the processing chamber (e.g., the base can be flush with the floor), which framing is configured to translate reversibly back and forth in the processing chamber along railings. The processing chamber floor has slots through which remainder material can flow downwards towards gravitational center G along gravitational vector 490. The slots are coupled with funnels such as 406, which are connected by channels (e.g., pipes) such as 407 to material reservoir such as 409. The processing chamber is coupled with a build module 421 that comprises a substrate to which the base is attached, which substrate is configured to vertically translate with the aid of actuator 422 coupled with an elevator motion stage (e.g., supporting plate) 423 via a bent arm. The elevator motion stage 423 and its coupled components are supported by framing 408. An atmosphere (e.g., content and/or pressure) may be equilibrated between the material reservoirs 409 and the processing chamber via schematic channel (e.g., pipe) portions 433a-c. Remainder material in the material reservoirs may be conveyed via schematic channels (e.g., pipes) 443a-b to a material recycling system, e.g., at least in part for future use in printing and/or debris removal. The components of the 3D printing system are disposed relative to gravitational vector 490 pointing to gravitational center G.

At times, the methods described herein are performed in an enclosure (e.g., container, processing chamber, and/or build module). One or more 3D objects can be formed (e.g., generated, and/or printed) in the enclosure (e.g., simultaneously, and/or sequentially). The enclosure may have a predetermined and/or controlled (e.g., maintained) pressure. The enclosure may have a predetermined and/or controlled atmosphere, e.g., during the 3D printing. The control may be manual or via a control system. The atmosphere may comprise at least one gas.

In some embodiments, the enclosure comprises an atmosphere having an ambient pressure (e.g., 1 atmosphere), or positive pressure above ambient pressure in an ambient environment external to the enclosure. The atmosphere may have a negative pressure (i.e., vacuum). Different (e.g., compartmentalized) portions of the enclosure may have different atmospheres. The different atmospheres may comprise different gas compositions. The different atmospheres may comprise different atmosphere temperatures. The different atmospheres may comprise ambient pressure (e.g., 1 atmosphere), negative pressure (i.e., vacuum) or positive pressure. The different portions of the enclosure may comprise the processing chamber, build module, or enclosure volume excluding the processing chamber and/or build module. The vacuum may comprise pressure below 1 bar, below 1 atmosphere, or below ambient pressure in the ambient environment. The positively pressurized environment may comprise pressure above 1 bar, above 1 atmosphere, or above the ambient pressure. In some cases, the chamber pressure can be (e.g., substantially) standard atmospheric pressure. The pressure may be measured at an ambient temperature, e.g., room temperature such as 20° C., or 25° C.

In some embodiments, the enclosure comprises an atmosphere. The atmosphere within the enclosure may comprise a positive pressure above ambient pressure in an ambient environment external to the enclosure. The atmosphere within the enclosure may be different than an atmosphere outside the enclosure. At times, a differential atmosphere (e.g., a difference in atmospheres between the inside of the enclosure and the outside of the enclosure) depends in part on a processing condition of the three-dimensional printing. Processing conditions can include, for example, (i) a composition of the pre-transformed material, (ii) an internal temperature of the material bed during the three-dimensional processing, (iii) a number of energy beams (e.g., an average number of energy beams) transforming (e.g., incident on) the target surface during the three-dimensional processing, (iv) an amount of contamination by debris during the three-dimensional processing, (v) temperature in the material bed during 3D printing, (vi) temperature in the processing chamber during the printing, (vii) amount of energy supplied by the energy beams to the material bed, or (vii) any combination thereof. For example, a differential atmosphere between the interior of the enclosure (e.g., within the processing chamber) and an ambient environment external to the enclosure may depend at least in part on an average number of energy beams utilized during the three-dimensional process.

In some embodiments, the enclosure includes an atmosphere that is greater than (e.g., at a positive pressure with respect to) an ambient atmosphere external to the enclosure. The atmosphere within the enclosure may comprise a positive pressure of at least about 20 Kilo Pascal (Kpa), 18 Kpa, 16 Kpa, 14 Kpa, 12 Kpa, 10 Kpa, or 5 Kpa above ambient atmospheric pressure, e.g., above 101 Kpa. The pressure in the enclosure can be at a range between any of the afore-mentioned pressure values above atmospheric pressure, e.g., from about 5 Kpa to about 20 Kpa, the values representing a pressure difference above atmospheric pressure, e.g., above 101 Kpa. The pressure can be measured by a pressure gauge. The pressure can be measured at ambient temperature (e.g., room temperature (R.T.)). In some cases, the chamber pressure can be standard atmospheric pressure. The pressure may be measured at an ambient temperature (e.g., room temperature such as about 20° C., or about 25° C.). The composition of the atmosphere within the enclosure may comprise any one or more of the gases described herein, for example, clean dry air (CDA), argon, and/or nitrogen. The gas may comprise a reactive agent (e.g., comprising oxygen or humidity). The atmosphere may comprise a v/v percent of the reactive agent (gas) of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of the reactive agent (gas) between the aforementioned percentages of hydrogen gas. The enclosure may comprise a gas flow, e.g., before, after, and/or during three-dimensional printing. The gas flow within the enclosure may comprise at least about 150 liters per minute (LPM), 200 LPM, 250 LPM, 300 LPM, 350 LPM, 400 LPM, 450 LPM, 500 LPM, 550 LPM, 600 LPM, 650 LPM, 700 LPM, 750 LPM, 800 LPM, 900 LPM, 1000 LPM, or 1200 LPM. The gas flow within the enclosure may comprise any value between the aforementioned values, for example, from about 150 LPM to about 500 LPM, from about 450 LPM to about 750 LPM, or from about 700 LPM to about 1200 LPM.

In some embodiments, the enclosure includes an atmosphere. The enclosure may comprise a (e.g., substantially) inert atmosphere. The atmosphere in the enclosure may be (e.g., substantially) depleted by one or more gases present in the ambient atmosphere. The atmosphere in the enclosure may include a reduced level of one or more gases relative to the ambient atmosphere. For example, the atmosphere may be substantially depleted, or have reduced levels of water (i.e., humidity), oxygen, nitrogen, carbon dioxide, hydrogen sulfide, or any combination thereof. The level of the depleted or reduced level gas may be at most about 0.1 parts per million (ppm), 1 ppm, 3 ppm, 10 ppm, 50 ppm, 100 ppm, 500 ppm, 1000 ppm, 3000 ppm, or 5000 ppm volume by volume (v/v). The level of the depleted or reduced level gas may be at least about 1 ppm, 10 ppm, 50 ppm, 100 ppm, 500 ppm, 1000 ppm, or 5000 ppm (v/v). The level of the oxygen gas may be at most about 1 ppm, 10 ppm, 50 ppm, 100 ppm, 500 ppm, 1000 ppm, or 2000 ppm (v/v). The level of the water vapor may be at most about 1 ppm, 10 ppm, 50 ppm, 100 ppm, 500 ppm, 700 ppm, 800 ppm, 900 ppm, or 1000 ppm (v/v). The level of the gas (e.g., depleted or reduced level gas, oxygen, or water) may be between any of the afore-mentioned levels of gas. The atmosphere may comprise air. The atmosphere may be inert. The atmosphere in the enclosure (e.g., processing chamber) may have reduced reactivity (e.g., be non-reactive) as compared to the ambient atmosphere external to the processing chamber and/or external to the printing system. The atmosphere may have reduced reactivity with the material (e.g., the pre-transformed material deposited in the layer of material (e.g., powder) or with the material comprising the 3D object), which reduced reactivity is compared to the reactivity of the ambient atmosphere. The atmosphere may hinder (e.g., prevent) oxidation of the generated 3D object, e.g., as compared to the oxidation by an ambient atmosphere external to the 3D printer and/or processing chamber. The atmosphere may hinder (e.g., prevent) oxidation of the pre-transformed material within the layer of pre-transformed material before its transformation, during its transformation, after its transformation, before its hardening, after its hardening, or any combination thereof. The atmosphere may comprise an inert gas. For example, the atmosphere may comprise argon or nitrogen gas. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe amount of hydrogen gas. The atmosphere may comprise a v/v percent of hydrogen gas of at least about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of hydrogen between the afore-mentioned percentages of hydrogen gas. The atmosphere may comprise a v/v hydrogen gas percent that is at least able to react with the material (e.g., at ambient temperature and/or at ambient pressure), and at most adhere to the prevalent work-safety standards in the jurisdiction (e.g., hydrogen codes and standards). The material may be the material within the layer of pre-transformed material (e.g., powder), the transformed material, the hardened material, or the material within the 3D object. Ambient refers to a condition to which people are generally accustomed. For example, ambient pressure may be about one (1) atmosphere.

In some embodiments, material utilized in the 3D printing undergoes passivation, e.g., using a passivation system. A passivation system may comprise (A) an in-situ passivation system (e.g., to passivate filtered debris and/or any other gas borne material before their disposal), (B) an ex-situ passivation system, or (C) a combination thereof. The passivation system may control a level of the oxidizing agent below a threshold. The oxidizing agent in the oxidizing mixture (e.g., oxygen) may be kept below a threshold (e.g., below 2000 ppm), e.g., by using one or more controllers such as the control system disclosed herein.

In some embodiments, the gas in the gas conveyance system and/or enclosure comprises a robust gas. The robust gas may comprise an inert gas enriched with reactive agent(s). At least one reactive agent in the robust gas may be in a concentration below that present in the ambient atmosphere external to the gas conveyance system and/or enclosure. The reactive agent(s) may comprise water or oxygen. The robust gas (e.g., gas mixture) may be more inert than the gas present in the ambient atmosphere. The robust gas may be less reactive than the gas present in the ambient atmosphere. Less reactive may be with debris, and/or pre-transformed material, e.g., during and/or after the printing. In some embodiments, humidity levels and/or oxygen levels in at least a portion of the enclosure (e.g., processing chamber, ancillary chamber, and/or build module) can be regulated such that an oxygenation and/or humidification of powder in the powder conveyance system is controlled. Oxygenation and/or humidification levels of recycled pre-transformed material (e.g., recycled powder material) can be from about 5 parts per million (ppm) to about 1500 ppm. The gas composition of the chamber can contain a level of oxygen that is at most about 4000 parts per million (ppm), 3000 ppm, 2000 ppm, 1500 ppm, 1000 ppm, 500 ppm, 400 ppm, 100 ppm, 50 ppm, 10 ppm, or 5 ppm. The gas composition of the chamber can contain an oxygen level between any of the afore-mentioned values (e.g., from about 4000 ppm to about 5 ppm, from about 2000 ppm to about 500 ppm, from about 1500 ppm to about 500 ppm, or from 500 ppm to about 50 ppm). Oxygenation and/or humidification levels of pre-transformed material can be about zero ppm. For example, oxygen content in pre-transformed material can be at least about xero (0) weight percent (wt %), 0.1 wt %, 0.25 wt %, 0.3 wt %, 0.5 wt %, 0.75 wt %, 1.0 wt %, or more. At times, atmospheric conditions can, in part, influence a flowability of pre-transformed material (e.g., powder material) from the layer dispensing mechanism. A dew point of an internal atmosphere of an enclosure (e.g., of the processing chamber) can be (I) below a level in which the powder particles absorb water such that they become reactive under condition of 3D printing process(es) and/or sufficient to cause measurable defects in a 3D object printed from the powder particles and (II) above a level of humidity below which the powder agglomerates, (e.g., electrostatically). In some embodiments, conditions (I) and/or (II) may depend in part on a type of powder material and/or on processing condition(s) of the 3D printing process(es). The gas composition of the chamber can contain a level of humidity that corresponds to a dew point of at most about −10° C., −15° C., −20° C., −25° C., −30° C., −35° C., −40° C., −50° C., −60° C., or −70° C. The gas composition of the chamber can contain a level of humidity that correspond to a dew point of between any of the aforementioned values, e.g., from about −70° C. to about −10° C. or from about −30° C. to about −20° C. A dew point of an internal atmosphere of the enclosure (e.g., of the processing chamber) can be from about −80° C. to about −30° C., from about −65° C. to about −40° C., or from about −55° C. to about −45° C., at an atmospheric pressure of at least about 10 kilo-Pascals (kPa), about 12 kPa, about 14 kPa, about 16 kPa, about 18 kPa, about 20 kPa above ambient pressure external to the enclosure. A dew point of an internal atmosphere of the enclosure can be any value within or including the afore-mentioned values. Examples of gas conveyance system and components (including control components), in-situ passivation systems, controlled oxidation methods and systems, 3D printing systems, control systems, software, and related processes, can be found in International Patent Application Serial Nos. PCT/US17/60035 and PCT/US21/35350, each of which is incorporated herein by reference in its entirety.

In some embodiments, a 3D printing system includes, or is operatively coupled with, one or more gas recycling systems. The gas recycling system can be at least a portion of the gas conveyance system. The processing chamber may include gas inlet(s) and gas outlet(s). The gas recycling system can be configured to recirculate the flow of gas from gas outlet(s) back into processing chamber via the gas inlet(s). Gas flow through a channel exiting a gas outlet can include solid and/or gaseous contaminants such as debris (e.g., soot). A filtration system can be configured to filter out at least some of the solid and/or gaseous contaminants, thereby providing a clean gas (e.g., cleaner than gas flow through channel exiting the gas outlet). The filtration system can include one or more filters. The filters may comprise physical filters or chemical filters. The clean gas exiting the filtering mechanism (also herein “filtration system”) can be under lower pressure relative to the incoming gas pressure into the filtering mechanism. The lower pressure and the pressure of the incoming gas pressure may be above ambient pressure external to the 3D printing system. The clean gas can be directed through a pump to regulate (e.g., increase) its relative pressure prior to entry to the processing chamber. Clean gas with a regulated pressure that exits the pump can be directed through one or more sensors. The one or more sensors may comprise a flow meter, which can measure the flow (e.g., pressure) of the pressurized clean gas. The one or more sensors may comprise temperature, humidity, oxygen sensors, or any other sensor disclosed herein. In some cases, the clean gas can have an ambient pressure or higher. The higher pressure may provide a positive pressure within the processing chamber (see example values of positive pressure described herein). A first portion of the clean gas can be directed through at least one inlet of a gas inlet portion of the enclosure, while a second portion of the clean gas can be directed to first and/or second window holders that provide gas purging of optical window areas, as described herein. That is, the gas recycling system can provide clean gas to provide a primary gas flow for the 3D printing system, as well as a secondary gas flow (e.g., window purging). In some embodiments, the pressurized clean gas is further filtered through a filter prior to reaching one or both of the window holders. In some embodiments, the one or more filters (e.g., as part of one or more filters and/or a filtration system) are configured to filter out particles having nanometer-scale (e.g., about 10 nm to about 500 nm) diameters. In some embodiments, the gas recycling system may provide clean gas to a recessed portion of the enclosure. In some embodiments, gas flow from the recessed portion of the enclosure can be directed through the gas recycling system. In some embodiments, gas flow from the recessed portion can be directed through one or more filters of a filtration system. In some embodiments, the gas recycling system provides clean gas directed to first and/or second window holders.

In some embodiments, the 3D printing system may comprise one or more pneumatic loops interconnected to the enclosure, e.g., to the processing chamber of the enclosure. The pneumatic loops may comprise e.g., a gas conveyance system and/or a material (e.g., powder) recycling system. The gas conveyance system is operatively coupled with a layer dispensing mechanism. Content of the pneumatic loops can be dynamic and affect (e.g., change) at least one characteristic of the atmosphere of the enclosure. The at least one characteristic of the atmosphere can comprise pressure, flow rate, flow direction, velocity, acceleration, temperature, composition, volume, or humidity. In an example, the direction, velocity, and/or acceleration of the gas flow in the enclosure are changed due to content of the pneumatic loops. One or more factors of the content of the pneumatic loops may affect the gas flow in the enclosure.

In some embodiments, an operation of the layer dispensing mechanism (e.g., recoater) may change the atmospheric characteristic(s) in the enclosure. In an example, operation of the layer dispensing mechanism (e.g., recoater) changes the gas flow characteristic(s) in the enclosure. The layer dispensing mechanism may comprise a material dispenser, material remover, or leveler. Pre-transformed material (e.g., powder) can be introduced into the enclosure through the material dispenser and planarized with the leveler and/or with the material remover. In an example, the layer dispensing mechanism includes the material dispenser and the material remover. The remaining material (e.g., including the excess pre-transformed material and/or debris) can be removed (e.g., attracted such as vacuumized) using the material remover. The remaining materials (also referred to herein as “remainder”) can move through the passages in the material remover. The layer dispensing mechanism may have at least one restriction that affects the gas flow in the enclosure. The passages in the material dispenser and/or material remover may be clogged with the material (e.g., powder) and may cause the change in the at least one characteristic of the atmosphere (e.g., gas flow) in the enclosure. The at least one characteristic of the atmosphere may comprise a gas flow velocity, gas flow acceleration, gas flow direction, pressure, or temperature.

In some embodiments, an operation of the gas conveyance system may affect the at least one characteristic of the atmosphere (e.g., the gas flow) in the enclosure. The gas conveyance system may comprise various components, e.g., valve(s), pipe(s), sensor(s), pump(s), and/or filter(s). The gas conveyance system may comprise at least one pump that facilitates (e.g., enables at least in part) the flow of fluids and/or controls one or more gas related variables. The one or more gas related variables may comprise pressure, flow rate, flow acceleration, flow direction, flow homogeneity, gas pressure, gas temperature, or volume of gas flowing in a passage. The operation of the pump may affect the flow of the fluids (e.g., gas) in the gas conveyance system and/or the enclosure. The at least one pump may alter (e.g., increase and/or decrease) its power. The power alteration of the pump comprises change at a steady rate or change at a fluctuating rate. The power alteration of the pump may comprise continuous change or pulsed change. The change in the power of the at least one pump may change the velocity and/or acceleration of the gas flow in the gas conveyance system and/or in the enclosure.

In some embodiments, one or more restrictions in the gas flow in various systems operatively coupled (e.g., directly and/or indirectly) with the enclosure affect the at least one characteristic of the atmosphere (e.g., the gas flow) in the enclosure. The restriction(s) may be disposed in the layer dispensing mechanism, gas conveyance system, and/or material recycling system. The restriction(s) may comprise valve(s), pipe(s), sensor(s), pump(s), or filter(s). The operation of valve(s) in the gas conveyance system may affect the one or more gas related variables. In an example, the one or more gas related variables comprises the volume of the gas flowing in the passage. Affecting the volume of the gas flowing in the passage may cause pressure differentials (i) in the gas conveyance system, (ii) in the enclosure, and/or (iii) between the gas conveyance system and the enclosure.

In some embodiments, the material recycling system may affect the gas flow in the enclosure and/or in the gas conveyance system. The remaining material (e.g., including the surplus pre-transformed material and/or debris) in the enclosure can be attracted away (e.g., by vacuuming) using the material remover. The removed remaining material can be introduced into separator(s) comprising cyclone(s) and/or filter(s). The remainder material may undergo separation (e.g., cyclonic separation) in separator(s) and/or filter(s). The remainder material may be introduced into filter sieve(s). The separation may utilize non-gravitational flow and/or gravitational flow. The remainder may flow (e.g., gravitationally) into a reservoir (e.g., hopper) such as a lower reservoir. The separated and/or sieved remainder material can be then delivered back into the layer dispensing mechanism as pre-transformed material, e.g., usable for 3D printing. The gas flow in the material recycling system may be changed e.g., during the separation process. Such change may affect the gas flow in the enclosure, e.g., causing it to change in one or more gas related variables. In an example, the pressure of the material recycling system is changed, e.g., dropped. This pressure change (e.g., drop) may affect other one or more gas related variables (e.g., related to the gas flow) in the enclosure, which is interconnected to the material recycling system.

In some embodiments, gas (e.g., robust gas) is exchanged with respect to the enclosure. In an example, the exchange of the gas includes ingress of gas into the enclosure and/or egress of gas out of the enclosure, e.g., to alleviate the change of the altered one or more gas related variables in the enclosure. For example, to alleviate changes in the pressure differential in the enclosure, in the gas conveyance system, and/or between the enclosure and the gas conveyance system. The exchange of gas may constitute at least a portion of a pressure alteration procedure. The robust gas may be introduced into the enclosure to compensate for the under-pressure of the enclosure. The robust gas may be relieved from the enclosure to reduce over-pressure in the enclosure, e.g., above an overpressure threshold. The exchange of the robust gas may facilitate controlling (e.g., maintaining) the requested pressure level (i) within a requested pressure threshold (e.g., threshold range) and/or (ii) for a requested minimal time span. The minimal time span may be a time span during which the pressure deviates from the pressure threshold. The pressure threshold and/or the time span of pressure deviation may prevent the pre-transformed material and/or debris to move from one position to another position, thus alleviating disturbance to the 3D printing process.

In some embodiments, changes in the one or more gas related variables and/or changes in the at least one characteristic of the atmosphere causes disruption to the 3D printing process. The 3D printing process may comprise using a material bed having a planar exposed surface. The disruption to the 3D process may comprise disruption to the planarity of the exposed surface. In an example, the pressure differential of the atmosphere in the enclosure causes displacement of powder (e.g., including powder in the exposed surface) from the powder bed. Such displacement may lead the disruption to the planarity of the exposed surface of the powder bed. The disruption to the planarity may comprise expulsion, eruption, and/or ejection of material from the material bed into the atmosphere of the enclosure, thus causing deviation from planarity of the exposed surface of the material bed. In an example, the material bed is a powder bed. The disruption may comprise ejection of powder from the powder bed into the enclosure atmosphere, e.g., in the form of powder “volcanoes”. Reducing occurrence (e.g., preventing) the material disruption may prevent the uniformity of the exposed surface of the material bed and/or increase in gas borne debris. In some embodiments, the requested pressure change tolerated may be at most about 0.01 Kilo Pascal (kPa), 0.03 kPa, 0.05 kPa, 0.1 kPa, 0.2 kPa, 0.3 kPa, 0.5 kPa, 0.6 kPa, 1.0 kPa, or less from the requested pressure threshold level. In some embodiments, the requested pressure range may be at most about +/−0.005 kPa, 0.025 kPa, 0.05 kPa, 0.1 kPa, 0.2 kPa, 0.3 kPa, 0.5 kPa, or less. The pressure differential may comprise any value between the aforementioned values, e.g., from about 0.01 KPa to about 1.0 KPa. In some embodiments, the requested minimum time span for pressure deviation may be at most about 0.1 second (sec), 0.3 sec, 0.5 sec, 1 sec, 1.5 sec, 2 sec, 5 sec, or less. The duration of the pressure differential may comprise any value between the aforementioned values, e.g., from about 0.1 sec to about 5 sec.

In some embodiments, the 3D printing system has various components. 3D printing system may comprise an enclosure, a gas conveyance system, an optical system, and an energy source. The enclosure may comprise a processing chamber and a build module. The processing chamber may or may not be connected to the build module. In an example, the build module is reversibly connected (e.g., during the printing) and disconnected (e.g., after the printing) from the enclosure. The 3D printing system may comprise the optical system enclosure and the energy source. The optical system enclosure may be operatively coupled with at least one energy source. The optical system enclosure comprises various components including the optical system (e.g., scanner). The optical system can translate the energy beam along a path, which the energy beam travels through the optical windows into the enclosure. The 3D printing system may comprise one or more energy beams and respective optical systems and optical windows. The enclosure (e.g., processing chamber) may comprise one or more (i) gas inlets and (ii) gas outlets. The 3D printing system may comprise the gas conveyance system. The gas conveyance system may be connected to the enclosure. One end of the gas conveyance system may be connected to the gas outlets, and the other end of the gas conveyance system may be connected to (i) the gas inlets, (ii) optical windows, and/or (iii) the optical system. The gas conveyance system may comprise various components comprising filter, gas line, discharge container, pump, gas enriching system, temperature conditioning system, or valve. Each of the components may be singular or plural. Gas egressed (e.g., expelled) from the enclosure (e.g., over pressured gas above a threshold) may be introduced (e.g., ingress) into the filter. The filter may be configured to facilitate streaming gas with a higher degree of purity, such as a HEPA filter. Debris included in the egressed gas from the enclosure can be removed with the filter. The debris may be collected in the discharge container. The egressed gas stream from the enclosure may split and diverted to (i) the pump in the gas conveyance system and/or (ii) an exhaust location. The egressed gas from the enclosure may be (i) introduced into the pump and/or (ii) egressed to the exhaust location. The exhaust location can comprise an ambient atmosphere or a reservoir (e.g., pressure reservoir). The pump may pressurize the gas passing through it. In an example, a portion of the filtered gas from the filter is introduced into the pump and pressurized until the pressure of the gas conveyance system reaches its maximum. The rest of the filtered gas may be egressed to the exhaust location. The gas conveyance system may comprise one or more valves. The one or more valves may comprise valves located (i) upstream of the pump or (ii) upstream of the exhaust location. “Upstream” are based at least in part on the direction of the gas flow. The valves may control (i) the gas flow direction (e.g., to the pump and/or to the exhaust location), and/or (ii) the gas flow rate at each direction. In an example, the gas conveyance system may comprise valve(s) (e.g., an outlet valve assembly) located upstream of the exhaust location. The outlet valve assembly may comprise one or more valves, e.g., include proportional valve(s), and/or discrete valve(s). The one or more valves may comprise a variable valve. The number of the valves of the outlet valve assembly may depend, e.g., on the pressure difference between the gas conveyance system and the exhaust location. The gas conveyance system comprises a gas enriching system. The gas enriching system may be connected in series or in parallel with the pump. The gas enriching system can enrich the gas with controlled level of a reactive agent. The reactive agent may comprise oxygen or humidity. The gas enriching system can enrich the gas with controlled level of a reactive agent. In an example, the gas enriching system comprises a humidity enriching system, e.g., enriching the gas flow with a controlled level of humidity. In an example, the gas enriching system is configured to enrich the gas flow with oxygen, e.g., with a controlled level of oxygen. One or more valves may be located (i) upstream of the gas enriching system and/or (ii) downstream of the gas enriching system. “Upstream” and “downstream” are based at least in part on the gas flow direction. The gas conveyance system may comprise a temperature conditioning system. The temperature conditioning system (e.g., cooler) may control (e.g., drop) the temperature of the gas flow. The gas conveyance system comprises an inlet valve assembly comprising one or more valves (e.g., proportional valve(s), and/or discrete valve(s)). The inlet valve assembly may be located upstream of the enclosure and downstream of the pump. The number of the valves of the outlet valve assembly may depend on the pressure difference between the gas conveyance system and the enclosure. In an example, the number of valves of the inlet valve assembly is smaller than the number of valves of the outlet valve assembly. The gas conveyance system may comprise one or more restrictions. The restrictions may comprise the valve(s) or the pump(s). A confined volume can be defined in the gas conveyance system between restrictions. The confined volume can function, e.g., as a pressure reservoir. In an example, the internal space of the gas line from the pump to the inlet valve assembly comprises confined volume, in which the pressurized gas egressed from the pump is reserved. The pressurized gas may be introduced into the enclosure, e.g., may ingress into the enclosure. The gas egressed from the enclosure to the gas conveyance system may be recycled, e.g., from the gas conveyance system into the enclosure. The inlet valve assembly may be utilized to control the ingress of the pressurized gas.

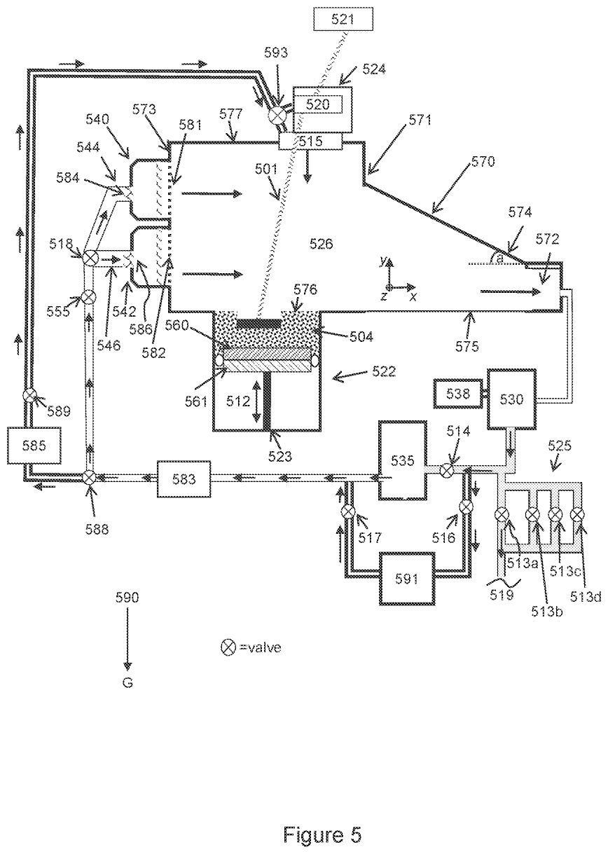

FIG. 5 shows an example of a 3D printing system. The 3D printing system includes an energy source 521. The energy source 521 generates an energy beam 501 that traverses an optical system 520 enclosed in an optical system enclosure 524. The energy beam 501 travels through an optical window 515 into processing chamber enclosing space 526 having an atmosphere. Energy beam 501 impinges upon exposed surface 576 of the material bed 504 to generate at least a portion of a 3D object disposed in the material bed 504. Material bed 504 is supported by base (e.g., build plate or build platform) 560 disposed above a substrate (e.g., piston) 561 that can traverse horizontally 512, e.g., using an elevator mechanism. Material bed 504 is disposed in build module 522 having floor 523, enclosing at least a portion of the elevator mechanism, e.g., the elevator shaft. The processing chamber having interior space 526 comprises one or more side walls 571 and 573, floor 575, and ceiling 577. The processing chamber comprises gas inlets 544 and 546 coupled with the side wall 573, and gas outlet 572 coupled with the side wall 571. The side wall 571 is opposed to the side wall 572. The gas inlet 544 is diverted (e.g., expands) into gas inlet portion 540. The gas inlet 546 is diverted (e.g., expands) into gas inlet portion 542. The processing chamber has a gas outlet portion 570 coupled with gas outlet 572. The gas outlet portion 570 tapers towards the gas outlet 572 in tapering angle 574 alpha (D). A perforated inlet screen 581 is coupled with the gas inlet portion 540. A perforated inlet screen 582 is coupled with the gas inlet portion 542. A perforated inlet screen 584 is coupled with the gas inlet 544. A perforated inlet screen 586 is coupled with the gas inlet 546. The gas outlet 572 and the gas outlet portion 570 are devoid of a perforated screen. The processing chamber is connected to a gas conveyance system. Arrows without numbers indicate the gas flow direction. The processing chamber is connected to filtering mechanism 530 and to pump 535. The filtering mechanism 530 has a distal (e.g., residual) container 538 into which gas borne debris can be collected. The gas conveyance system comprises a gas enriching system 591 connected parallel to the pump 535. The gas enriching system 591 enriches the gas (e.g., gas mixture) flowing in the gas conveyance system by one or more reactive agents (e.g., water and/or oxygen). The gas conveyance system can convey gas (e.g., over pressured gas above a threshold) to the pump 535, and/or to an exhaust location 519. The exhaust location 519 can comprise the ambient environment or a pressure reservoir (not shown in FIG. 5). A portion of the gas passed through an outlet valve assembly 525 is egressed to the exhaust location 519. The outlet valve assembly 525 comprises four valves 513a, 513b, 513c, and 513d. At least two valves may be of different types. At least two valves may be of the same valve type. In an example, the two valves 513a and 513b are proportional valves, and the two valves 513c and 513d are discrete valves. A portion of the gas that passes through valve 514 is introduced into pump 535. A portion of the gas that passes through valve 516 is introduced into gas enriching system 591. Gas egressed from the gas enriching system 591 and passing through a valve 517 is combined with the gas expelled from pump 535. Gas in a confined volume of the gas conveyance system (e.g., (i) from the pump 535 to an inlet valve assembly 555 and/or (ii) from the valve 517 to the inlet valve assembly 555) can be pressurized by the pump 535. The pressurized gas can be introduced into the processing chamber through the gas inlets 544 and 546. The gas conveyance system comprises temperature conditioning system 583 (e.g., a cooler). The gas conveyance system comprises a gas line (e.g., comprising channels) to optical window 515 and to optical system 520, the gas line comprising filter 585 and an optional valve 589. The gas conveyance system includes a channel split to different channels (e.g., gas lines) at junction 588, e.g., to (i) the optical window 515 and optical system 520, and (ii) the processing chamber. Junction 588 may comprise an optional valve. The optical window 515 and the optical system 520 receives gas streams from different gas lines split at junction 593. Junction 593 may comprise an optional valve. Gas inlet 544 and Gas inlet 546 receive gas streams from different gas lines split at junction 518. Junction 518 may comprise an optional valve. In FIG. 5, the processing chamber and the build module are depicted with respect to gravitational vector 590 pointing towards the gravitational center of the ambient environment external to the 3D printer. The gas conveyance system portion extending externally to the processing chamber from gas outlet 572 to optional perforated screens 581 and 582 and to junction 588, is not entirely depicted with relation vector 590, and is rather depicted schematically.

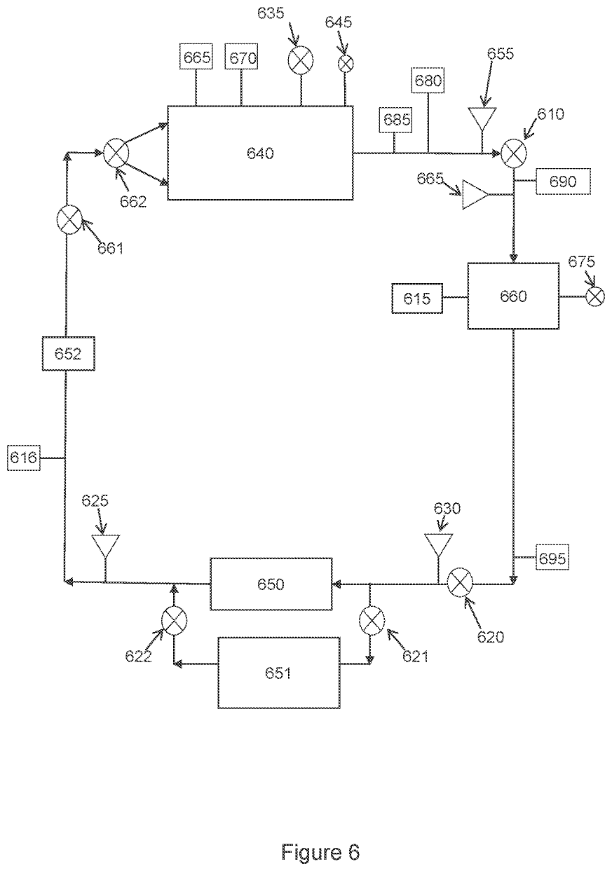

FIG. 6 shows an example of a 3D printing system. The 3D printing system comprises an enclosure 640 and a gas conveyance system. The gas conveyance system comprises filtering mechanism 660, a pump 650, a humidity enriching system 651, and a temperature conditioning system 652. The gas conveyance system is configured to conveys gas (e.g., internal gas egressed from the enclosure 640) to the filtering mechanism 660. The gas conveyance system comprises one or more sensors 615, 616, 670, 680, 685, 690, and 695. The sensors may be associated with one or more gas related variables. The gas conveyance system comprises one more valves 610, 620, 621, 622, 625, 630, 635, 645, 655, 661, 662, 665, and 675. The valves facilitate (e.g., enable and/or regulate at least in part) the flow of the gas. The sensor 670 is connected to the enclosure 640. The sensor 670 senses the pressure of the enclosure 640. The valves 635, 645, and 665 are connected (e.g., directly or indirectly) to the enclosure 640. The valves 665 regulates the ingress of the gas into the enclosure 640. The valves 635 and 645 regulate the egress of the gas from the enclosure 640. The sensors 680, 685, and 690 are located in the gas conveyance system between the upstream of the enclosure 640 and the downstream of the filtering mechanism 660. The sensors 680 and 685 sense the pressure of the gas egressed from the enclosure 640. The sensor 690 senses the pressure of a portion of the gas conveyance system comprising the gas passed through the valve 610. The valves 610, 655, and 665 can facilitate introduction of the gas (e.g., comprising robust gas) into the filtering mechanism 660. The sensor 615 is connected to the filtering mechanism 660. The sensor 615 can sense the pressure of gas inside the filtering mechanism 660. The gas conveyance system comprises an outlet valve assembly 675. The outlet valve assembly may comprise one or more valves, e.g., connected in parallel or series. The outlet valve assembly 675 is connected to the exhaust location (e.g., an ambient environment and/or a pressure reservoir (not shown in FIG. 6)). The gas egressed from the filtering mechanism 660 is directed to (i) the exhaust location and/or (ii) the gas conveyance system (e.g., the pump 650 and/or the humidity enriching system 651). In an example, the gas flows into the gas conveyance system until the gas conveyance system reaches its maximum pressure, and the residual gas is egressed to the exhaust location. The sensor 695 and the valves 620 and 630 are located between the upstream of the filtering mechanism 660 and the downstream of the pump 650. The sensor 695 can sense the pressure of a portion the gas conveyance system comprising the gas egressed from the filtering mechanism 660. The valves 620 and 630 may facilitate introduction of the gas into the pump 650 and/or the humidity enriching system 651. The valves 621 and 622 may be utilized in controlling the flow of the gas passing through the humidity enriching system 651. The gas egressed from the humidity enriching system 651 and passed through the valve 622 is combined with the gas egressed out of the pump 650. The valve 625 and the sensor 616 is located in the gas conveyance system between the upstream of the pump 650 and the downstream of the temperature conditioning system 652. The valve 625 may facilitate introduction of a gas into the temperature conditioning system 652. The sensor 616 can sense the temperature of the gas that ingresses into the temperature conditioning system 652. The temperature conditioning system 652 can regulate the temperature of the gas based at least in part on the temperature data obtained from the sensor 616. The valve 661 is located at the downstream of the temperature conditioning system 652. The gas in a confined volume of the gas conveyance system (e.g., (i) from the pump 650 to the valve 661 and/or (ii) from the valve 622 to the valve 661) can be pressurized by the pump 650. The pump 650 and/or the valves 622 and 661 can constitute restrictions. The restrictions can be fixed or variable. Pressurized gas can be introduced into the enclosure 640 through split valve 662. The split valve 662 splits the gas stream into the enclosure 640. One of the split gas streams is introduced into the upper portion of the enclosure 640. One of the split gas streams is introduced into the lower portion of the enclosure 640.

In some embodiments, the 3D printing system comprises a layer dispensing mechanism. The layer dispensing mechanism may be disposed in an enclosure. The layer dispensing mechanism may deposit starting materials (e.g., pre-transformed materials) in the enclosure. The starting material may form at least a portion of a material bed in the enclosure. The layer dispensing mechanism may comprise a recoater. The layer dispensing mechanism may be coupled to a moving system that maneuvers (e.g., facilitates the movement of) the layer dispensing mechanism. The layer dispensing mechanism may move along the enclosure (e.g., material bed) and an ancillary chamber (e.g., garage). The ancillary chamber may be configured to accommodate the layer dispensing mechanism in its resting (e.g., idle) position. The ancillary chamber may be coupled with the enclosure (e.g., processing chamber). The layer dispensing mechanism may move back and forth along with the moving system, e.g., in a reversible manner. The layer dispensing mechanism may move to the enclosure and dispense a layer of material (e.g., powder). The layer of the material may form at least a portion of the material (e.g., powder) bed. The moving system may comprise one or more components. The one or more components of the moving system may facilitate the movement of the layer dispensing system (e.g., guiding the path of the layer dispensing system). The one or more components of the moving system may comprise carriage(s), railing(s), or translation inducer(s) (e.g., comprising belt(s)). The one or more components of the moving system may facilitate securing of the layer dispensing mechanism to (e.g., inner wall(s) of) the enclosure. The one or more components may comprise frame(s), mount plate(s), fastener(s) (e.g., screw(s), peg(s), and/or pin(s)), or spacer(s) (e.g., wall mount spacer(s), threaded spacer(s), and/or standoff spacer(s)). The one or more components of the moving system may facilitate the flow of gas (e.g., into and/or out of the enclosure). The one or more components of the moving system may comprise gas aligning structure. The one or more components of the moving system may facilitate the protection of other components from environmental factors within the enclosure. The environmental factors within the enclosure may comprise energy beam, debris, residual material, heat, gas flow or pressure. The environmental factors pertaining to the gas flow may comprise flow direction, flow acceleration, flow speed, flow turbulence, flow laminarity, flow rate pulsation, flow acceleration pulsation, or gas borne debris. The environmental factors pertaining to the gas flow gas borne debris may comprise an amount of debris in the gas, a central tendency of the debris FLS, material comprised in the debris, surface type of the debris, surface roughness FLS of the debris, or morphology of the debris. In some embodiments, the layer dispensing mechanism is connected (e.g., mounted) to a frame of the moving system. The frame may be connected to one or more railings, e.g., at least on one end of the frame. The frame may be connected to the one or more railings, e.g., through a carrier disposed in between. The frame may move back and forth along the railings. The layer dispensing mechanism may move back and forth along the railings. The movement of the layer dispensing mechanism may be driven by a translation inducer, e.g., comprising a belt. The translation inducer may be disposed, e.g., between the frame and the railing. The moving system may comprise an actuator (e.g., a motor) that facilitates the driving of the translation inducer. The actuator may operatively couple to a controller. The railing may comprise a mount plate. The mount plate may be fixed to a structure (e.g., gas flow aligning structure), e.g., by using fastener(s). The mount plate may be separated from the gas flow aligning structure. The fastener may comprise wall mount spacers. The gas flow aligning structure may comprise an area that has holes. The holes may be part of, or operatively coupled to, one or more gas inlet and/or outlet compartments. The holes may be configured for gas to pass therethrough (e.g., into or out of the enclosure). The gas aligning structure may be part of, or connected to, the enclosure (e.g., the inner wall(s) of the enclosure). The moving system may further comprise a protecting component that protects (e.g., shields) other components from the energy beam (e.g., laser). The layer dispensing mechanism may comprise material dispensing mechanism(s), material removal mechanism(s), or material shaping mechanism(s). The material dispensing mechanism(s) may deposit material to form at least a portion of the material bed. The deposited starting material may be shaped (e.g., leveled) by the material shaping mechanism. In some embodiments, the material shaping mechanism comprises a leveler to planarize an exposed surface of the material bed within the enclosure. In some embodiments, the material shaping mechanism is devoid of a leveler to planarize an exposed surface of a material bed within the enclosure. The material shaping mechanism may comprise using a material removal mechanism that does not contact the exposed surface of the material bed, e.g., using vacuum.

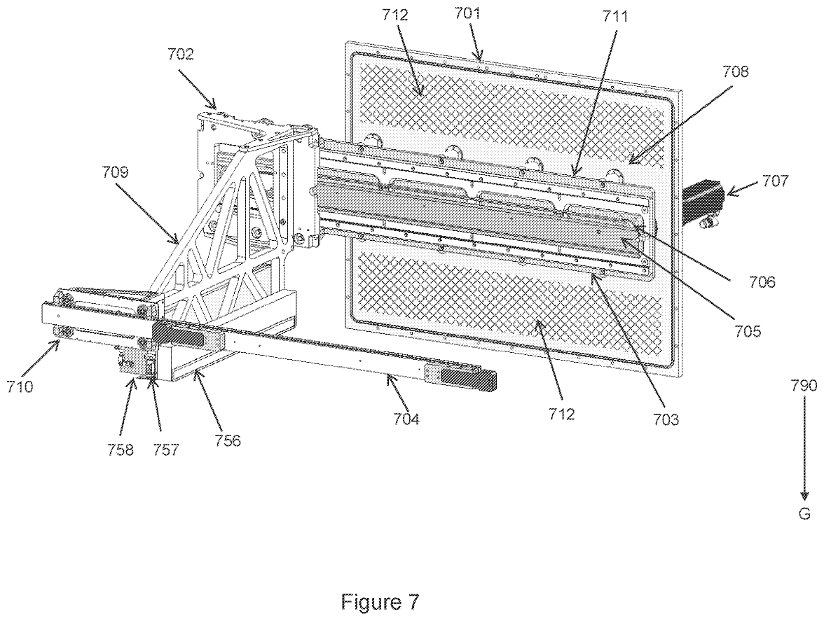

FIG. 7 shows an example of portions of a moving system and a processing chamber wall 701 comprising gas flow aligning structures. The moving system comprises carriage 702; first railing 703 having a mount plate 711; second railing 704; energy beam (e.g., laser) shield 705; translation inducer (e.g., comprising a belt) 706; actuator 707; wall spacer mounts such as 708; framing 709; configured to mount a layer dispensing mechanism that comprises a dispenser 756, a leveler 757, and a remover 758; third railing 710; and an area having holes (e.g., inlets, or vents) constituting gas flow aligning structures 712 comprising holes. The holes may be part of, or operatively coupled to, one or more gas inlet compartments, e.g., FIG. 5, 581 or 582. The holes may be configured for gas to pass therethrough, e.g., into or out of the processing chamber. FIG. 7 depicts vector 790 directed towards a gravitational center G. The moving system is configured to maneuver a layer dispensing mechanism along the railing 703, 704, and 710, which layer dispensing mechanism comprises the dispenser 756, leveler 757 and remover 758 that are mounted to the framing.

In some embodiments, a pressure alteration mechanism facilitates maintaining the gas pressure in the enclosure within a threshold pressure. The pressure alteration mechanism may comprise maintaining the gas pressure in the enclosure at a pre-determined level and/or between a pre-determined range (e.g., from a minimum threshold value to a maximum threshold value). The pressure alteration mechanism may be configured to exchange gas with respect to the enclosure. The exchange of gas may comprise ingress or egress of the gas with respect to the enclosure. The pressure alteration mechanism may comprise one or more operation modes. The one or more operation modes may comprise ingress operation mode(s) and/or egress operation mode(s). The operation modes of the pressure alteration mechanism may be switched based at least in part on level and/or range of pressure value(s). The level and/or range may be pre-determined. In some embodiments, the pressure alteration mechanism maintains the gas pressure in the enclosure from a minimum threshold value to a maximum threshold (e.g., value or range). When the gas pressure in the enclosure is below the minimum threshold value, the ingress operation mode may be initiated. The ingress operation mode may comprise ingress of (e.g., pressurized) gas from a gas source into the enclosure. The gas source may or may not be a target location such as a reservoir. The ingress operation mode may compensate for the under-pressure within the enclosure. When the gas pressure in the enclosure is above the maximum threshold, the egress operation mode may be initiated. The egress operation mode may comprise egress of (e.g., over-pressured) gas from the enclosure into a target location, e.g., a reservoir. The egress operation mode may assist in release of the over-pressure forming in the enclosure. The operation mode may be reversibly switched back from the ingress operation mode to the egress operation mode, e.g., and vice versa in a reversible manner. The pressure alteration mechanism may comprise controlling (e.g., maintaining) the gas pressure in the enclosure within a pressure range being from a minimum threshold value to a maximum threshold value.

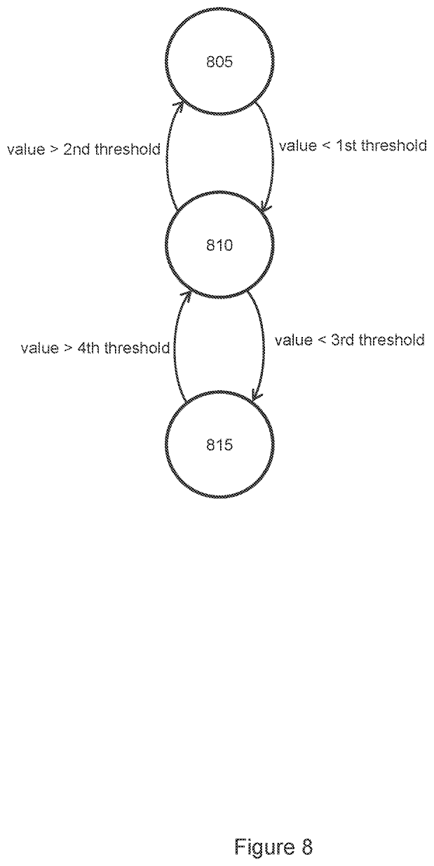

FIG. 8 shows an example of switching between the modes based at least in part on pre-determined threshold levels. For example, the first operation mode 805 is initially performed, when the gas pressure level of an enclosure is above a first threshold value. The second operation mode 810 is initiated when the gas pressure level of the enclosure is at or below the first threshold value. The mode is switched back from the second operation mode 810 to the first operation mode 805 when the gas pressure level of the enclosure exceeds a second threshold value. The third operation mode 815 is initiated when the gas pressure level of the enclosure is at or below a third threshold value. The third operation mode is switched back to a second operation mode when the gas pressure level of the enclosure exceeds a fourth threshold value. The second threshold value can be above the first threshold value. The fourth threshold value can be above the third threshold value. The second threshold value can be above: the third threshold value and the fourth threshold value. The first threshold value can be above: the third threshold value and the fourth threshold value.

In some embodiments, the 3D printing system may comprise a gas conveyance system. The gas conveyance system may (e.g., directly or indirectly) couple to an enclosure. The gas conveyance system may be in fluid contact with the enclosure. The gas conveyance system may facilitate flow of gas into and/or out of the enclosure. The gas may comprise robust gas. The robust gas may comprise a lower concentration of reactive agent(s) (e.g., oxygen and/or water) as compared to an ambient atmosphere. The reactive agent(s) may be capable of reacting with the starting material utilized in the 3D printing system, product of the 3D printing and/or byproduct of the 3D printing such as soot or other forms of debris. The gas conveyance system may facilitate (i) exchange (e.g., ingress and/or egress) of the gas with respect to the enclosure; (ii) removal of debris in the gas; and/or (iii) regulating at least one characteristic (e.g., pressure, temperature, and/or concentration of the reactive agent(s)) of the gas to maintain requested environment in the enclosure. The gas conveyance system may comprise pipe(s), valve(s), filtering mechanism(s), temperature conditioning system(s), or container(s). In some embodiments, gas outlet portion and gas inlet portion of the enclosure are coupled with pipes of the gas conveyance system. Gas expelled from the enclosure (e.g., through the gas outlet portion) may be introduced into the gas conveyance system through the pipe(s). The gas expelled from the enclosure may comprise over-pressured gas. The gas expelled from the enclosure may comprise debris, e.g., gas borne debris, residual material, or other byproduct(s) of the 3D printing. The expelled gas from the enclosure may be introduced into the filtering mechanism. The expelled gas may be filtered in the filtering mechanism. Debris in the expelled gas may be sieved in the filtering mechanism. The sieved debris may be collected in a distal (e.g., residual) container. The distal container may be connected to, or be part of, the filtering mechanism. The filtered gas expelled from the filtering mechanism may be introduced into a pump. The pump may (i) facilitate (e.g., enables at least in part) the flow of gas and/or (ii) controls one or more gas related variables. The one or more gas related variables may comprise pressure, flow rate, flow acceleration, flow direction, flow homogeneity, gas pressure, gas temperature, or volume of gas flowing in a passage. The gas expelled from the pump may be introduced into the temperature conditioning system (e.g., cooler). The temperature conditioning system may regulate the temperature of the gas at a pre-determined value and/or within a pre-determined range. The gas expelled from the temperature conditioning system may split into several (e.g., two) gas streams e.g., at a junction. One of the gas streams flows into the gas conveyance system towards (e.g., the inlet portion of) the enclosure. One of the other gas streams flows towards (i) one or more optical windows, and/or (ii) an optical system enclosure. The gas conveyance system may be in fluidic contact with (i) one or more optical windows, and/or (ii) the optical system enclosure. In some embodiments, a gas flow mechanism separates from the gas conveyance system, and flows gas into the optical enclosure. The gas flowing in the gas flow mechanism may or may not be the same as the gas flowing in the gas conveyance system. The gas stream that flows towards the optical windows may encounter one or more filters configured to reduce a probability (e.g., prevent) debris from attaching to the optical windows. The gas stream that flows towards the optical enclosure may encounter one or more filters configured to reduce a probability (e.g., prevent) debris from attaching to the optical setup in the optical enclosure. The gas stream may flow from the optical windows and/or optical system into the enclosure. The gas flow mechanism may or may not be included in the gas conveyance system. The gas conveyance system may comprise an inlet valve assembly disposed upstream of the enclosure based at least in part on the gas flow direction. The inlet valve assembly may comprise at least one (e.g., restrictive) valve. The restrictive valve may facilitate confining a volume of the gas conveyance system, e.g., from the pump to the inlet valve assembly. The gas expelled from the pump and flowing into the gas conveyance system, may be enclosed in the confined volume. The pump may pressurize the enclosed gas. The inlet valve assembly may facilitate ingress of the pressurized gas into the enclosure. The pressurized gas introduced into the enclosure may compensate the under-pressure of the enclosure. The pressurized gas that passes through the inlet valve assembly may be split into several (e.g., two) gas steams, e.g., at a split valve. Each of the gas streams may be introduced into different locations of the enclosure. In some embodiments, the enclosure comprises several gas inlets, e.g., coupled with a side wall. The gas inlets may be disposed at different heights of the side wall relative to the gravitational direction. The enclosure may comprise a lower gas inlet coupled with a lower portion of the side wall of the enclosure; and an upper gas inlet coupled with an upper portion of the side wall of the enclosure. The “lower” and “upper” may be with respect to the gravitational direction of the ambient environment. Any (e.g., and all) of the gas streams may be introduced into the lower gas inlet and the upper gas inlet.

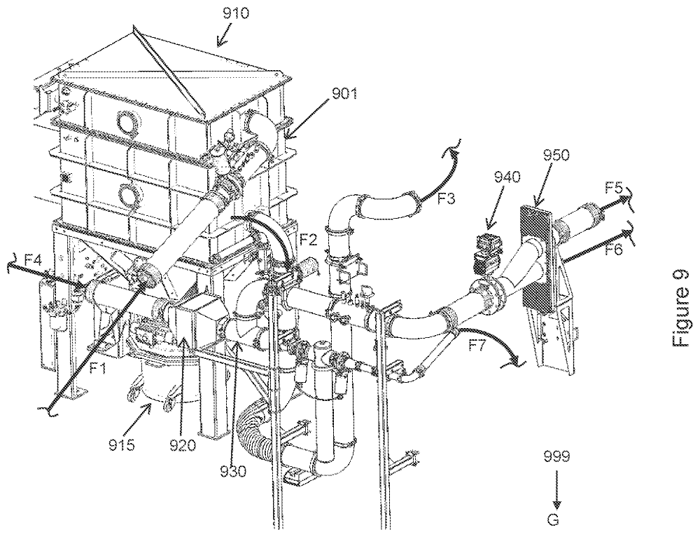

FIG. 9 shows an example of a portion of a gas conveyance system of the 3D printing system. The gas (e.g., over-pressured gas) that egresses from the enclosure (not shown in FIG. 9) ingresses into a gas conveyance system, e.g., into filtering mechanism 910 through pipe 901 connected thereto, as indicated by gas stream F1. The gas is filtered in filtering mechanism 910. Debris (e.g., gas borne debris and/or soot) can be sieved in the filtering mechanism 910. The debris can be collected in distal (e.g., residual) container 915. The filtered gas egresses from the filtering mechanism 910 and ingresses into pipe of the gas conveyance system as indicated by gas stream F2. The filtered gas is conveyed through the pipe and ingresses into a pump (not shown in FIG. 9) as indicated by gas stream F3. The (e.g., pressurized) gas egresses from the pump and ingresses into channel(s) (e.g., pipe(s)) of the gas conveyance system as indicated by gas stream F4. The gas can pass through a temperature conditioning system (e.g., cooler) 920. The gas flow that egresses from the temperature conditioning system 920 splits into two streams of gas at a junction 930. One gas stream at junction 930 flows towards inlet valve assembly 940 and splits at a split valve 950 into gas streams F5 and F6. The other gas stream at junction 930 flows towards one or more optical windows (not shown in FIG. 9) as indicated by gas stream F7. The inlet valve assembly 940 comprises one or more (e.g., restrictive) valve(s). The valve(s) may be configured to confine a volume of the gas conveyance system (e.g., from the pump to the inlet valve assembly 940) and restrict the gas egressed from the pump in the confined volume. Pressure of the gas in the confined volume of the gas conveyance system may be altered (e.g., pressurized) at least in part by the pump. The gas that passes through the inlet valve assembly 940 splits into two streams of gas at the split valve 950. One gas stream flows into a first portion of the enclosure (not shown in FIG. 9) as indicated by gas stream F5. The other gas stream flows into a second portion of the enclosure (not shown in FIG. 9) as indicated by gas stream F6. The 3D printing system may be configured for disposition relative to gravitational vector 999 pointing towards gravitational center G of the ambient environment. The first portion may be positioned higher than the second portion with respect to the gravitational vector 999. The other gas stream at junction 930 is conveyed through pipes and ingress into the optical windows as indicated by gas stream F7. In some embodiments, the ingress may be also into the optical enclosure. The gas stream F7 may reduce a probability (e.g., prevent) debris from attaching to the optical windows and/or optical system. The optical windows and/or optical system may be disposed at the top of the enclosure with respect to the gravitational vector 999. The gas stream F7 flows from junction 930 to the optical windows and/or optical system.

In some embodiments, the 3D printing system comprises a gas conveyance system and a gas flow mechanism. The gas conveyance system and a gas flow mechanism may be separate systems. The gas conveyance system and a gas flow mechanism may not be separate systems. The gas conveyance system may be in fluidic contact with an enclosure of the 3D printing system, e.g., the processing chamber. The enclosure may enclose a material bed. The gas conveyance system may be coupled with gas ingress opening(s) (e.g., gas inlet(s)) and gas egress opening(s) (e.g., gas outlet(s)). Gas (e.g., over-pressured gas) in the enclosure may egress through the gas egress opening(s) into the gas conveyance system. Gas (e.g., comprising robust gas) from the gas conveyance system may ingress through the gas ingress opening(s) into the enclosure, e.g., to compensate for the under-pressure in the enclosure, e.g., comprising the processing chamber. Gas flow from the gas ingress opening(s) may create a flow that directs debris (e.g., soot) in the enclosure out through the gas egress opening. The gas ingress opening(s) and/or gas egress opening(s) may comprise a flow directing component (e.g., foam, distributed openings, mesh, and/or hollow tubes). The gas conveyance system may facilitate pressure alteration procedures in the enclosure. In some embodiments, when the pressure in the enclosure is below threshold, the gas conveyance system provides pressurized gas into the enclosure through gas ingress opening(s). In some embodiments, when the pressure in the enclosure is above a threshold, the enclosure releases (e.g., at least a portion of) the over-pressured gas into the gas conveyance system through the gas egress opening(s). The at least the portion of the gas conveyance system may serve as the reservoir configured to enclose the gas. The gas conveyance system may enclose gas released from the enclosure. The gas conveyance system may provide gas into the enclosure. The gas conveyance system may be coupled with gas inflow opening(s). The gas flow mechanism may or may not be included in the gas conveyance system. In some embodiments, the gas flow mechanism is separate from each other. In some embodiments, the gas flow mechanism is included in the gas conveyance system. Gas from the gas flow mechanism may ingress through the gas inflow opening(s) into the enclosure. Gas inflow opening(s) introducing gas into the enclosure may be located around each of the optical window(s). The optical window(s) and/or optical system may be operatively coupled to the nozzle(s), e.g., connected, contacting, and/or supported. Gas flow from the gas inflow opening(s) may reduce the debris accumulating at the optical window(s) and/or optical chamber engaged with the nozzle(s). The gas may flow from the optical windows and/or optical chamber, into the enclosure. Gas stream from the gas ingress openings may converge with gas stream from the gas inflow opening(s). Any (e.g., each) of the gas ingress opening, gas egress opening, and/or gas inflow opening, may be singular or plural. In some embodiments, the gas ingress opening comprises plural openings. Each of the gas ingress openings may have a different amount of gas flow in a printing cycle. Gas flow through an ingress opening may vary between printing cycles. Total gas flowing through the at least two gas ingress openings may or may not be same. In some embodiments, total gas flow through the plural ingress openings is (e.g., substantially) same. No adjustment of one or components (e.g., pump(s)) of the gas flow may be required. Total equal gas flow through plural gas ingress openings during different operations in the enclosure may allow the pump(s) pumping the gas to operate at an (e.g., substantially) constant operation condition (e.g., constant speed). The constant operation condition may facilitate avoiding adjustment of pump functionality (e.g., speed) and/or avoid lag time when adjusting the pump(s). The gas ingress opening(s), and gas egress opening(s) may be positioned on side wall(s) of the enclosure. The egress opening(s) may be positioned on the opposite side wall of the enclosure where the gas ingress opening(s) is positioned. The gas inflow opening(s) may be positioned on a ceiling of the enclosure.

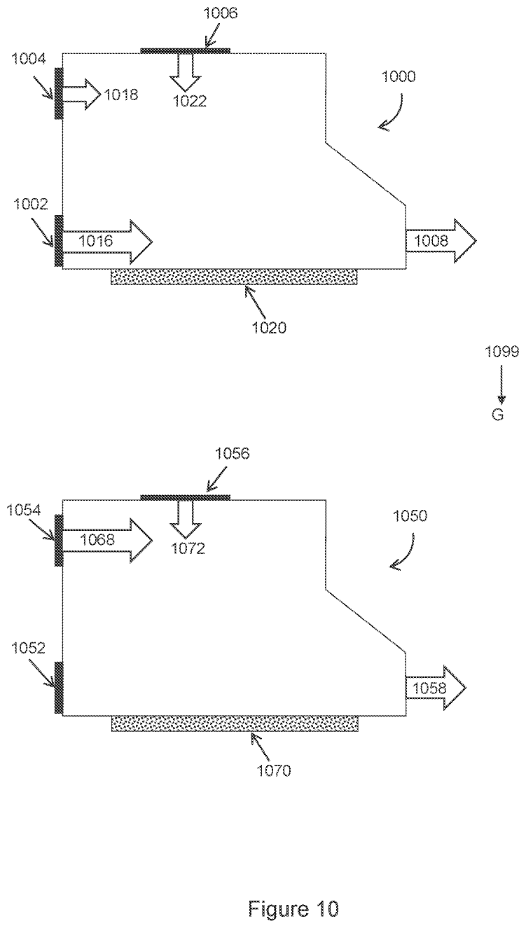

FIG. 10 shows an example of a side view of a processing chamber 1000. The processing chamber 1000 comprises a first gas ingress opening 1002, a second gas ingress opening 1004, a third gas inflow opening(s) 1006 (e.g., from nozzle(s) around an optical window(s)), and a gas outlet (e.g., egress opening) 1008. The first gas ingress opening 1002 is closer to a material bed 1020 than the second gas ingress opening 1004. Optical window(s) and/or optical system engaged with nozzle(s) is located around the third gas inflow opening(s) 1006 flowing gas flow 1022 into processing chamber 1000. Arrows represent gas flow during one or more operations being performed in the processing chamber 1000, with the relative sizes for the inflowing gas representing relative proportions of gas flow capacity. For example, during a printing operation (e.g., using an energy beam(s) directed through the optical window(s)), a first gas flow 1016 from the first gas ingress opening 1002 is greater than a second gas flow 1018 from the second gas ingress opening 1004. Gas flow from the first gas ingress opening 1002 and the second gas ingress opening 1004 creates a flow that can direct debris (e.g., soot) out through the gas outlet 1008, while gas flow 1022 from the third gas inflow opening(s) 1006 can keep the debris away from the optical window(s) engaged with the nozzle(s). The first gas ingress opening 1002 and second gas ingress opening 1004 are disposed on one wall of the processing chamber opposing the gas outlet 1008. Gas inflow opening(s) 1006 is disposed on a ceiling perpendicular to the one wall. FIG. 10 also shows an example of a processing chamber 1050. The processing chamber 1050 comprises a first gas ingress opening 1052, a second gas ingress opening 1054, a third gas inflow opening(s) 1056 inflowing gas around optical window(s) and/or optical system and through nozzle(s), and a gas outlet (e.g., egress opening) 1058. The first gas ingress opening 1052 is disposed closer to a material bed 1070 than the second gas ingress opening 1054. Arrows represent gas flow during one or more operations being performed in the processing chamber 1050. The relative sizes of arrows utilized to represent the inflowing gas represent relative proportions of gas flow capacity. For example, during an operation such as dispensing a portion of the material bed (e.g., dispensing a planar layer of pre-transformed material also known as recoating), a first gas flow is minimal or (e.g., essentially) stopped; and a second gas flow 1068 flows through the second gas ingress opening 1054. Gas flow 1072 from the third gas inflow opening(s) 1056 may keep debris (e.g., soot) away from the optical window(s) and/or optical system. In some embodiments, the total gas flow through the first gas ingress opening 1002 and the second gas ingress opening 1004 during operation of the energy beam may be such that no adjustment of one or components (e.g., pump(s)) of the gas flow is required. The total gas flow through the first gas ingress opening 1002 and the second gas ingress opening 1004 during operation of the energy beam, may (e.g., essentially) be equal to the total gas flow through the first gas ingress opening 1052 (that is in this example zero) and the second gas ingress opening 1054 during a different operation occurring in the processing chamber. The processing chambers in FIG. 10 may be configured for disposition relative to gravitational vector 1099 pointing towards gravitational center G.

In some embodiments, the 3D printing system may comprise a control system. The control system may comprise one or more controllers. The control system may comprise, or be operatively coupled with, one or more devices, apparatuses, and/or systems of the 3D printing system, including any component of the device(s), apparatuses(s), and/or system(s). The controllers or control mechanisms (e.g., comprising a computer system) may be programmed to implement methods of the disclosure.

In some embodiments, the 3D printer comprises a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may be part of a control system comprising multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may utilize one or more wired and/or wireless networks for communication, e.g., with other controllers or devices, apparatuses, or systems of the 3D printing system and its components. For example, wired ethernet technologies, e.g., a local area networks (LAN). For example, wireless communication technologies, e.g., a wireless local area network (WLAN). The controller may utilize one or more control protocols for communication, for example, with other controller(s) or one or more devices, apparatuses, or systems of the 3D printing system or any of its components. Control protocols can comprise one or more protocols of an internet protocol suite, e.g., transmission control protocol (TCP) or transmission control protocol/internet protocol (TCP/IP). Control protocols can comprise one or more serial communication protocols. Control protocols can comprise one or more of controller area networks or another message-based protocol, e.g., for communication with microcontrollers and devices. Control protocols can interface with one or more serial bus interfaces for communication with the 3D printing system and its components. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. Examples of controller, control protocols, control systems, 3D printing systems, apparatuses, devices, and any of their components, and 3D printing processes can be found in International Patent Application Serial No. PCT/US17/18191, filed Feb. 16, 2017, titled “ACCURATE THREE-DIMENSIONAL PRINTING,” which is incorporated herein by reference in their entirety.

Control may comprise regulate, modulate, adjust, maintain, alter, change, govern, manage, restrain, restrict, direct, guide, oversee, manage, preserve, sustain, restrain, temper, or vary.

In some embodiments, the methods, systems, device, software and/or the apparatuses described herein comprise a control system. The control system can be in communication with one or more components of the 3D printing system. The control system can be in communication with one or more components facilitating the 3D printing methodologies. The control system can be in communication with one or more energy sources, optical systems, gas flow system, material flow systems, energy (e.g., energy beams), build platform assembly, and/or with any other component of the 3D printing system.

In some embodiments, the 3D printing system comprises a controller. The controller may include one or more components. The controller may comprise a processor. The controller may comprise a specialized hardware (e.g., electronic circuit). The controller may be a proportional-integral-derivative controller (PID controller). The control may comprise dynamic control (e.g., in real time during the 3D printing process). For example, the control of the (e.g., transforming) energy beam may be a dynamic control (e.g., during the 3D printing process). The PID controller may comprise a PID tuning software. The PID control may comprise constant and/or dynamic PID control parameters. The PID parameters may relate a variable to the required power needed to maintain and/or achieve a setpoint of the variable at any given time. The calculation may comprise calculating a process value. The process value may be the value of the variable to be controlled at a given moment in time. For example, the process controller may control a height of at least one portion of the layer of hardened material that deviates from the average surface of the target surface (e.g., exposed surface of the material bed) by altering the power of the energy source and/or power density of the energy beam, wherein the height measurement is the variable, and the power of the energy source and/or power density of the energy beam are the process value(s). The variable may comprise a temperature or metrological value. The parameters may be obtained and/or calculated using a historical (e.g., past) 3D printing process. The parameters may be obtained in real time, during a 3D printing process. During a 3D printing process, may comprise during the formation of a 3D object, during the formation of a layer of hardened material, or during the formation of a portion of a layer of hardened material. The calculation output may be a relative distance (e.g., height) of the material bed (e.g., from a cooling mechanism, bottom of the enclosure, optical window, energy source, or any combination thereof). The controller may comprise a feedback control scheme. The feedback control scheme may comprise an open feedback loop control scheme. The feedback loop control scheme may comprise a closed feedback loop control scheme. Feedback control scheme may comprise hardware compensation. Feedback control scheme may comprise software compensation. Control system may comprise, or be operatively coupled with, a metrological detection system and configured to receive measurement data from the metrological detection system, e.g., height mapper. The control system may be configured to generate control signals responsive to the measurement data collected by the metrological detection system.

In some embodiments, a controller of a 3D printing system comprises a metrological detection system. The metrological detection system may be used in the control of 3D printing processes of the 3D printing system. The metrological detection system may be configured to detect distance variations such as vertical distance variations, e.g., height variations. The metrological detection system may be configured to detect distance variations such as horizontal distance variations, e.g., variations with respect to an XY plane. For example, a horizontal distance variation along an X-axis that is oriented parallel to a direction of translation of a translatable component (e.g., a translation mechanism). For example, a horizontal distance variation along a Y-axis that is orientated perpendicular to the direction of translation of the translatable component (e.g., the translation mechanism) and perpendicular to a gravitational vector. The metrological detection system may be configured to detect a vertical (e.g., height) variations in a planar surface, e.g., a planar exposed surface of a material bed. The metrological detection system may comprise a height mapper system. The metrological detection system may comprise an interferometric optical system. The metrological detection system may comprise a position sensitive device system. The metrological detection system may comprise an optical detector. The metrological detection system may include, or be operatively coupled with, an image processor. The metrological detection system may comprise an imaging detector to monitor irregularities. The image detector may comprise a camera such as a charged coupled device (CCD) camera. The image detector may comprise detecting a location or an area of the printed 3D object and convert it to a pixel in the X-Y (e.g., horizontal) plane. The image detector may comprise detecting an interference pattern generated by an interferometric beam path. The image detector may comprise detecting position of a beam incident on the image detector relative to an imaging region of the image detector. The controller may comprise one or more computational schemes to convert data (e.g., measurement data) from the metrological detection system to generate a result. The one or more computational schemes may be utilized to determine one or more aspects of the build platform assembly, the optical system, and/or of the target surface, e.g., the exposed surface of the material bed or the build platform surface. The one or more aspects may comprise positional aspects, or localization aspects. The one or more aspects may be absolute or relative. For example, an aspect can include a physical orientation of a moving component of the build module, the moving component comprising a base, substrate, or build platform assembly, the build module assembly comprising the base (also herein “build platform”). For example, an aspect can include a physical orientation of a moving component of the optical system, e.g., of one or more optical assemblies, energy beam paths, or processing cones incident on the target surface. The physical orientation may comprise a relative orientation (e.g., relative to a requested orientation) or an absolute orientation (e.g., relative to a coordinate axis). For example, an aspect may comprise a relative orientation of the target surface or at least one optical assembly (e.g., a plurality of optical assemblies) with respect to an enclosure (e.g., the processing chamber) with respect to a requested orientation, e.g., characterizing offset value(s) of the position (e.g., XY position) of the optical assembly or target surface from the requested value(s). For example, an aspect may include (a) a height (e.g., along a z-axis) of the target surface, (b) an XY position (c) a rotation of the target surface, or (d) any combination of (a), (b), and (c). The orientation may include (A) pitch or roll (e.g., due to movement around the horizontal axis). The controller may utilize one or more computational schemes to measure a height (e.g., along a z-axis) of the target surface (e.g., a phase shift computational scheme). The controller may utilize one or more computational schemes to measure a position (e.g., about the XY plane). The computational scheme may comprise an algorithm. The controller may utilize a computational scheme comprising a (e.g., digital) modulation scheme that conveys data by changing (e.g., modulating) the phase of a reference signal (e.g., carrier wave). Measurements collected by the metrological detection system may be utilized by one or more controllers, for example, to provide feedback controls to one or more control systems. For example, the one or more controllers may process, or direct processing, the measurements at a time including before, after and/or during the 3D printing process (e.g., in real time). The one or more controllers may be integrated in a control system that controls the 3D printing process (e.g., the recoater, gas flow system, and/or energy beam(s)). The control system may be any control system disclosed herein. For example, the control system may be a hierarchical control system. For example, the control system may comprise at least three hierarchical control levels, e.g., at least three, four, or five control levels.

Methods, apparatuses, and/or systems of the present disclosure can be implemented by way of one or more computational schemes. A computational scheme can be implemented by way of software upon execution by one or more computer processors. For example, the processor can be programmed to calculate the path of the energy beam and/or the power per unit area emitted by the energy source (e.g., that should be provided to the material bed in order to achieve the requested result). Other control and/or algorithm examples may be found in International Patent Application Serial No. PCT/US17/18191, filed Feb. 16, 2017, titled “ACCURATE THREE-DIMENSIONAL PRINTING;” which is incorporated herein by reference in their entirety.

In some embodiments the control system comprises a laser control system. The laser control system may comprise, or may be operatively coupled with, an optical translation control system. The laser control system may comprise, or be operatively coupled with, a laser system (e.g., optical system) of the 3D printing system, e.g., energy sources, optical components, translation mechanism, optical systems, motors, encoders, or the like. At times, the laser control system is operable to control operations of the optical system (e.g., comprising one or more optical assemblies) of the 3D printing system. The control system may be operable to adjust operations of the optical system (e.g., of the one or more optical assemblies) in response to a measured positional deviation of one or more aspects of the translatable optical system. The laser control system may be operable to adjust (e.g., calibrate) one or more characteristics of the irradiating energy (e.g., the energy beam) incident on the target surface, e.g., the exposed surface of the material bed. Adjusting one or more characteristics of the irradiating energy beam may comprise a software adjustment (e.g., calibration). Adjusting one or more characteristics of the irradiating energy beam may comprise a hardware adjustment (e.g., calibration).

In some embodiments, the laser control system is configured to calibrate one or more characteristics of the irradiating energy (e.g., energy beam) in response to a positional deviation of the target surface, translational mechanism, optical system component(s), build platform assembly, or build platform, from a requested position. For example, the laser control system may be configured to calibrate one or more characteristics of the irradiating energy in response to a positional deviation of the target surface about an XY plane and/or about a rotational axis of the target surface (e.g., rotation about a central axis). For example, the laser control system may calibrate (i) the position at which the irradiating energy contacts a surface (e.g., the target surface), (ii) the shape of the footprint of the energy beam at the (e.g., target) surface, (iii) the XY offset of a first energy beam position at the (e.g., target) surface with respect to a second energy beam position at the (e.g., target) surface, and/or (iv) the XY offset of the energy beam with respect to the (e.g., target) surface. The position at which the energy beam contacts the surface is the position at which the energy beam impinges on the surface.

In some embodiments, the laser control system is configured to calibrate one or more characteristics of the irradiating energy (e.g., energy beam). A calibration may include a comparison of a commanded (e.g., instructed) energy beam position (e.g., at the target surface) compared with an actual (e.g., measured) energy beam position at the target surface. The characteristics of the energy beam may be calibrated along a field of view of the optical system (e.g., and/or detector). The laser control system may calibrate characteristics of a processing cone of the energy (e.g., laser beam). The calibration of the focus mechanism may achieve a requested spot or footprint size for various locations in the field of view of the irradiating energy (e.g., intersection of the processing cone with the target surface and/or calibration structure surface). The power density distribution measure may be calibrated (e.g., substantially) identically, or differently, along the field of view of the irradiating energy. In some embodiments, different positions in the field of view may require different focus offsets and/or or footprint size. Processing cone coverage of the material bed can depend in part on dimensions of one or more of the mirrors of a scanner, e.g., galvanometric scanner, utilized to direct a path of the energy beam about the target surface. Laser control systems, control systems, controllers and operation thereof, 3D printing systems and processes, apparatus, methods, computer programs, are disclosed in International Patent Application Serial No. PCT/US19/14635 filed Jan. 22, 2019, and U.S. Provisional Patent Application Ser. No. 63/290,878 filed on Dec. 17, 2021, each of which is incorporated herein by reference in its entirety.

At times, a calibration comprises generating a compensation for one or more characteristics of the laser system. A compensation may be effectuated at least in part by a (e.g., energy beam) calibration. At times, an energy beam calibration comprises formation of one or more (e.g., physically printed or optically projected) alignment markers using at least one energy beam directed at a target surface. The one or more alignment markers may form an arrangement (e.g., a pattern). The position(s) of the marker(s) may be according to a requested (e.g., pre-determined) arrangement (e.g., a reference pattern). Requested may be according to a commanded arrangement as directed by commands to a guidance system for directing the energy beam(s). The arrangement (e.g., position(s)) of the one or more alignment markers may be detected by a detection system. The detected position(s) (e.g., measured position(s)) of the alignment marker(s) may be compared to commanded (e.g., requested) position(s). The energy beam calibration may comprise correction (e.g., compensation) of any deviation of the detected position(s) from the commanded position(s). The deviation of the detected position(s) from the commanded position(s) may be caused in part by (a) thermal effects on the energy beam and/or optical components, (b) position deviation of the target surface, (c) a non-uniformity of layer deposition, or (d) a combination thereof. Following application of the (e.g., initial) compensation to the energy beam (e.g., to the guidance system directing the energy beam), further (e.g., additional) calibration may be performed. Further calibration may (e.g., iteratively) improve the compensation of the any deviation between the detected position(s) from the commanded position(s) of the energy beam at the target surface. The deviation may depend on the nature and/or geometry of one or more optical elements of the optical system. The calibration may comprise altering the one or more elements (e.g., position thereof) of the optical system. The calibration may comprise altering a command to one or more elements of the optical system and/or to the energy source.

In some embodiments, the control system utilizes data from a metrological detection system. The control system may use the data to control one or more parameters of the 3D printing. For example, the control system may use the metrology data to control one or more positions of the optical system. At times, the control system may utilize a control scheme comprising a feedback control loop that utilizes alignment data, e.g., collected from one or more metrological detection systems to update control parameters of one or more control systems. Data collected from one or more metrological detection systems may comprise alignment data indicative of a position of at least one component of the optical system, for example, a position of (A) an optical assembly, (B) the array of optical assemblies, (C) the translation mechanism, (D) energy beam(s) of the optical system incident on the target surface, or (E) any combination of (A) to (D). The data collected from one or more metrological detection systems can be utilized by a feedback control loop to adjust a position of the component of the optical system, for example, a position of (A) an optical assembly, (B) the array of optical assemblies, (C) the translation mechanism, (D) energy beam(s) of the optical system incident on the target surface, or (E) any combination of (A) to (D). At times, a control scheme comprises a feedforward control loop that utilizes alignment data to update control parameters of one or more control systems. Alignment data may comprise historical data, e.g., data collected after a three-dimensional process performed by a three-dimensional printer. Historical data (e.g., historical measurements) may comprise characterization of three-dimensional objects formed utilizing the three-dimensional printer. The historical data may be utilized in a feedforward control loop to adjust a position of (A) an optical assembly, (B) the array of optical assemblies, (C) the translation mechanism, (D) energy beam(s) of the optical system incident on the target surface, or (E) any combination of (A) to (D). The control system may use the metrology data to control one or more parameters of the energy source and/or energy beam. The one or more measurements from the metrological detection system may be used to alter (e.g., in real time, and/or offline) the computer model. For example, the metrological detection system measurement(s) may be used to alter the optical proximity correction data. For example, the metrological detection system measurement(s) may be used to alter the printing instruction of one or more successive layers (e.g., during the printing of the 3D object).

In some embodiments, the detector and/or controller(s) averages at least a portion of the detected signal over time (e.g., period). In some embodiments, the detector and/or controller(s) reduces (at least in part) noise from the detected signal (e.g., over time). The noise may comprise detector noise, sensor noise, noise from the target surface, or any combination thereof. The noise from the target surface may arise from a deviation from planarity of the target surface (e.g., when a target surface comprises particulate material (e.g., powder)). The reduction of the noise may comprise using a filter, noise reduction algorithm, averaging of the signal over time, or any combination thereof.

In some embodiments, the controller(s) (e.g., continuously or intermittently) calculates an error value during the control time. The intermittent calculation may or may not be periodic. The error value may be the difference between a requested setpoint and a measured process variable. The control may be continuous control (e.g., during the 3D printing process, during formation of the 3D object, and/or during formation of a layer of hardened material). The control may be discontinuous. For example, the control may cause the occurrence of a sequence of discrete events. The control scheme may comprise a continuous, discrete, or batch control. The requested setpoint may comprise a temperature, power, power density, or a metrological (e.g., height) setpoint. The metrological setpoint may relate to the target surface (e.g., the exposed surface of the material bed). The metrological setpoints may relate to one or more height setpoints of the target surface (e.g., the exposed (e.g., top) surface of the material bed). The controller(s) may attempt to minimize an error (e.g., temperature and/or metrological error) over time by adjustment of a control variable. The control variable may comprise a direction and/or (electrical) power supplied to any component of the 3D printing apparatus and/or system. For example, direction and/or power supplied to the: energy beam, scanner, motor translating the platform, optical system component, optical diffuser, or any combination thereof.

In some embodiments, the systems, apparatuses, and/or components thereof comprise one or more controllers. The one or more controllers can comprise one or more central processing unit (CPU), input/output (I/O) and/or communications module. The CPU can comprise electronic circuitry that carries out instructions of a computer program by performing basic arithmetic, logical, control and I/O operations specified by the instructions. The controller can comprise a suitable software (e.g., operating system). The control system may optionally include a feedback control loop and/or feed-forward control loop. The controllers may be shared between one or more systems or apparatuses. Each apparatus or system may have its own controller. Two or more systems and/or its components may share a controller. Two or more apparatuses and/or its components may share a controller. The controller may be any controller (e.g., a controller used in 3D printing) such as, for example, the controller disclosed in Provisional Patent Application Ser. No. 62/252,330 that was filed on Nov. 6, 2015, titled “APPARATUSES, SYSTEMS AND METHODS FOR THREE-DIMENSIONAL PRINTING,” or in Provisional Patent Application Ser. No. 62/325,402 that was filed on Apr. 20, 2016, titled “METHODS, SYSTEMS, APPARATUSES, AND SOFTWARE FOR ACCURATE THREE-DIMENSIONAL PRINTING,” or in PCT Patent Application serial number PCT/US16/59781, that was filed on Oct. 31, 2016, titled “ADEPT THREE-DIMENSIONAL PRINTING”, all three of which are incorporated herein by reference in their entirety.

At times, multiple of tuning schemes can be generated for the one or more controllers, each tuning scheme selectable for a set of operating conditions and/or powder characteristics. For example, tuning scheme may utilize (i) a look-up table (LUT), (ii) historical data, (iii) experiments, (iv) physics simulation, (v) artificial intelligence, (vi) data analysis, and/or (vii) the like. The artificial intelligence may comprise training a plant model (a machine-learned model). The artificial intelligence may comprise data analysis. The training model may be trained utilizing (i) a look-up table (LUT), (ii) historical data, (iii) experiments, (iv) synthesized results from physics simulation, or (v) the like. In some embodiments, control scheme(s) can use a single plant model and project changes due to the temperature based at least in part on previously identified models. The control scheme(s) may be inscribed as program instructions (e.g., software).

In some embodiments, the control scheme used the controller(s) disclosed herein involve data analysis. The data analysis techniques involve one or more regression analysis(es) and/or calculation(s). The regression analysis and/or calculation may comprise linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elastic net regression, principal component analysis (PCA), singular value decomposition (SVD)), probability measure techniques (e.g., fuzzy measure theory, Borel measure, Harr measure, risk-neutral measure, Lebesgue measure), predictive modeling techniques (e.g., group method of data handling (GMDH), Naive Bayes classifiers, k-nearest neighbors algorithm (k-NN), support vector machines (SVMs), neural networks, support vector machines, classification and regression trees (CART), random forest, gradient boosting, generalized linear model (GLM)), or any other suitable probability and/or statistical analysis(es). A learning scheme may comprise neural networks. The leaning scheme may comprise machine learning. The learning scheme may comprise pattern recognition. The learning scheme may comprise artificial intelligence, data miming, computational statistics, mathematical optimization, predictive analytics, discrete calculus, or differential geometry. The learning schemes may comprise supervised learning, reinforcement learning, unsupervised learning, semi-supervised learning. The learning scheme may comprise bias-variance decomposition. The learning scheme may comprise decision tree learning, associated rule learning, artificial neural networks, deep learning, inductive logic programming, support vector machines, clustering, Bayesian networks, reinforcement learning, representation learning, similarity and metric learning, sparse dictionary learning, or genetic algorithms (e.g., evolutional algorithm). The non-transitory computer media may comprise any of the algorithms disclosed herein. The controller and/or processor may comprise the non-transitory computer media. The software may comprise any of the algorithms disclosed herein. The controller and/or processor may comprise the software. The learning scheme may comprise random forest scheme.

In some embodiments, the control system utilizes a physics simulation in, e.g., in a computer model (e.g., comprising a prediction model, statistical model, a thermal model, or a thermo-mechanical model). The computer model may provide feedforward information to the control system. The computer model may provide the feed forward control scheme. There may be more than one computer models (e.g., at least 1, 2, 3, 4, 5, 6, 7, 8, 9 or 10 different computer models). The controller may (e.g., dynamically) switch between the computer models to predict and/or estimate the behavior of the optical elements. Dynamic includes changing computer models (e.g., in real time) based at least in part on a sensor input or based at least in part on a controller decision that may in turn be based at least in part on monitored target temperature. The dynamic switch may be performed in real-time, e.g., during operation of the optical system and/or during printing 3D object(s). The controller may be configured (e.g., reconfigured) to include additional one or more computer models and/or readjust the existing one or more computer models. A prediction may be done offline (e.g., predetermined) and/or in real-time. Examples of the calibration, control systems, controllers, and operation thereof, 3D printing systems and processes, apparatus, methods, and computer programs, are disclosed in International Patent Application serial number PCT/US19/14635, filed Jan. 22, 2019, titled “CALIBRATION IN THREE-DIMENSIONAL PRINTING,” which is incorporated herein by reference in its entirety.

In some instances, the processing unit includes one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The close proximity may allow substantial preservation of communication signals that travel between the cores. The close proximity may diminish communication signal degradation. A core as understood herein is a computing component having independent central processing capabilities. The computing system may comprise a multiplicity of cores, which may be disposed on a single computing component. The multiplicity of cores may include two or more independent central processing units. The independent central processing units may constitute a unit that read and execute program instructions. The independent central processing units may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS).

In some instances, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by Nvidia, ATI Technologies, S3 Graphics, Advanced Micro Devices (AMD), or Matrox. The processing unit may be able to process algorithms comprising a matrix or a vector. The core may comprise a complex instruction set computing core (CISC), or reduced instruction set computing (RISC).

In some instances, the computer system includes an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

In some instances, the computer system includes configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration. The FPGA may comprise configurable FPGA logic, and/or fixed-function hardware comprising multipliers, memories, microprocessor cores, first in-first out (FIFO) and/or error correcting code (ECC) logic, digital signal processing (DSP) blocks, peripheral Component interconnect express (PCI Express) controllers, ethernet media access control (MAC) blocks, or high-speed serial transceivers. DSP blocks can be DSP slices.

In some examples, the computing system includes an integrated circuit. The computing system may include an integrated circuit that performs the algorithm (e.g., control algorithm). In some instances, the controller uses calculations, real time measurements, or any combination thereof to regulate the energy beam(s).

In some embodiments, a user develops at least one 3D printing instruction and directs the 3D printer (e.g., through communication with the 3D printer processor) to print in a requested manner according to the developed at least one 3D printing instruction. A user may or may not be able to control (e.g., locally or remotely) the 3D printer controller, e.g., depending on permission preferences. For example, a client may not be able to control the 3D printing controller (e.g., maintenance of the 3D printer).

In some embodiments, the user (e.g., other than a client) processor may use real-time and/or historical 3D printing data of one or more 3D printers. The 3D printing data may comprise metrology data. The user processor may comprise quality control. The quality control may use a statistical method (e.g., statistical process control (SPC)). The user processor may log excursion log, report when a signal deviates from the nominal level, or any combination thereof. The user processor may generate a configurable response. The configurable response may comprise a print/pause/stop command (e.g., automatically) to the 3D printer (e.g., to the 3D printing processor). The configurable response may be based at least in part on a user defined parameter, threshold, or any combination thereof. The configurable response may result in a user defined action. The user processor may control the 3D printing process and ensure that it operates at its full potential. For example, at its full potential, the 3D printing process may make a maximum number of 3D object with a minimum of waste and/or 3D printer down time. The SPC may comprise a control chart, design of experiments, and/or focus on continuous improvement.

In some embodiments, the 3D printing system comprises a control system. The control system may control the manufacturing (e.g., printing) process(es) of the manufacturing system, e.g., of the 3D printer. The control system may comprise a feed forward and/or feedback control scheme, e.g., that has been pre-programmed. The control system may utilize feed forward control scheme, e.g., by predicting a required control action based at least in part on (a) knowledge of the system model and/or (b) the requested setpoint. The knowledge of the system model may comprise (i) a look-up table (LUT), (ii) historical data, (iii) experiments, (iv) physics simulation, (v) artificial intelligence, or (vi) data analysis. In some embodiments, the control system comprises a gas control system, e.g., to facilitate the gas flow of the 3D printing system and/or to control of the one or more characteristics of the gas flow. The one or more characteristics of gas flow may comprise pressure, flow rate, flow acceleration, flow direction, flow homogeneity, gas pressure, gas temperature, or volume of gas flowing in a passage. The gas control system may be configured to control ingress of the gas (e.g., comprising robust gas) into the enclosure and/or egress of the gas (e.g., comprising robust gas) out of the enclosure. The robust gas may comprise less concentration of reactive agent(s) (e.g., oxygen and/or water) compared to an ambient atmosphere. The reactive agent(s) may be capable of reacting with the materials utilized in the 3D printing system. The feed forward control scheme may receive input from one or more sensors, e.g., as disclosed herein. The feed forward control scheme may comprise a computational scheme. In some embodiments, the computational scheme utilizes at least one characteristic of 3D printing. The at least one characteristic of 3D printing may comprise (i) structure of one or more 3D objects formed (e.g., printed) in a forming (e.g., printing) cycle, (ii) structure of the one or more 3D objects as it is being formed (e.g., printed), (iii) the structure of the one or more 3D objects as it is being formed (e.g., printed) and embedded in a material (e.g., powder) bed comprising pre-transformed material (e.g., powder), (iv) a composition of the material (e.g., powder), (v) a morphology of the material (e.g., powder), (vi) a temperature of the material (e.g., powder) bed during forming (e.g., printing), or (vii) any combination thereof.

In some embodiments, at least one of the 3D objects has a structure in which the shape of a specific part of the object is altered (e.g., narrowed and/or widened). The 3D object may comprise an internal cavity. The internal cavity may comprise an opening, e.g., the internal cavity may be an open cavity. The opening may have a volume smaller than the volume of the cavity. The opening may have an area smaller than the circumference of the cavity. In an example, the 3D object has a bottle shape having a narrow opening neck, e.g., a wine bottle. The 3D object having the narrowly opened cavity may be formed (e.g., printed) in a material (e.g., powder) bed. Pressure forming inside the printed 3D object cavity may be different from the pressure in the enclosure environment external to the cavity, e.g., during the forming (e.g., printing) process of the 3D object. For example, the pressure in the enclosure external to the cavity is higher than the pressure inside the cavity of the 3D object disposed in the material bed that is in the enclosure. This pressure difference between the cavity and the enclosure environment external to the cavity may cause starting material (e.g., powder) of the material bed to shift in position during pressure equilibration between the cavity and the enclosure environment external to the cavity. In an example, powder is expelled (e.g., ejected) from the cavity towards the enclosure environment external to the cavity, e.g., when the pressure inside the cavity is higher than the pressure in the enclosure outside of the cavity. In an example, powder is contracted towards the direction of, or into, the cavity, e.g., when the pressure inside the cavity is lower than the pressure in the enclosure outside of the cavity. Such shift in position of the starting material of the material bed may perturb an exposed surface of the material bed, e.g., causing inaccuracies in the printing process. In an example, material expulsion perturbs the planarity of the exposed surface of the material bed. An exposed surface of material bed having (e.g., gross) perturbation to its planarity may compromise the fidelity of the 3D object being printed. Gross perturbation may comprise islands having at least one FLS in the range from about 10 micrometers (□m), 20 □m, or 50 □m; to about 1 millimeter (mm), 5 mm 10 mm, e.g., from about 10 □m to about 10 mm. The control system may comprise a computational scheme that utilizes at least a structure of the 3D object(s) (A) as it is being formed (e.g., printed) in the material bed and/or (B) as it is being embedded in a material (e.g., powder) bed. The control system may predict the pressure difference between the enclosure and the cavity. The control system may control (e.g., regulate such as minimize) the pressure difference and/or the time span of the pressure differential, e.g., to minimize perturbing of the exposed surface of the material bed.

In some embodiments, the control system comprises utilizing historical data in its control scheme. The historical data can be used at least in part to formulate the control scheme and/or update the control scheme. Historical data may comprise data collected before, during and/or after a three-dimensional process performed by 3D printing system in a prior printing cycle. The historical data (e.g., historical measurements) may comprise the at least one characteristic of the 3D object(s) and/or of the 3D printing process(es). In some embodiments, the at least one characteristic of the 3D objects comprises data related to metrology, design, material, and/or to the quality of the 3D object(s). In some embodiments, the at least one characteristic of the 3D printing process(es) comprises data related to the pressure, temperature, position, gas flow, energy beam, printing path, and/or printing speed. The historical data (e.g., historical measurements) can be saved, e.g., as a look-up table (LUT). The historical data may be utilized in a feed forward control system. The historical data may be utilized to control (e.g., to regulate) the printing process. In some embodiments, the historical data is utilized to predict the at least one characteristic of the 3D printing process. In an example, the historical data is utilized to predict a pressure differential forming in the enclosure and/or time span of the pressure differential in the enclosure. In an example, the historical data is utilized to predict the volume of gas to be exchanged (e.g., egress and/or ingress) relative to the enclosure to diminish the pressure differential. In an example, the historical data is utilized to predict the time span required to diminish the pressure differential, e.g., return the pressure to its requested level.

In some embodiments, the control system utilizes the historical data and/or the computational scheme. In some embodiments, a control scheme of the control system comprises combining accumulated historical data (e.g., historical measurements). The historical data may be utilized as data for a learning scheme, e.g., on an ongoing basis as additional historical data become available. The control system may comprise utilizing a learning scheme, e.g., artificial intelligence and/or machine learning. The learning scheme may comprise utilizing the historical data related to the at least one characteristic of the 3D object(s) or 3D printing process(es). The historical data may be utilized to synthesize additional data to be used by the learning scheme. The control system may predict various settings related to the 3D printing process, e.g., relating to the at least one characteristic of the 3D printing process. Predictions of the various settings may be based at least on the historical data and/or the learning scheme. In some embodiments, the control system is utilized to predict (I) the pressure differential forming in the enclosure at a time, (II) volume of gas to be exchanged (e.g., egress and/or ingress) relative to the enclosure to minimize the pressure differential, and/or (III) duration it would take to minimize the pressure differential. The control scheme may be optimized to (A) minimize the pressure differential and/or (B) minimize the duration of the pressure differential. The pressure differential may be a pressure variation (e.g., pressure fluctuation) affected by one or more processes, e.g., two consecutive processes before, during and/or after the formation of the product. The product may comprise a 3D object. The process may comprise 3D printing.

In some embodiments, the 3D printing system comprises a control system. The control system may comprise a feedback control scheme. The feedback control scheme may rely at least in part on input from at least one sensor connected to the control system. The control system may comprise a processing unit. The sensor may be operatively coupled with, or be integrated in, a valve. The control scheme may control the valve. The control scheme may comprise on-off control, proportional control, proportional-integral (PI) control, or proportional-integral-derivative (PID) control. The control system may comprise, or be operatively coupled with, a detection system (e.g., pressure detection system). The control scheme may be configured to receive measurement data from the detection system. Measurement data collected by the detection system may be utilized by one or more controllers, e.g., to provide feedback control signals to one or more control systems. In some embodiments, the measurement data collected by the detection system comprises the pressure value of at least one component of the 3D printing system, e.g., enclosure, gas conveyance system, layer dispensing system, and/or material recycling system. The measurement data may be collected by using at least one sensor e.g., located in or around the component. The read sampling rate of the sensor may depend (e.g., at least in part) on one or more characteristics of a measurement target, the manufactured product (e.g., 3D objects), and/or tolerances requested for the product. The one or more characteristics of a measurement target may comprise a temperature, a pressure, a gas makeup, a gas flow direction, a gas flow velocity, or amount of reactive agent(s). The measurement target may comprise fluids within the 3D printing system. In some embodiments, the measurement target comprises (a) an atmosphere within an enclosure, (b) fluids within a gas conveyance system, or (c) fluids within a gas flow mechanism. In some embodiments, the read sampling rate of the at least one sensor may be at most about 10 millisecond (msec), 20 msec, 30 msec, 50 msec, 70 msec, 100 msec, 150 msec, or less. The read sampling rate of the at least one sensor may comprise any value between the aforementioned values, e.g., from about 10 msec to about 150 msec. The location of the sensor may depend at least in part on the measurement target, measurement method, and/or type of sensor(s). In some embodiments, the sensor(s) that measures the pressure of the enclosure is located in (i) the enclosure, and/or (ii) a segment of the gas conveyance system. The segment of the gas conveyance system may be adjacent to the enclosure. The segment of the gas conveyance system may be gas channel(s) (e.g., pipe(s)) connected (e.g., directly) to the enclosure.

In some embodiments, the control system is configured to generate control signals responsive to the measurement data, e.g., collected by the detection system. The control signals may facilitate regulation of at least one component (e.g., valve, pump, temperature conditioning system, and/or humidity enriching system) to a requested state such as a requested level. In some embodiments, the control system collects the pressure data of the enclosure using at least one sensor, and generates control signals responsive to the pressure data, e.g., to regulate (A) an inlet valve assembly (e.g., inlet valve(s)) and/or (B) an outlet valve assembly (e.g., outlet valve(s)). A valve assembly may comprise the inlet valve assembly or the outlet valve assembly. The valve assembly may comprise a valve, e.g., may comprise several valves. The valve assembly may comprise a proportional valve, discrete valve, or variable valve. In one example, when the control system detects that the pressure inside the enclosure is above a threshold, the control system generates a signal to the outlet valve(s) resulting in egress of the over-pressured gas from the enclosure into a target location. The signal may be directed to a valve, the signal comprising (A) a signal to open the valve(s) for a fixed duration, (B) a signal to increase the degree of opening of the valve, or (C) a signal to increase duration of opening the valve. The target location may be a reservoir or the ambient environment. The reservoir may or may not be part of the manufacturing machine, e.g., 3D printer. In another example, when the control system detects that the pressure inside the enclosure is below a threshold, the control system generates a signal to the inlet valve(s) resulting at least in (a) ingress of (e.g., robust) gas from a gas source into the enclosure and (b) compensating for the under-pressure of the enclosure. The signal may be directed to a valve, the signal comprising (A) a signal to open the valve(s) for a fixed duration, (B) a signal to increase the degree of opening of the valve, or (C) a signal to increase duration of opening the valve. The gas source may be a reservoir or the ambient environment. The reservoir may or may not be part of the manufacturing machine, e.g., 3D printer.

In some embodiments, 3D printing system comprises an enclosure and a gas conveyance system. The gas conveyance system may (e.g., directly or indirectly) couple to the enclosure. The 3D printing system may comprise one or more valve assembly. The valve assembly may be (i) part of the gas conveyance system, or (ii) operatively couplet to the gas conveyance system. The valve assembly may be connected (e.g., directly and/or indirectly) to the enclosure. The valve assembly may comprise at least an inlet valve assembly and an outlet valve assembly. The valve assembly may be controlled by the control system. Each of the inlet and outlet valve assembly may comprise one or more valves. The inlet valve assembly may comprise at least one proportional valve(s). The inlet proportional valve(s) may be linear or non-linear proportional valve. The non-linear proportional valve may require a linearization control scheme (e.g., calibration using a lookup table). The outlet valve assembly may comprise at least one proportional valve(s) and/or discrete valve(s). The number, opening area, and/or type of valves in each of the inlet and outlet valve assembly may depend (e.g., at least in part) on the pressure difference at the locations where the gas is to be exchanged. In some embodiments, the inlet valve assembly may be configured to facilitate ingress of gas from a gas source into the enclosure; and the outlet valve assembly may be configured to facilitate egress of the gas from the enclosure to a target location. The pressure difference across the inlet valve assembly (e.g., the pressure difference between the gas source and the enclosure) may be different (e.g., larger) compared to the pressure difference across the outlet valve assembly (e.g., the pressure difference between the enclosure and the target location). In some embodiments, the number and/or opening area of the outlet valve assembly are larger than those of the inlet valve assembly. In an example, the outlet valve assembly comprises two proportional valves and two discrete valves. In an example, the inlet valve assembly comprises a single proportional valve. Each of the valve assembly may comprise one or more types of valves (e.g., pneumatic valve, servo valve and/or butterfly valve). The servo valve may be operatively coupled with a servo motor, e.g., configured to effectuate closing and/or opening the valve such as reversibly. The response time of the valve (i.e., time taken for the valve to shift its position, e.g., from opening to closure and vice versa) may be at most about 3000 milliseconds (msec), 100 msec, 50 msec, 20 msec, 10 msec, 5 msec, or less. The response time of the valve may comprise any value between the aforementioned value, e.g., from about 5 msec to about 3000 msec, from about 5 msec to about 50 msec, from about 50 msec to about 100 msec, or from about 100 msec to about 3000 msec. Fast response time of the valve(s) may reduce a probability (e.g., prevent) acceleration of material (e.g., powder) from a material bed in the enclosure. Fast response time may hinder (e.g., prevent) disruption to the planarity of an exposed surface of the powder bed. Fast response time may refer to a duration of time shorter than the time required to move (e.g., accelerate) the material (e.g., powder) from the material bed. Fast response time may facilitate (e.g., at least in part enable) altering the pressure in the enclosure to a requested value or within a requested range without the acceleration of the material. Fast response time may vary (e.g., at least in part) according to (i) at least one characteristic of the material in the material bed, and/or (ii) at least one characteristic of an atmosphere of the enclosure. The at least one characteristic of the material may comprise type, temperature, or pressure of the material. The at least one characteristic of the atmosphere of the enclosure may comprise temperature or pressure of the atmosphere. The disruption to the planarity may comprise expulsion, eruption, and/or ejection of the material from the material bed into the atmosphere of the enclosure. The disruptions may comprise the gross perturbation, e.g., as disclosed herein. At least two different types of valves may have a different response time. Different response time may be by at least about 0.5, 1, 2, or 3 orders of magnitude.

In some embodiments, the 3D printing system comprises a control system (e.g., controller). The control system may comprise (e.g., electrical) circuitry that is configured to generate output signals (e.g., voltage signals) for directing one or more aspects of the components (or any parts thereof) described herein. The control system may be programmed or otherwise configured to facilitate formation (e.g., printing) of one or more 3D objects. The controller may comprise an electrical circuitry, or a connection to a power source such as an electrical source. In an example, the controller comprises a connection to electrical power. The controller can comprise a subordinate-controller for controlling formation of one or more 3D objects. The controller may comprise one or more loop schemes (e.g., open loop, feed-forward loop and/or feedback loop). The subordinate-controller may be an internal-controller. The controller (e.g., or subordinate controller) may comprise a PID loop. The subordinate-controller may be a second controller as part of the first controller. The subordinate-controller may be a linear controller. The controller may be configured to control one or more components of the forming tool. The controller may be configured to control in real time during at least a portion of the 3D printing. The controller may be configured to control (i) a transforming agent generator (e.g., an energy source, a dispenser of the binding agent and/or reactive agent), (ii) a guidance mechanism (e.g., scanner and/or actuator), (iii) at least one component of a layer dispenser (e.g., of a pre-transformed material and/or a transforming agent), (iv) at least one component of a gas flow system, or (v) at least one component of a chamber in which the 3D object is formed (e.g., a door, an elevator, a valve, a pump, and/or a sensor). The controller may be configured to control a controllable property comprising: (i) an energy beam power (e.g., delivered to the material bed), (ii) an attribute (e.g., temperature) at a position in the material bed (e.g., on the forming 3D object), (iii) energy beam speed, (iv) energy beam power density, (v) energy beam dwell time, (vi) energy beam irradiation spot (e.g., on the exposed surface of the material bed), (vii) energy beam focus (e.g., focus or defocus), or (viii) energy beam cross-section (e.g., beam waist). The controller may be configured to control a controllable (e.g., binding and/or reactive agent) property comprising: (i) strength (e.g., reaction rate), (ii) volume (e.g., delivered to the material bed), (iii) density (e.g., on a location of the material bed), or (iv) dwell time (e.g., on the material bed). The controllable property may be a control variable. The control may be to maintain a target parameter (e.g., temperature and/or pressure) of one or more 3D objects being formed. The target parameter may be a setpoint of an attribute. The target parameter may vary in time (e.g., in real time) and/or in location (e.g., exposed surface of the material bed, or top surface of the (e.g., forming) 3D object). The target parameter may correlate to the controllable property. The subordinate-controller may receive a pre-determined attribute setpoint. The target parameter may comprise forming instructions. Forming instructions may be (e.g., optionally) modified by a sub-controller to generate a control variable plan (e.g., that is executed by the controller). The subordinate-controller may receive a target parameter (e.g., temperature and/or pressure) to maintain at least one characteristic of the forming 3D object (e.g., dimension in a direction). The controller can receive multiple types of target inputs. Any of the target inputs may be user defined. Some of the target values may be used to form 3D forming instructions for generating the 3D object. The forming instructions may be dynamically adjusted in real time. The controller may monitor (e.g., continuously) one or more signals from one or more sensors for providing feedback signals. For example, the controller may monitor the energy beam power, attribute (e.g., temperature, pressure, wavelength, or reflectivity) of a position in the material bed, and/or metrology (e.g., height) of a position on the target surface (e.g., exposed surface of a material bed, or top surface of the (e.g., forming) 3D object). The monitor may be continuous or discontinuous. A variation between the target parameter and the sensed parameter may be used to estimate an error in the value of that parameter. The variation (e.g., error) may be used by the subordinate-controller to adjust the forming instructions. The controller may control (e.g., continuously) one or more parameters (e.g., in real time). The controller may provide feed forward signals, e.g., by using historical data (e.g., for the parameters). The historical data may be of previously printed 3D objects, or of previously printed layers of the 3D object. Configured may comprise built, constructed, designed, patterned, or arranged. The hardware of the controller may comprise a predictor model. The predictor model may comprise linear or non-linear modes. The predictor model may comprise free parameters which may be estimated using a characterization process. The characterization process may be before, during and/or after the 3D printing. The predictor model may be wired to the controller. The predictor model can be configured into the controller (e.g., before and/or during the 3D printing).

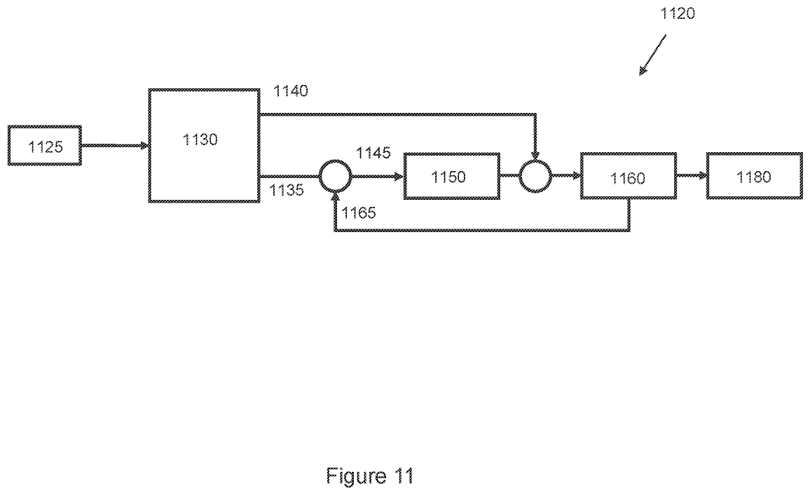

FIG. 11 shows a schematic example of a controller (e.g., a control system) 1120 that is programmed or configured to facilitate formation 1180 of one or more 3D objects. The controller 1120 comprises forming instructions 1125. The controller 1120 provides the instructions 1125 to sub-controller 1130. The sub-controller 1130 provides a target parameter 1135 to subordinate-controller 1150. One or more sensors 1160 provides sensed parameter to the subordinate-controller 1150 by feedback control loop 1165. A variation 1145 between the target parameter 1135 and the sensed parameter 1165 is provided to the subordinate-controller 1150. The controller 1120 comprises a feed forward control loop 1140. The formation 1180 of the one or more 3D objects may (e.g., at least in part) consider the variation 1145 and data provided by feed forward control loop 1140.

In some embodiments, 3D printing system comprises control system. The control system may comprise control scheme(s) (e.g., control loop(s)). For example, the control system may be configured to execute the control scheme(s). The control system may comprise a feed forward control loop and/or feedback control loop. The control system may comprise at least one controller. The at least one controller may comprise input controller, output controller, I/O controller, or processor controller. The controller may operatively couple to one or more components of the 3D printing system. In some embodiments, the controller operatively couples with input component(s) (e.g., sensor(s)) and/or output component(s) (e.g., valve(s), pump(s), or gas source(s)). The controller may receive signals from the input component(s) and execute, of direct execution of, one or more operations to the output component(s). The control system may comprise regulating at least one characteristic of an atmosphere in an enclosure and/or in the reservoir. The at least one characteristic of the atmosphere can comprise pressure, flow rate, flow direction, velocity, acceleration, temperature, composition, volume, or humidity. In some embodiments, the control scheme comprises regulating pressure fluctuation of the atmosphere in an enclosure. Sensors may be located in and/or adjacent to the enclosure and/or reservoir. Regulating at least one characteristic of the atmosphere may comprise considering the signals received from the input component(s), e.g., sensor input. The controller may direct at least one output component to facilitate (e.g., assist at least in part) regulating the at least one characteristic of the atmosphere in the enclosure and/or reservoir. In some embodiment, the controller directs valve(s), pump(s), and/or gas reservoir(s) to assist the exchange of gas with respect to the enclosure and/or reservoir.

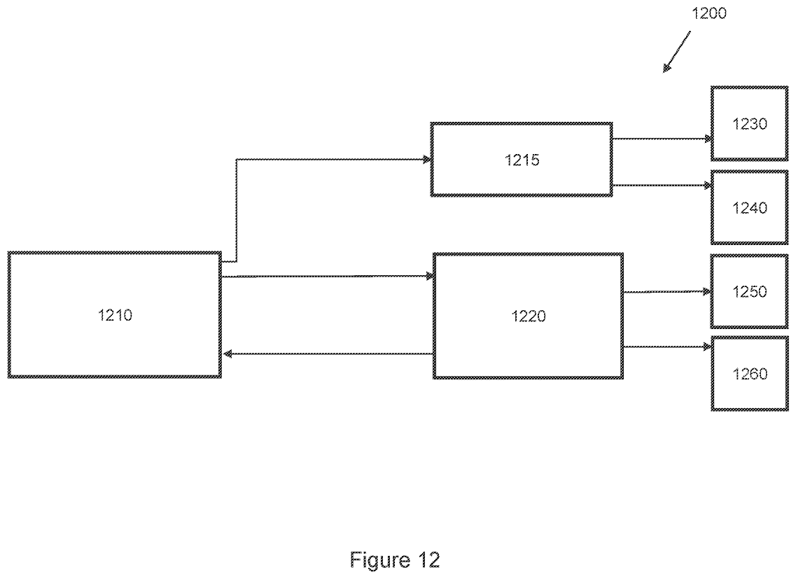

FIG. 12 shows a schematic example of control system 1200. The control system 1200 comprises control loop 1210 (e.g., comprising feed forward loop and/or feedback loop). The control loop 1210 communicates with a first controller 1215 and a second controller 1220. The first controller 1215 is an output controller; and the second controller 1220 is an I/O controller. The first controller 1215 is operatively coupled with one or more output components (e.g., discrete valves 1230 and 1240). The second controller 1220 is operatively coupled with one or more output components (e.g., proportional valves 1250 and 1260), and one or more input components (e.g., sensor(s) not shown in FIG. 12). The second controller 1220 may receive signals from one or more input components (e.g., sensor(s)). The second controller 1220 transmits the signals to control loop 1210. The control loop 1210 transmits instructions to the first controller 1215 and the second controller 1220 based (e.g., at least in part) on the signals from the one or more sensors. The first controller 1215 controls the one or more output components (e.g., discrete valves 1230 and 1240) based (e.g., at least in part) on the instructions. The second controller 1220 controls the one or more output components (e.g., proportional valves 1250 and 1260) based (e.g., at least in part) on the instructions.

In some embodiments, the 3D printing system comprises a control system. The control system may comprise a control system. The control system may comprise input component(s) (e.g., sensor(s)), external device(s), or output component(s). The input component(s) (e.g., sensor(s)), external device(s), and/or output component(s) may operatively couple to the controller. The controller may receive input signals from the input component(s). The input signals may be continuous real-time data from sensors, measuring components, or other systems. The input component(s) may (e.g., optionally) convert the input signals into a digital data format. In some embodiments, the controller is connected to a pressure sensor disposed in or adjacent to an enclosure. The pressure sensor may detect the pressure of the enclosure. The pressure sensor may convert pressure data into a digital data format. The converted data may be provided to the controller. The controller may process the converted data. The controller may communicate with the external device(s), e.g., personal computer. The controller may send data to the external devices(s). The controller may receive data (e.g., control commands) from the external device(s), e.g., through communication protocols. The controller may transmit output signals (e.g., instructions) to the output components(s). The output signals may depend (e.g., at least in part) on the data from the input component(s) and/or external device(s). The output signals may be (i) analog output signals (e.g., having continuous values), and/or (ii) discrete output signals (e.g., having discrete values). In some embodiments, the output component(s) comprise valve(s). The valves may comprise proportional valves or discrete valves. The controller may provide analog output signals to the proportional valves. The controller may provide discrete output signals to the discrete valves. The control system may comprise control components (e.g., electronic control components). At least a portion of the output component(s) may be controlled by the control components. In some embodiments, the controller transmits signals to the (e.g., electronic) control components. The (e.g., electronic) control components may transmit (e.g., electronic) signals to the output components. The control components may comprise driver or valve. In some embodiments, the control components (e.g., a solenoid driver and a solenoid valve) are operatively coupled with the output component (e.g., a discrete valve). The solenoid driver may control (e.g., open and/or close) the solenoid valve, e.g., that operates with gas pressure. The opening/closing of the solenoid valve may control the gas flow and change the state of the discrete valve. In some embodiments, the output components (e.g., proportional valves and discrete valves) constitute an outlet valve assembly. The outlet valve assembly may be a part of, or connected to, a gas conveyance system. The outlet valve assembly may operatively couple to the enclosure. When the controller determines an over-pressure in the enclosure (e.g., by receiving input signals from input components and/or receiving control commands from external devices), the controller may control at least one of the output components of the outlet valve assembly to be opened, or increase the degree of opening, and relieve the over-pressure of the enclosure.

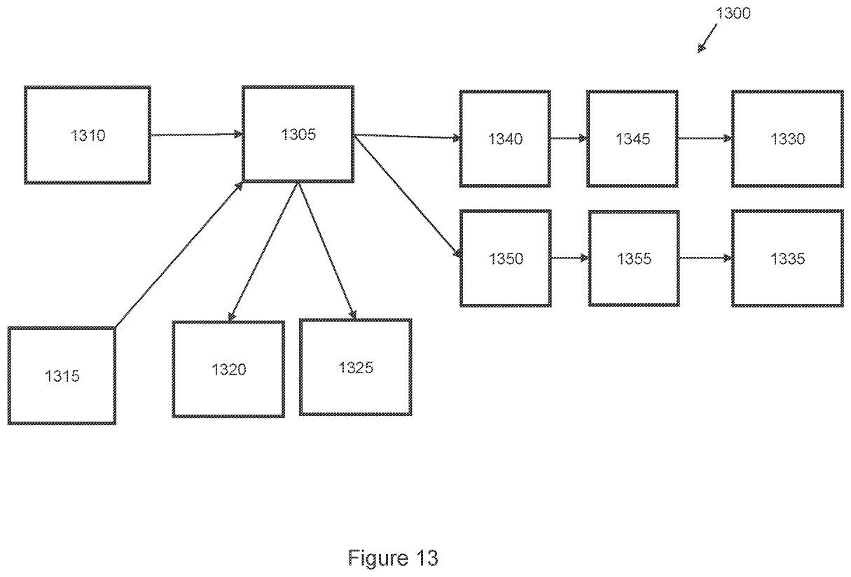

FIG. 13 shows a schematic example of control system 1300. The control system 1300 comprises an I/O controller 1305. The controller 1305 is operatively coupled with an input component 1310, an external device 1315, and output components 1320, 1325, 1330 and 1335. The controller 1305 receives input signals from the input component 1310. The controller 1305 is operatively coupled with the external device 1315. The controller 1305 is operatively coupled with the output components 1320, 1325, 1330 and 1335. The controller 1305 transmits output signals to the output components 1320, 1325, 1330 and 1335. The control system 1300 comprises control components 1340, 1345, 1350, and 1355. Output component 1330 is controlled (e.g., at least in part) by the control components 1340 and 1345. Output component 1335 is controlled (e.g., at least in part) by the control components 1350 and 1355.

In some embodiments, the 3D printing system comprises a computer system. The computer system can control (e.g., direct, monitor, and/or regulate) various features of printing methods, apparatuses and systems of the present disclosure, such as, for example, control force, translation, heating, cooling and/or maintaining the temperature of a powder bed, process parameters (e.g., chamber pressure), scanning rate (e.g., of the energy beam and/or the platform), scanning route of the energy source, position and/or temperature of the cooling member(s), application of the amount of energy emitted to a selected location, or any combination thereof. The computer system can be part of, or be in communication with, a 3D printing system or apparatus. The computer may be coupled with one or more mechanisms disclosed herein, and/or any parts thereof. For example, the computer may be coupled with one or more sensors, valves, switches, motors, pumps, scanners, optical components, or any combination thereof.

In some embodiments, the computer system utilizes program instructions to execute, or direct execution of, operation(s). The program instructions can be inscribed in a machine executable code. Methods as described herein can be implemented by way of machine (e.g., computer processor) executable code stored on an electronic storage location of the computer system, such as, for example, on the memory, or electronic storage unit. The machine executable or machine-readable code can be provided in the form of software. During use, the processor can execute the code. In some cases, the code can be retrieved from the storage unit and stored on the memory for ready access by the processor. In some situations, the electronic storage unit can be precluded, and machine-executable instructions are stored on memory. The code can be pre-compiled and configured for use with a machine having a processer adapted to execute the code or can be compiled during runtime. The code can be supplied in a programming language that can be selected to enable the code to execute in a pre-compiled or as-compiled fashion.

In some embodiments, the computer system comprises a memory. The memory may comprise a random-access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complemented to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

In some embodiments, the computer system comprises an electronic storage unit. The electronic storage unit can be a data storage unit (or data repository) for storing data. In some embodiments, the storage unit stores files, such as drivers, libraries, and saved programs. The storage unit can store user data (e.g., user preferences and user programs). In some cases, the computer system can include one or more additional data storage units that are external to the computer system, such as located on a remote server that is in communication with the computer system through the network (e.g., an intranet or the Internet).

Aspects of the systems, apparatuses, and/or methods provided herein, such as the computer system, can be embodied in programming (e.g., using a software). Various aspects of the technology may be thought of as “product,” “object,” or “articles of manufacture” typically in the form of machine (or processor) executable code and/or associated data that is carried on or embodied in a type of machine-readable medium. Machine-executable code can be stored on the electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

In some embodiments, the computer system may comprise a processor or a plurality of processors. The processor may be a processing unit. The processing unit may include one or more processing units. The processor (e.g., 3D printer processor) may be programmed to implement methods of the disclosure. The processing unit can execute a sequence of machine-readable instructions, which can be embodied in a program or software. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system can be included in the circuit.

The processor may be configured to process control protocols, e.g., communicate with one or more components of the 3D printer system using the control protocols. Control protocols can be one or more of the internet protocol suite, e.g., transmission control protocol (TCP) or transmission control protocol/internet protocol (TCP/IP). Control protocols can be one or more of serial communication protocols. Control protocols can be one or more of controller area networks or another message-based protocol, e.g., for communication with microcontrollers and devices. Control protocols can interface with one or more serial bus interfaces for communication with the 3D printing system and its components. The control protocol can be any control protocol disclosed herein.

In some embodiments, the plurality of processors may form a network architecture. At least two of the plurality of the 3D printer processors may interact with each other. In some embodiments, a 3D printer processor interacts with at least one processor that acts as a 3D printer interface (also referred to herein as “machine interface processor”). The one or more machine interface processors may be connected to at least one 3D printer processor. The connection may be through a wire (e.g., cable) and/or be wireless (e.g., via Bluetooth technology). In some embodiments, the machine interface processor directs 3D print job production, 3D printer management, 3D printer monitoring, or any combination thereof.

The computer system can be operatively coupled with a computer network (“network”), e.g., with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled with the computer system to behave as a client or a server.

In some embodiments, the 3D printer comprises communicating through the network. The computer system can communicate with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

In some instances, all or portions of the software are at times communicated through the Internet and/or other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium or media that participate(s) in providing instructions to a processor for execution.

In some embodiments, the 3D printer comprises a communication technology. The communication may comprise wired or wireless communication. For example, the systems, apparatuses, and/or parts thereof may comprise Bluetooth, wi-fi, or global positioning system (GPS), or radio-frequency (RF) technology. The RF technology may comprise ultrawideband (UWB) technology. Systems, apparatuses, and/or parts thereof may comprise a communication port. The communication port may be a serial port or a parallel port. The communication port may be a Universal Serial Bus port (e.g., USB). The systems, apparatuses, and/or parts thereof may comprise USB ports. The USB can be micro or mini-USB. The surface identification mechanism may comprise a plug and/or a socket (e.g., electrical, AC power, DC power). The systems, apparatuses, and/or parts thereof may comprise an electrical adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least about 10, 15, 18, 20, 22, 24, 26, 28, 30, 40, 42, 45, 50, 55, 80, or 100 pins.

In some instances, the system and/or apparatus described herein (e.g., controller) and/or any of their components comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen.

In some instances, the computer system comprises an electronic display. The computer system can include or be in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms (e.g., from the one or more sensors). The control may rely on historical data. The feedback mechanism may be pre-programmed. The feedback mechanisms may rely on input from sensors (described herein) that are connected to the control unit (i.e., control system or control mechanism e.g., computer) and/or processing unit. The computer system may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output (e.g., display) various parameters of the 3D printing system (as described herein) in real time or in a delayed time. The output unit may output the current 3D printed object (e.g., real time display of the 3D object as it is being printed), the requested 3D printed object (e.g., according to a model), the printed 3D object or any combination thereof. The output unit may output the cleaning progress of the object, or various aspects thereof. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may display the amount of a certain gas in the chamber. The output unit may output the amount of oxidizing gas (e.g., oxygen), hydrogen, water vapor, or any of the gases mentioned herein, and pressure in the printing chamber (i.e., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as optionally output by the output unit.

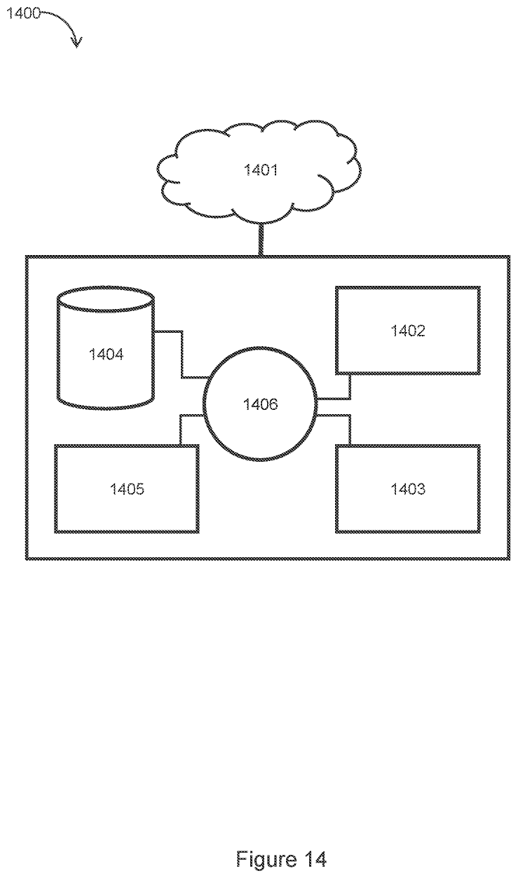

FIG. 14 is a schematic example of a computer system 1400 that is programmed or otherwise configured to facilitate the formation of a 3D object according to the methods provided herein. The computer system 1400 can include a processing unit 1406 (also “processor,” “computer” and “computer processor” used herein). The computer system may include memory or memory location 1402 (e.g., random-access memory, read-only memory, flash memory), electronic storage unit 1404 (e.g., hard disk), communication interface 1403 (e.g., network adapter) for communicating with one or more other systems, and peripheral devices 1405, such as cache, other memory, data storage and/or electronic display adapters. The memory 1402, storage unit 1404, interface 1403, and peripheral devices 1405 are in communication with the processing unit 1406 through a communication bus (solid lines), such as a motherboard.

In some embodiments, the 3D printing system comprises the enclosure and the gas conveyance system comprising the inlet valve assembly and the outlet valve assembly. The inlet valve assembly may be configured to facilitate the ingress of gas from a gas source into the enclosure, e.g., to compensate for the under-pressure and/or overpressure in the enclosure, e.g., during manufacturing such as during 3D printing. The gas source may be (i) an ingress pressure reservoir, (ii) a compressor (e.g., pump), (iii) portion of the gas conveyance system, or (iv) any combination of (i) to (iii). The outlet valve assembly may be configured to facilitate the egress of the gas from the enclosure to a target location, e.g., to alleviate the over-pressure in the enclosure. The target location may be (I) ambient environment, (II) an egress pressure reservoir, (III) the portion of the gas conveyance system, or (IV) any combination of (I) to (III). The gas conveyance system may comprise one or more restrictions. The one or more restrictions may comprise valve(s) (e.g., the inlet valve assembly), the compressor (e.g., pump), or the pressure reservoir(s). The portion of the gas conveyance system may comprise a portion between the restrictions of the gas conveyance system. In some embodiments, the portion of the gas conveyance system comprises (a) reservoir (e.g., gas channel(s)) from a valve (e.g., located adjacent to the enclosure) to the compressor (e.g., pump), (b) reservoir (e.g., gas channel(s)) from a first valve (e.g., located adjacent to the enclosure) and to a second valve (e.g., located adjacent to the compressor), or (c) reservoir (e.g., gas channel(s)) from a variable valve (e.g., butterfly valve located adjacent to the enclosure) to the compressor (e.g., pump). The reservoir may comprise a channel of the gas conveyance system. The valve located adjacent to the enclosure may be located upstream of the enclosure based at least in part on the direction of the gas flow. The portion of the gas conveyance system may comprise (i) the portion between the restrictions of gas conveyance system or (ii) at least one pressure reservoir operatively coupled with one or more components of the gas conveyance system. The one or more components of the gas conveyance system may comprise gas channel(s), valve(s), compressor(s) or restriction(s) of the gas conveyance system. The one or more components of the gas conveyance system may be associated at least in part with dynamic pneumatic loop(s), e.g., included in a material recycling system, and/or a material removing mechanism. In some embodiment, the content of the material recycling system is dynamic and affects (e.g., changes) the pressure of at least the one or more components of the gas conveyance system. The pressure reservoir may operatively be coupled with the one or more components of the gas conveyance system and assist at least in part in equilibrating the gas pressure in at least a portion of the gas conveyance system and the enclosure.

In some embodiments, the manufacturing system comprises a control process of forming at least one product. For example, the 3D printing system comprises a control process for printing one or more 3D objects. The control process may be related to an attribute of the 3D objects (e.g., dimensions) and/or printing process, e.g., temperature, pressure, gas flow, optics, and/or atmosphere. In some embodiments, the control process is configured to maintain an attribute of the forming process to a target parameter. The 3D printing system may comprise estimating a fluctuation (e.g., variation) of the attribute, determining if the fluctuation is within tolerance, or controlling the parameter to stay within the tolerance. The controlling may comprise regulating one or more components of the 3D printing system. The controlling may be repeated until the parameter falls within the tolerance. The attribute may comprise pressure, temperature, gas makeup, concentration (e.g., amount) of reactive agent(s), gas flow velocity, gas flow direction, extent of gas flow laminarity (e.g., or conversely, extent of gas flow turbulence), or gas flow acceleration. The pressure fluctuation may be a pressure variation (e.g., pressure differential) affected by one or more processes, e.g., two consecutive processes before, during and/or after the formation of the object. The control system may predict a value of the attribute in the next process, and estimate the fluctuation (e.g., variation) in the attribute. Estimating the pressure fluctuation may be performed by control system. The control system may comprise a feed forward control loop and/or feedback control loop. The control system may estimate the fluctuation in the attribute by utilizing a feed forward control loop. The feed forward control loop may comprise estimating the pressure fluctuation in the enclosure during the formation (e.g., printing). Estimating the pressure fluctuations may comprise considering (i) at least one characteristic of the one or more 3D objects printed in a printing cycle and/or (ii) at least one characteristic of a material bed in which the one or more 3D objects are printed in the printing cycle. The at least one characteristic of the one or more 3D objects may comprise (i) structure of the 3D object(s) printed in a printing cycle, (ii) structure of the 3d object(s) as it is being printed, or (iii) structure of the 3D object(s) as it is being printed and embedded in a powder bed comprising pre-transformed material. The at least one characteristic of a material bed may comprise (i) material composition of the material, (ii) morphology of the material, or (iii) temperature of the material bed during the printing. The feed forward control loop may be configured to utilize a computational scheme and/or historical data. The control system may comprise a feedback control loop. The control system may adjust the estimated fluctuation by obtaining measurement data, e.g., from sensor(s). The control system may sense an actual value of the attribute, and calculate the actual fluctuation (e.g., variation) in the attribute. The 3D printing system may comprise determining whether the fluctuation (e.g., estimated fluctuation and/or actual fluctuation) is within a tolerance. The tolerance may be a predetermined value or a predetermined range of the attribute. The control system (e.g., controller) may be configured to determine whether the fluctuation is within the tolerance. When the control system (e.g., controller) determines the fluctuation is within the tolerance, the control system may transmit instructions (e.g., commands) of performing the next step (e.g., forming one or more 3D objects). When the control system (e.g., controller) determines the pressure fluctuation is outside the pressure tolerance, the control system may control the one or more components of 3D printing system to make the fluctuation in the attribute fall within the tolerance. The control system may transmit instructions (e.g., commands) to one or more components to regulate the attribute value. Controlling of one or more components of 3D printing system may be performed once or multiple times. In some embodiments, the regulation is repeated until the pressure fluctuation falls within the pressure tolerance. The regulated components may be same or different in each of the regulating instances and/or processes. In some embodiments, when the 3D printing system determines the pressure of the enclosure is above a threshold pressure, the 3D printing system transmits instructions to one or more components of the 3D printing system. The one or more components of 3D printing system may be an outlet valve (e.g., connected to an ambient atmosphere or to the reservoir), a compressor, and/or gas reservoir(s). The gas reservoir may be at least a portion of the gas conveyance system. The gas reservoir may comprise a pressure reservoir. In some embodiments, when the 3D printing system determines the pressure of the enclosure is below a threshold pressure, the 3D printing system transmits instructions to one or more components of the 3D printing system. The one or more components of 3D printing system may be an inlet valve or a gas source(s). The gas source may comprise a gas reservoir. The gas reservoir may comprise a compressed gas source, e.g., a gas cylinder. The gas reservoir may be at least a portion of the gas conveyance system. The gas reservoir may comprise a pressure reservoir.

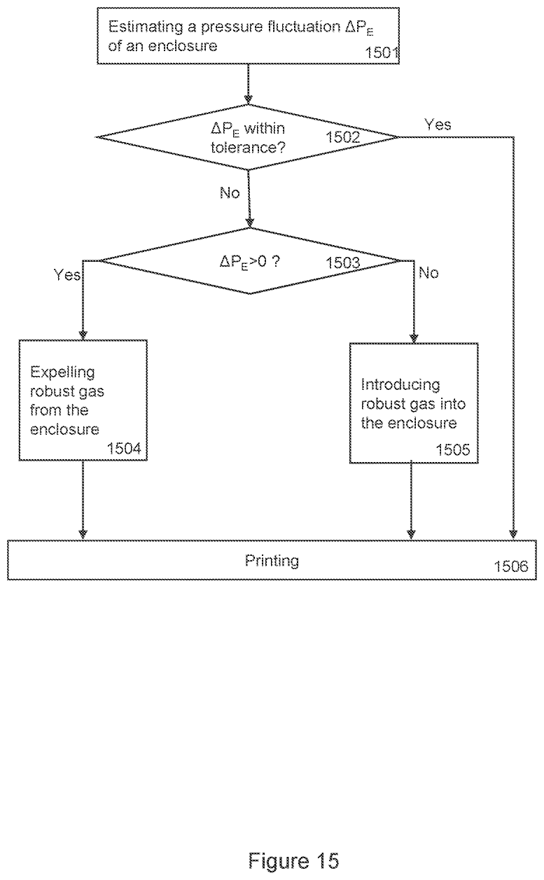

FIG. 15 shows an example flowchart of 3D printing process performed by a 3D printing system, e.g., comprising at least one controller. In block 1501, estimating a pressure fluctuation ΔPE of an enclosure. The pressure fluctuation ΔPE is pressure variation between two processes, e.g., two consecutive processes before and/or during the formation of one or more 3D objects. In block 1502, determining whether the pressure fluctuation ΔPE is within a pressure tolerance. When the pressure fluctuation ΔPE is within the pressure tolerance, printing one or more 3D objects in block 1506. In block 1503, when the pressure fluctuation ΔPE is outside the pressure tolerance, determining the sign of the pressure fluctuation ΔPE e.g., whether the pressure fluctuation value is positive or negative. When the pressure fluctuation ΔPE is positive, expelling gas (e.g., internal gas) from the enclosure in block 1504. When the pressure fluctuation ΔPE is negative, introducing gas (e.g., comprising robust gas) into the enclosure in block 1505. When the pressure fluctuation ΔPE falls within the pressure tolerance by the egress and/or ingress of gas relative to the enclosure, printing one or more 3D objects in block 1506. The pressure related values may be determined at least in part by the controller(s) of the 3D printing system. The operations may be executed, or directed, by the controller(s).

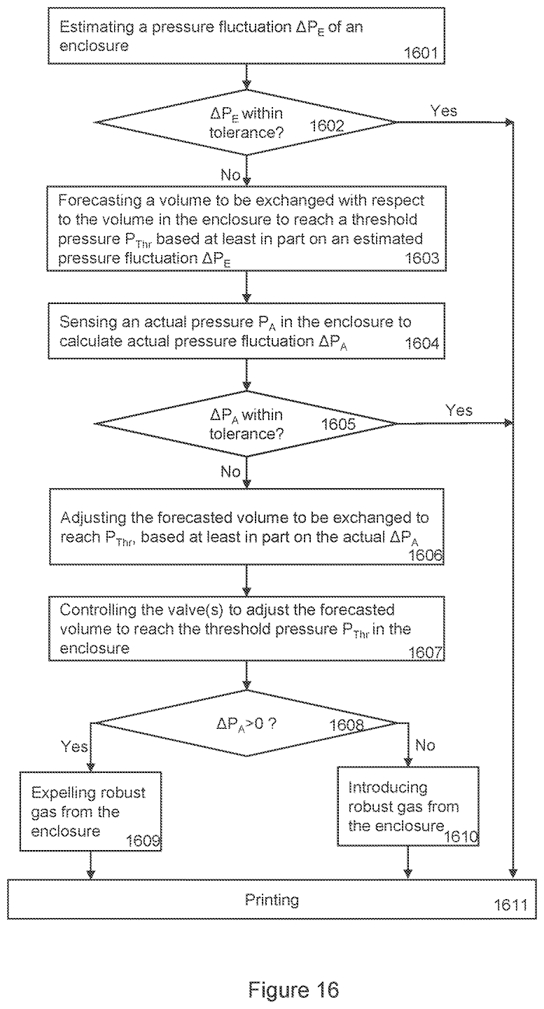

FIG. 16 shows an example flowchart of a portion of a 3D printing process, e.g., as performed by at least one controller thereof. In block 1601, estimating a pressure fluctuation ΔPE of an enclosure. The estimated pressure fluctuation ΔPE is pressure variation between two processes, e.g., two consecutive processes before and/or during the formation of one or more 3D objects. In block 1602, determining whether the estimated pressure fluctuation ΔPE is within a pressure tolerance (e.g., within allowed pressure range). When the estimated pressure fluctuation ΔPE is within the pressure tolerance, directing performance of the next process, e.g., printing one or more 3D objects, in block 1611. When the estimated pressure fluctuation ΔPE is outside the pressure tolerance, forecasting a volume to be exchanged (e.g., egress and/or ingress) with respect to the enclosure to reach a threshold pressure PThr in block 1603. In block 1603, the forecasting may be based at least in part on the estimated pressure fluctuation ΔPE. In block 1604, sensing an actual pressure PA in the enclosure to calculate the actual pressure fluctuation ΔPA, e.g., by using feedback control. In block 1605, determining whether the actual pressure fluctuation ΔPA is within a pressure tolerance. When the 3D printing system (e.g., control system or controller) determines the actual pressure fluctuation ΔPA is within the pressure tolerance, the 3D printing system performs the next process, e.g., printing one or more 3D objects in block 1611. When the actual pressure fluctuation ΔPA is outside the pressure tolerance, adjusting the forecasted volume to be exchanged to reach the threshold pressure PThr in block 1606. The adjustment of the forecasted volume may be based at least in part on the actual pressure fluctuation ΔPA. In block 1607, controlling one or more components (e.g., valve(s)) to adjust the forecasted volume to reach the threshold pressure PThr in the enclosure. In block 1608, determining the sign of the actual pressure fluctuation ΔPA, i.e., whether the pressure fluctuation value is positive or negative. In block 1609, when the actual pressure fluctuation ΔPA is positive: expelling gas (e.g., internal gas) from the enclosure in. In block 1610, when the actual pressure fluctuation ΔPA is negative: introducing gas (e.g., comprising robust gas) into the enclosure. The pressure fluctuation can fall within the pressure tolerance (e.g., reach a threshold pressure PThr) at least in part by the egress and/or ingress of gas relative to the enclosure. In block 1611, preforming the next process, e.g., printing one or more 3D objects. The pressure related values may be determined at least in part by the controller(s) of the 3D printing system. The operations may be executed, or directed, by the controller(s).

In some embodiments, (unwanted) pressure differentials occur during the manufacturing process. The pressure differentials may occur when the layer dispensing mechanism operates. In an example, the pressure differentials maximize when the remover of the layer dispensing mechanism is operational, such as beginning to be (i) cleared of the material (e.g., powder), and/or (ii) loaded with the material (e.g., powder). When the remover is being cleared of the material, the pressure of the enclosure may drop, e.g., the pressure fluctuation of the enclosure may be negative. When the remover is loaded with the material, the pressure of the enclosure may increase, e.g., the pressure fluctuation of the enclosure may be positive. In some embodiments, it is requested to curtail such unwanted pressure differentials. To curtail the pressure differentials, a first control scheme may be utilized. The first control scheme may comprise (a) introducing gas into the enclosure from a gas source or (b) expelling gas out of the enclosure to the ambient atmosphere. The gas may comprise robust gas. The gas source may comprise a first reservoir (e.g., cylinder). The first reservoir may be external to the manufacturing system. The first pressure control scheme may be more adequate (e.g., quick and/or economical) when the volume required to be exchanged is relatively small, e.g., in manufacturing systems having a smaller volume of enclosure. The smaller volume of the enclosure may be at most about 200 liters (L), 300 L, 350 L, 400 L, 500 L, or 550 L. The enclosure may have a volume between any of the afore-mentioned volumes, e.g., from about 200 L to about 550 L. The enclosure may comprise the processing chamber or the build module, e.g., the processing chamber and the build module. To curtail the pressure differentials, a second control scheme may be utilized. The second control scheme may comprise (A) introducing the gas may be into the enclosure from a second reservoir gas or (B) expelling the gas out of the enclosure to the second reservoir. The second reservoir may be internal to the manufacturing system, or external to the manufacturing system. In the second reservoir, the robust gas may or may not be recycled. The second reservoir may be part of, or may be operatively coupled with, a gas recycling system. The second pressure control scheme may be more adequate (e.g., allow for quicker pressure stabilization and/or more economical) when the volume required to be exchanged is relatively large, e.g., in the manufacturing systems having a larger volume of enclosure. The larger volume of the enclosure may be at least about 600 liters (L), 700 L, 750 L, 800 L, 850 L, 900 L, or 1000 L. 3000 L, 3500 L, 4000 L, 5000 L, 6000 L, or 8000 L. The larger volume of the enclosure may have a volume between any of the afore-mentioned volumes, e.g., from about 600 L to about 8000 L, from about 600 L to about 1000 L, from about 1000 L to about 8000 L, or from about 3000 L to about 8000 L. The enclosure may comprise the processing chamber or the build module, e.g., the processing chamber and the build module. The processing chamber may have a larger volume of at least about 600 liters (L), 700 L, 750 L, 800 L, 850 L, 900 L, or 1000 L. The processing chamber may have a volume between any of the afore-mentioned volumes, e.g., from about 600 L to about 1000 L. The reservoir may comprise a portion (e.g., channels) of the gas conveyance system of the manufacturing system. In some embodiments, a manufacturing system comprises a plurality of gas sources and target locations. The plurality of gas sources may comprise (i) an ambient atmosphere, (ii) pressure reservoir, (iii) a compressor (e.g., pump), or (iv) a portion of gas conveyance system. The plurality of target locations may comprise (i) an ambient atmosphere, (ii) pressure reservoir, or (iii) a portion of gas conveyance system. The manufacturing system may switch the gas source and/or the target location during the printing (e.g., between each printing cycle). The switching may be performed (e.g., at least in part) by considering the capacity of the gas source and/or target location. The capacity may comprise volume or pressure. In some embodiments, the volume of the portion of the gas conveyance system is at least about 60 liters (L), 70 L, 74 L, 80 L, 90 L, or 100 L. The portion of the gas conveyance system may have a volume between any of the afore-mentioned volumes, e.g., from about 60 L to about 100 L. The maximum pressure of the portion of the gas conveyance system may be at most about 20 kilo-Pascals (kPa), 30 kPa, 35 kPa, 40 kPa, 50 kPa, 60 kPa, or 70 kPa. The portion of the gas conveyance system may have a maximum pressure between any of the afore-mentioned pressure values, e.g., from abut 20 kPa to about 70 kPa.

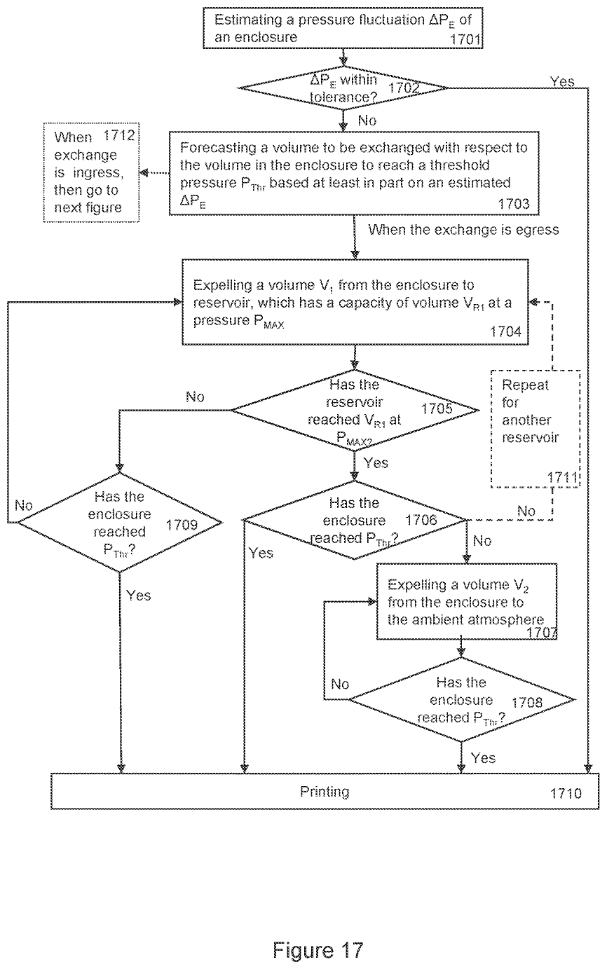

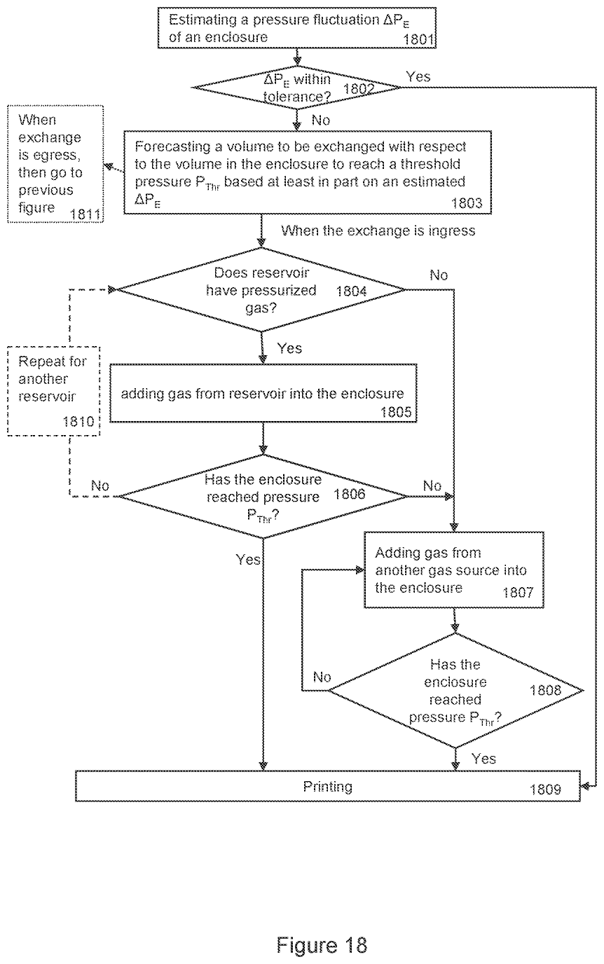

FIG. 17 shows an example flowchart of 3D printing process. The 3D printing process comprises relieving overpressure of an enclosure. In block 1701, estimating a pressure fluctuation ΔPE of an enclosure. In block 1702, determining whether the estimated pressure fluctuation ΔPE is within a pressure tolerance. In block 1710, when the 3D printing system (e.g., control system or controller) determines the estimated pressure fluctuation ΔPE is within the pressure tolerance, printing one or more 3D objects. In block 1703, when the 3D printing system (e.g., control system or controller) determines the estimated pressure fluctuation ΔPE is outside the pressure tolerance (e.g., above a threshold pressure PThr), the 3D printing system performs forecasting a volume to be exchanged (e.g., ingress or egress) with respect to the enclosure to reach the threshold pressure PThr. In block 1703, forecasting may be based (e.g., at least in part) on the estimated pressure fluctuation ΔPE. In block 1712 (e.g., described in FIG. 18), when the exchange is ingress, the 3D printing system instructs performing processes. In block 1703, when the exchange is egress, the 3D printing process performs expelling (e.g., egress) a volume V1 of gas (e.g., internal gas) from the enclosure to a target place (e.g., a reservoir). In block 1705, determining whether the reservoir has reached its maximum capacity, e.g., maximum volume VR1 at a maximum pressure PMAX, with the reservoir having a maximum capacity of maximum volume VR1 at a maximum pressure PMAX. In block 1709, when the 3D printing system (e.g., control system or controller) determines the reservoir has not reached its maximum capacity, determining whether the enclosure has reached the threshold pressure PThr. When the enclosure has not reached the threshold pressure PThr, repeating expelling the volume V1 of gas from the enclosure to the reservoir in block 1704. When the enclosure reached the threshold pressure PThr, printing one or more 3D objects in block 1710. When the reservoir reached its maximum capacity, determining whether the enclosure has reached the threshold pressure PThr in block 1706. When the enclosure reached the threshold pressure PThr, printing one or more 3D objects in block 1710. When the enclosure has not reached the threshold pressure PThr, (i) expelling (e.g., egressing) a volume V2 of gas from the enclosure to a target place (e.g., ambient atmosphere) in block 1707, and/or (ii) repeating the previous processes (e.g., in blocks 1704, 1705, 1706, 1709, and/or 1710) with another reservoir in block 1711. in block 1708, determining whether the enclosure has reached the threshold pressure PThr. When the 3D printing system determines the enclosure has reached the threshold pressure PThr, printing one or more 3D objects in block 1710. When the enclosure has not reached the threshold pressure PThr, expelling the volume V2 of gas from the enclosure to the ambient atmosphere in block 1707. The pressure related values may be determined at least in part by the controller(s) of the 3D printing system. The operations may be executed, or directed, by the controller(s).

FIG. 18 shows an example flowchart of 3D printing process. The 3D printing process comprises compensating under-pressure of an enclosure. Estimating a pressure fluctuation ΔPE of an enclosure in block 1801. Determining whether the estimated pressure fluctuation ΔPE is within a pressure tolerance in block 1802. When the estimated pressure fluctuation ΔPE is within the pressure tolerance, printing one or more 3D objects in block 1809. When the estimated pressure fluctuation ΔPE is outside the pressure tolerance (e.g., above a threshold pressure PThr), forecasting a volume to be exchanged (e.g., ingress or introduced) with respect to the enclosure to reach the threshold pressure PThr in block 1803. The forecasting may be based (e.g., at least in part) on the estimated pressure fluctuation ΔPE in block 1803. When the exchange is egress, performing processes (described in FIG. 17) in block 1811. When the exchange is ingress, determining whether a reservoir (e.g., pressure reservoir) has pressurized gas in block 1804. When the reservoir does not have pressurized gas, adding gas from another gas source, e.g., a portion of the gas conveyance system, in block 1807. In block 1808, determining whether the enclosure has reached the threshold pressure PThr. When the enclosure has reached threshold pressure PThr, printing one or more 3D objects in block 1809. When the enclosure has not reached the threshold pressure PThr, repeat adding gas from the other gas source into the enclosure in block 1807. When the reservoir has residual pressurized gas, adding gas from the reservoir into the enclosure in block 1805. In block 1806, determining whether the enclosure has reached the threshold pressure PThr. When the enclosure has reached the threshold pressure PThr, printing one or more 3D objects in block 1809. When the enclosure has not reached the threshold pressure PThr, (i) adding (e.g., ingress or introducing) gas from another gas source into the enclosure in block 1807, and/or (ii) repeating the previous processes (e.g., in blocks 1804, 1805, 1807, 1808, and/or 1809) with another reservoir in block 1810. The pressure related values may be determined at least in part by the controller(s) of the 3D printing system. The operations may be executed, or directed, by the controller(s).

Examples. The following are illustrative and non-limiting examples of methods of the present disclosure.

Example 1: In a processing chamber, Inconel-718 powder having a diameter distribution of from about 15 micrometers to about 45 micrometers was dispensed by a layer dispensing mechanism (e.g., recoater), the powder being dispensed above a build plate having a diameter of about 315 mm to form a powder bed. A layer dispensing mechanism was used to form a powder bed. When idle, a layer dispensing mechanism is parked in an ancillary chamber (e.g., garage) coupled with the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen was at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. Pressure control schemes have been used during the printing similar to those depicted in FIGS. 12 and 13. Pressure alteration operations have been used during the printing similar to those depicted in FIGS. 15 and 16, with forecasting the volume to be exchanged with respect to the volume in the enclosure considered the printing of the 3D object comprising at least one characteristic of the 3D object printed comprises a shape of the 3D object comprising a cavity in the 3D object and an opening of the cavity opening, e.g., the 3D geometries of the cavity and its opening. The processing chamber was equipped with two optical windows made of sapphire. Each laser beam was guided by an optical setup in an optical system enclosure, the optical system enclosure disposed above the processing chamber, the optical system enclosure comprising a galvanometer scanner. Each of the laser beams originated from a fiber laser and traversed its respective optical window into the processing chamber to impinge on an exposed surface of the powder bed to print layerwise a 3D object. Each of the laser beam had a maximum power of about one (1) Kilo Watt, and a wavelength of about 1060 nanometers. A user was able to view the laser beams during printing using three circular viewing window assemblies similar to the one depicted in FIG. 3, 302. The viewing assembly comprises a reflective coating (as disclosed herein) facing the interior of the processing chamber. The layer dispensing mechanism formed a powder bed by sequential layerwise deposition, the powder bed was disposed in a build module and above the build plate. The build plate was disposed above a piston. The build plate traversed down at increments of about 50 □m at a precision of +/−2 micrometers using an optical encoder. The powder bed was used for layerwise printing the 3D object using the lasers. The removed powder was recycled using a recycling system as part of the powder recycling system that is part of the material conveyance system. The recycled powder was reused by the layer dispensing mechanism, e.g., recoater.

Example 2: In a processing chamber, Inconel-718 powder having a diameter distribution of from about 15 micrometers to about 45 micrometers was dispensed by a layer dispensing mechanism (e.g., recoater), the powder being dispensed above a build plate having a diameter of about 600 mm to form a powder bed. A layer dispensing mechanism was used to form a powder bed. When idle, a layer dispensing mechanism is parked in an ancillary chamber (e.g., garage) coupled with the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen was at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. The processing chamber was equipped with eight optical windows made of sapphire in a configuration similar to the one depicted in FIG. 4, e.g., 480. Each laser beam was guided by an optical setup in an optical system enclosure, the optical system enclosure disposed above the processing chamber, the optical system enclosure comprising a galvanometer scanner. Each of the laser beams originated from a fiber laser and traversed its respective optical window into the processing chamber to impinge on an exposed surface of the powder bed to print layerwise a 3D object. Each of the laser beam had a maximum power of about one (1) Kilo Watt, and a wavelength of about 1060 nanometers. The layer dispensing mechanism formed a powder bed by sequential layerwise deposition, the powder bed was disposed in a build module and above the build plate. The build plate was disposed above a piston. The build plate traversed down at increments of about 50 D m at a precision of +/−2 micrometers using an optical encoder. The powder bed was used for layerwise printing the 3D object using the lasers. The removed powder was recycled using a recycling system as part of the powder recycling system that is part of the material conveyance system. The recycled powder was reused by the layer dispensing mechanism, e.g., recoater.

While preferred embodiments of the present invention have been shown, and described herein, it will be obvious to those skilled in the art that such embodiments are provided by way of example only. It is not intended that the present disclosure be limited by the specific examples provided within the specification. While the present disclosure has been described with reference to the afore-mentioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments described herein might be employed in practicing the present disclosure. It is therefore contemplated that the present disclosure shall also cover any such alternatives, modifications, variations, or equivalents. It is intended that the following claims define the scope of the present disclosure and that methods and structures within the scope of these claims and their equivalents be covered thereby.

What is claimed is:

1. An apparatus for printing one or more three-dimensional (3D) objects, the apparatus comprising: one or more controllers configured to:
(a) operatively couple with one or more components associated with a three-dimensional (3D) printer that is configured to print the one or more 3D objects;
(b) generate an estimation of the pressure fluctuation in an enclosure of the 3D printer, the pressure fluctuation being during the printing of the one or more 3D objects in the enclosure, the estimation being generated at least in part by considering (i) at least one first characteristic of the one or more 3D objects printed and/or (ii) at least one second characteristic of a material bed in which the one or more 3D objects are printed, wherein at least a portion of the material bed is utilized to print the one or more 3D objects during the printing; and
(c) direct the one or more components to assist in regulating the pressure based at least in part on the estimation.

2. The apparatus of claim 1, wherein the one or more controllers are configured to operatively couple with a gas enrichment system, the gas enrichment system being configured to enrich gas flowing into the enclosure with at least one reactive agent.

3. The apparatus of claim 2, wherein the gas enrichment system is operatively coupled with or part of a gas conveyance system, the gas conveyance system being operatively coupled with the enclosure and in fluidic communication with the enclosure.

4. The apparatus of claim 1, further comprising at least one sensor operatively coupled with the enclosure and the one or more controllers, the at least one sensor being configured to sense at least one characteristic of the atmosphere of the enclosure.

5. The apparatus of claim 4, wherein the one or more controllers are configured to receive data from the at least one sensor and regulate the pressure fluctuation based at least in part on the data received.

6. The apparatus of claim 1, further comprising a layer dispensing mechanism, wherein the one or more controllers are operatively coupled with the layer dispensing mechanism, the layer dispensing mechanism being located in the enclosure, the layer dispensing mechanism being configured to deposit a layer of a starting material on a target surface, the layer of the starting material constituting at least a portion of the material bed.

7. The apparatus of claim 6, wherein the layer dispensing mechanism further comprises a material dispenser and a remover, the material dispenser is configured to dispense the starting material, the remover being is configured to remove from the enclosure at least a portion of the starting material that does not constitute the material bed.

8. The apparatus of claim 7, wherein the pressure fluctuation in the enclosure is negative when the remover is cleared of the removed material.

9. The apparatus of claim 7, wherein the pressure fluctuation in the enclosure is positive when the remover is loaded with the removed material.

10. A method for printing one or more three-dimensional (3D) objects, the method comprising:
printing the one or more 3D objects in an enclosure about a material bed;
generating an estimation of a pressure fluctuation of an atmosphere of the enclosure during the printing of the one or more 3D objects;
the estimation being generated at least in part by considering (i) at least one characteristic of the one or more 3D objects being printed or (ii) at least one characteristic of the material bed about which the one or more 3D objects are printed; and
regulating the pressure fluctuation of the atmosphere of the enclosure.

11. The method of claim 10, wherein at least during the printing, controlling a pressure in the enclosure to be above an ambient pressure external to the enclosure.

12. The method of claim 10, further comprising removing a removed material from the material bed by a remover, the removed material being at least a portion of the material bed.

13. The method of claim 12, wherein the pressure fluctuation in the enclosure is negative when the remover is cleared of the removed material.

14. The method of claim 12, wherein the pressure fluctuation in the enclosure is positive when the remover is loaded with the removed material.

15. A device for printing one or more three-dimensional (3D) objects, the device comprising:
a reservoir operatively coupled with a three-dimensional (3D) printer utilized for the printing of the one or more 3D objects in the enclosure;
wherein the reservoir is configured to exchange at least a portion of a gas of an atmosphere of an enclosure and enclose a reservoir gas in the reservoir during the exchange; and
wherein the exchange includes an egress of the gas from the enclosure and an ingress of the reservoir gas disposed in the reservoir of the gas into the enclosure.

16. The device of claim 15, wherein the reservoir is configured to accommodate at least during the printing, a pressure above an ambient pressure external to the 3D printer.

17. The device of claim 15, wherein the reservoir further comprises at least one pressure reservoir, the at least one pressure reservoir being operatively coupled with the enclosure.

18. The device of claim 15, further comprising at least one compressor operatively coupled to the reservoir, the at least one compressor being configured to (i) facilitate flow of the gas during the egress of the gas from the enclosure or (ii) control one or more gas related variables.

19. The device of claim 18, wherein the one or more gas related variables include a pressure, a temperature, a flow rate, a flow acceleration, a flow direction, a flow homogeneity, or a volume of gas flowing in a gas conveyance system.

20. The device of claim 15, wherein the device further comprises at least one filtering mechanism configured to facilitate removal of a gas borne material carried by the gas egressed from the enclosure, the at least one filtering mechanism being operatively coupled with the reservoir.
